(19) United States
(12) Patent Application Publication
(10) Pub. No.: US 2012/0243611 A1
(43) Pub. Date: Sep. 27, 2012

(54) IMAGE PROCESSING APPARATUS AND METHOD AS WELL AS PROGRAM

(75) Inventor: Kenji Kondo, Tokyo (JP)

(73) Assignee: SONY CORPORATION, Tokyo (JP)

(21) Appl. No.: 13/514,354

(22) PCT Filed: Dec. 14, 2010
(86) PCT No.: PCT/JP10/72434

§ 371 Date: Jun. 7, 2012

(30) Foreign Application Priority Data
Dec. 22, 2009 (JP) 2009-290905
Jul. 13, 2010 (JP) 2010-158866

(51) Int. Cl. H04N 7/32

(52) U.S. Cl. 375/240.16; 375/E07.027; 375/E07.125; 375/E07.193

(57) ABSTRACT

The present invention relates to an image processing apparatus and method, and a program capable of suppressing loss of high-frequency components and achieving a clear sense of the picture quality. A selector 95 selects one of filter coefficients from among a filter coefficient A1 which is used in all inter prediction modes where L0L1 weighted prediction is not used and is stored in an A1 filter coefficient memory 91, a filter coefficient A2 which is used in a bi-prediction mode where the L0L1 weighted prediction is used and is stored in an A2 filter coefficient memory 92, a filter coefficient A3 which is used in a direct mode where the L0L1 weighted prediction is used and is stored in an A3 filter coefficient memory 93, and a filter coefficient A4 which is used in a skip mode where the L0L1 weighted prediction is used and is stored in an A4 filter coefficient memory 94, and outputs the selected filter coefficients to a fixed interpolation filter. The present invention can be applied, for example, to an image encoding apparatus which carries out encoding based on the H.264/AVC method.

### TECHNICAL FIELD

The present invention relates to an image processing apparatus and method, and particularly to an image processing apparatus and method capable of suppressing loss of high-frequency components and achieving a clear sense of the picture quality.

### BACKGROUND ART

As standard specifications for compressing image information, H.264 and MPEG-4 Part 10 (Advanced Video Coding, hereinafter referred to as H.264/AVC) are available.

In H.264/AVC, inter prediction with attention paid to a correlation between frames or fields is carried out. And, in a motion compensation process carried out in the inter prediction, a prediction image (hereinafter referred to as inter prediction image) by the inter prediction is produced using part of a region of an image which is stored already and can be referred to.

For example, in the case where five frames of an image which are stored already and can be referred to are determined as reference frames as seen in FIG. 1, part of an inter prediction image of a frame (original frame) to be inter predicted is configured referring to part of an image (hereinafter referred to as reference image) of one of the five reference frames. It is to be noted that the position of part of the reference image to be used as the part of the inter prediction image is determined by a motion vector detected based on images of the reference frame and the original frame.

More particularly, as seen in FIG. 2, in the case where the face 11 in the reference frame moves in a rightwardly downward direction in the original frame and a lower portion of approximately ⅓ of the face 11 is hidden, a motion vector which represents a leftwardly upward direction opposite to the rightwardly downward direction is detected. Then, the part 12 of the face 11 which is hidden in the original frame is configured referring to part 13 of the face 11 in the reference frame at a position to which the part 12 is moved by a motion represented by the motion vector.

Further, in H.264/AVC, it is expected to enhance, in a motion compensation process, the resolution of the motion vector fractional accuracy such as ½ or ¼.

In such a motion compensation process in fractional accuracy as described above, a pixel at a virtual fractional position called Sub pel is set between adjacent pixels, and a process of producing such a Sub pel (hereinafter referred to as interpolation) is carried out additionally. In other words, in a motion compensation process in fractional accuracy, the minimum resolution of a motion vector is a pixel at a fractional position, and therefore, interpolation for producing a pixel at a fractional position is carried out.

FIG. 3 shows pixels of an image in which the number of pixels in the vertical direction and the horizontal direction is increased to four times by interpolation. It is to be noted that, in FIG. 3, a blank square represents a pixel at an integral position (Integer pel (Int. pel)), and a square to which slanting lines are applied represents a pixel at a fractional position (Sub pel). Further, an alphabetical letter in a square represents a pixel value of a pixel represented by the square.

Pixel values b, h, j, a, d, f and r of pixels at fractional positions produced by interpolation are represented by the expressions (1) given below.

b=(E−5F+20G+20H−5I+J)/32

h=(A−5C+20G+20M−5R+T)/32

j=(aa−5bb+20b+20s−5gg+hh)/32

a=(G+b)/2

d=(G+h)/2

f=(b+j)/2

r=(m+s)/2 (1)

It is to be noted that the pixel values aa, bb, s, gg and hh can be determined similarly to b; cc, dd, m, ee and ff similarly to h; the pixel value c can be determined similarly to a; the pixel values f, n and q can be determined similarly to d; and e, p and g similarly to r.

The expression (1) given above is expressions adopted in interpolation in H.264/AVC and so forth, and although the expressions differ depending upon differences in standard, the object of the expressions is same. The expressions can be implemented by a finite impulse response (FIR (Finit-duration Impulse Response)) filter having an even number of taps. For example, in H.264/AVC, an interpolation filter having six taps is used.

Incidentally, in H.264/AVC, particularly in the case of a B picture, bidirectional prediction can be used as illustrated in FIG. 4. In FIG. 4, pictures are illustrated in a displaying order, and reference pictures encoded already are juxtaposed preceding to and succeeding an encoding object picture in the displaying order. In the case where the encoding object picture is a B picture, as indicated, for example, by an object prediction block of the encoding object picture, two blocks of the preceding and succeeding (bidirectional) reference pictures are referred to, and the encoding object picture can have a motion vector of L0 prediction in the preceding direction and a motion vector of L1 prediction in the succeeding direction.

In particular, L0 is earlier in displaying time principally than an object prediction block, and L1 is later in displaying time principally than another object prediction block. The reference pictures distinguished from each other can be selectively used for different encoding modes. As the encoding modes, five modes are available including an intra screen encoding (intra prediction), L0 prediction, L1 prediction, bi-prediction and direct modes as seen in FIG. 5.

FIG. 5 is a view illustrating a relationship between the encoding modes and a reference picture and a motion vector. It is to be noted that, in FIG. 5, the reference picture indicates whether or not the reference picture is used in the encoding modes while the motion vector indicates whether or not the encoding modes have motion vector information.

The intra screen encoding mode is a mode in which prediction is carried out within a screen (that is, intra screen) and an encoding mode in which none of an L0 reference picture and an L1 reference picture are used and which does not have any of a motion vector of the L0 prediction and a motion vector of the L1 prediction. The L0 prediction mode is an encoding mode in which only the L0 reference picture is used to carry out prediction and which has motion vector information of the L0 prediction. The L1 prediction mode is an encoding mode in which prediction is carried out using only the L1 reference picture and which has motion vector information of the L1 prediction.

The bi-prediction mode is an encoding mode in which prediction is carried out using the L0 and L1 reference pictures and which has motion vector information of the L0 and L1 predictions. The direct mode is an encoding mode in which prediction is carried out using the L0 and L1 reference pictures but which does not have any motion vector information. In particular, the direct mode is an encoding mode in which, although it does not have motion vector information, a motion vector information of a current object prediction block is predicted from motion vector information of an encoded block in a reference picture and is used. It is to be noted that also the direct mode may possibly have only one of the L0 and L1 reference pictures.

In this manner, in the bi-prediction mode and the direct mode, both of the L0 and L1 reference pictures may be used. Where two reference pictures are involved, a prediction signal of the bi-prediction mode or the direct mode can be obtained by weighted prediction represented by the following expression (2).

Y_{Bi-Pred}=W₀Y₀+W₁Y₁+D (2)

Here, Y_{Bi-Pred} is a weighted interpolation signal with an offset in the bi-prediction mode or the direct mode, and W₀ and W₁ are weighting coefficients to L0 and L1 while Y₀ and Y₁ are motion compensation prediction signals of L0 and L1, respectively. As such W₀, W₁ and D as mentioned above, those which are explicitly included in bit stream information or are obtained implicitly by calculation on the decoding side.

If encoding deterioration of a reference picture has no correlation between the two reference pictures of L0 and L1, then the encoding deterioration is suppressed by this weighted prediction. As a result, a residual signal which is the difference between the prediction signal and the input signal decreases, and the bit amount of the residual signal is reduced and the encoding efficiency is improved.

Further, in Non-Patent Documents 1 to 3, an adaptive interpolation filter (AIF) is listed in a latest research report. In a motion compensation process in which this AIF is used, by adaptively changing the filter coefficients of a FIR filter which is used in interpolation and has an even number of taps, the influence of aliasing or encoding distortion can be reduced to reduce the error in motion compensation.

While the AIF exhibits several variations from differences in filter structure, the Separable adaptive interpolation filter (hereinafter referred to as Separable AIF) disclosed in Non-Patent Document 2 is described representatively with reference to FIG. 6. It is to be noted that a square to which slanting lines are applied represents a pixel at an integral position (Integer pel (Int. pel)), and a blank square represents a pixel at a fractional position (Sub pel). Further, an alphabetical letter in a square represents a pixel value of a pixel indicated by the square.

In the Separable AIF, interpolation of non-integral positions in the horizontal direction is carried out as a first step, and interpolation in a non-integral direction in the vertical direction is carried out as a second step. It is to be noted that also it is possible to reverse the processing order for the horizontal and vertical directions.

First, at the first step, the pixel valves a, b and c of pixels at fractional positions are calculated in accordance with the following expression (3) from the pixel values E, F, G, H, I and J of pixels at integral positions by means of a FIR filter. Here, h[pos][n] is a filter coefficient, and pos represents the position of a sub pel shown in FIG. 3 while n represents the number of the filter coefficient. This filter coefficient is included in stream information and used on the decoding side.

a=h[a][0]×E+h1[a][1]×F+h2[a]×G+h[a][3]×H+h[a][4]×I+h[a][5]×J

b=h[b][0]×E+h1[b][1]×F+h2[b][2]×G+h[b][3]×H+h[b][4]×I+h[b][5]×J

c=h[c][0]×E+h1[c][1]×F+h2[c][2]×G+h[c][3]×H+h[c][4]×I+h[c][5]×J (3)

It is to be noted that also pixel values (a1, b1, c1, a2, b2, c2, a3, b3, c3, a4, b4, c4, a5, b5, c5) of pixels at fractional positions of a row of pixel values G1, G2, G3, G4, G5 can be determined similarly to the pixel values a, b, c.

Then, as the second step, the pixel values d to o other than the pixel values a, b, c are calculated in accordance with the following expressions (4).

d=h[d][0]×G1+h[d][1]×G2+h[d][2]×G+h[d][3]×G3+h[d][4]*G4+h[d][5]×G5

h=h[h][0]×G1+h[h][1]×G2+h[h][2]×G+h[h][3]×G3+h[h][4]*G4+h[h][5]×G5

l=h[l][0]×G1+h[l][1]×G2+h[l][2]×G+h[l][3]×G3+h[l][4]*G4+h[l][5]×G5

e=h[e][0]×a1+h[e][1]×a2+h[e][2]×a+h[e][3]×a3+h[e][4]*a4+h[e][5]×a5

i=h[i][0]×a1+h[i][1]×a2+h[i][2]×a+h[i][3]×a3+h[i][4]*a4+h[i][5]×a5

m=h[m][0]×a1+h[m][1]×a2+h[m][2]×a+h[m][3]×a3+h[m][4]*a4+h[m][5]×a5

f=h[f][0]×b1+h[f][1]×b2+h[f][2]×b+h[f][3]×b3+h[f][4]*b4+h[f][5]×b5

j=h[j][0]×b1+h[j][1]×b2+h[j][2]×b+h[j][3]×b3+h[j][4]*b4+h[j][5]×b5

n=h[n][0]×b1+h[n][1]×b2+h[n][2]×b+h[n][3]×b3+h[n][4]*b4+h[n][5]×b5

g=h[g][0]×c1+h[g][1]×c2+h[g][2]×c+h[g][3]×c3+h[g][4]*c4+h[g][5]×c5

k=h[k][0]×c1+h[k][1]×c2+h[k][2]×c+h[k][3]×c3+h[k][4]*c4+h[k][5]×c5

o=h[o][0]×c1+h[o][1]×c2+h[o][2]×c+h[o][3]×c3+h[o][4]*c4+h[o][5]×c5 (4)

It is to be noted that, while, in the method described above, all of the filter coefficients are independent of each other, in Non-Patent Document 2, the following expressions (5) are indicated.

a=h[a][0]×E+h1[a][1]×F+h2[a]×G+h[a][3]×H+h[a][4]×I+h[a][5]×J

b=h[b][0]×E+h1[b][1]×F+h2[b][2]×G+h[b][2]×H+h[b][1]×I+h[b][0]×J

c=h[c][0]×E+h1[c][1]×F+h2[c][2]×G+h[c][3]×H+h[c][4]×I+h[c][5]×J

d=h[d][0]×G1+h[d][1]×G2+h[d][2]×G+h[d][3]×G3+h[d][4]*G4+h[d][5]×G5

h=h[h][0]×G1+h[h][1]×G2+h[h][2]×G+h[h][2]×G3+h[h][1]*G4+h[h][0]×G5

l=h[d][5]×G1+h[d][4]×G2+h[d][3]×G+h[d][2]×G3+h[d][1]*G4+h[d][0]×G5

e=h[e][0]×a1+h[e][1]×a2+h[e][2]×a+h[e][3]×a3+h[e][4]*a4+h[e][5]×a5

i=h[i][0]×a1+h[i][1]×a2+h[i][2]×a+h[i][2]×a3+h[i][1]*a4+h[i][0]×a5

m=h[e][5]×a1+h[e][4]×a2+h[e][3]×a+h[e][2]×a3+h[e][1]*a4+h[e][0]×a5

f=h[f][0]×b1+h[f][1]×b2+h[f][2]×b+h[f][3]×b3+h[f][4]*b4+h[f][5]×b5

j=h[j][0]×b1+h[j][1]×b2+h[j][2]×b+h[j][2]×b3+h[j][1]*b4+h[j][0]×b5

n=f[n][5]×b1+h[f][4]×b2+h[f][3]×b+h[f][2]×b3+h[f][1]*b4+h[f][0]×b5

g=h[g][0]×c1+h[g][1]×c2+h[g][2]×c+h[g][3]×c3+h[g][4]*c4+h[g][5]×c5

k=h[k][0]×c1+h[k][1]×c2+h[k][2]×c+h[k][2]×c3+h[k][1]*c4+h[k][0]×c5

o=h[g][5]×c1+h[g][4]×c2+h[g][3]×c+h[g][2]×c3+h[g][1]*c4+h[g][0]×c5 (5)

For example, h[b][3] which is one of filter coefficients for the calculation of the pixel value b is replaced by h[b][2]. In the case where all filters are completely independent of each other like the former, the number of filter coefficients makes a total of 90, but according to the method of Non-Patent Document 2, the number of filter coefficients decreases to 51.

Although the AIF described above improves the performance of the interpolation filter, since the filter coefficients are included into stream information, an overhead exists, and according to circumstances, it may possibly occur that the encoding efficiency is deteriorated. Therefore, in Non-Patent Document 3, the filter coefficients are reduced using symmetry thereof to reduce the overhead. On the encoding side, it is checked the filter coefficient of which Sub pel is proximate to that of another Sub pel, and such proximate filter coefficients are aggregated to one coefficient. A descriptor of the symmetry representative of in what manner filter coefficients are aggregated is included into stream information and sent to the decoding side. On the decoding side, the descriptor of the symmetry is received, and it can be found in what manner the filter coefficients are aggregated.

Incidentally, in the H.264/AVC method, the macro block size is 16×16 pixels. However, to set the macro block size to 16×16 pixels is not optimum to such a large picture frame as that of UHD (Ultra High Definition: 400×2000 pixels) which becomes an object of the next generation encoding method.

Therefore, in Non-Patent Document 4 and so forth, it is proposed to expand the macro block size to such a great size as, for example, 32×32 pixels.

It is to be noted that the figures of the conventional technologies described above are suitably used for description of the invention of the present application.

### PRIOR ART DOCUMENTS

### Non-Patent Documents

Non-Patent Document 1: Yuri Vatis, Joern Ostermann, “Prediction of P-B-Frames Using a Two-dimensional Non-separable Adaptive Wiener Interpolation Filter for H.264/AVC,” ITU-T SG16 VCEG 30th Meeting, Hangzhou China, October 2066
Non-Patent Document 2: Steffen Wittmann, Thomas Wedi, “Separable adaptive inerpolation filte,” ITU-T SG16COM16-C219-E, June 2007
Non-Patent Document 3: Dmytro Rusanovskyy, et al., “Improvements on Enhanced Directional Adaptive Filtering (EDAIF-2),” COM 16-C125-E, January 2009
Non-Patent Document 4: “Video Coding Using Extended Block Sizes,” VCEG-AD09, ITU-Telecommunications Standardization Sector STURY GROUP Question 16—Contribution 123, January 2009

### SUMMARY OF INVENTION

### Technical Problems

As described hereinabove, while weighted prediction in which a plurality of reference pictures are used can achieve the effect that encoding deterioration of reference pictures is reduced, there is the possibility that high frequency components may be lost.

Although a plurality of causes are possible, it is considered that a principal factor comes from displacement in positioning. In particular, when two predicted images are superposed on each other by weighted prediction, since complete positioning of a current object prediction block is difficult, positional displacement occurs particularly at a contour portion of an image. This arises from the fact that positional displacement occurs at a contour portion of two predicted images of prediction signals obtained from reference pictures as shown in FIG. 7.

In the example of FIG. 7, the axis of abscissa represents the position of an image and the axis of ordinate represents the luminance value at the position. A line with diamonds indicates an input signal, and a line with squares indicates a prediction signal based on the L0 reference picture. Further, a line with triangles indicates a prediction signal based on the L1 reference picture, and a line with cross marks is a weighted prediction signal when W₀=W₁=0.5.

It can be recognized that, with respect to a variation of the input signal of FIG. 7, the prediction signals of L0 and L1 are displaced leftwardly and rightwardly, and from the prediction signals of L0 and L1, the variation of the weighted prediction is moderated with respect to the input signal.

That the weighted prediction signals which are prediction signals in the bi-prediction mode and the direct mode come to vary moderately makes a cause of occurrence of blurring at a contour portion, and there is the possibility that the encoding efficiency may be deteriorated and, in terms of the picture quality, the impression may be degraded.

Such positional displacement frequently occurs in the direct mode rather than in the bi-prediction mode. In the bi-prediction mode, since motion vector information is possessed, accurate positioning can be achieved in comparison with the direct mode. However, in the direct mode, motion vector information obtained by prediction from encoded blocks is used. Accordingly, since a prediction error from encoded blocks cannot be avoided, an error occurs in positioning in the direct mode.

Further, according to the AIF technologies of Non-Patent Documents 1 to 3, the filter characteristic of an interpolation filter can be changed in a unit of a slice and encoding deterioration of reference pictures can be reduced. In particular, by using a spatial LPF (Low Pass Filter) characteristic which the AIF has to weaken high frequency components of noise included in reference pictures, encoding deterioration can be reduced. However, there is the possibility that, by this LPF characteristic, high frequency components of an image may be lost.

Further, where this fact is combined with the fact in the weighted prediction described above, there is the possibility that a further significant influence may be had. In other words, spatial high frequency components of an interpolation signal are lost by the AIF, and further, temporal high frequency components are lost by the weighted prediction. By a combination of the AIF technology and the weighted prediction in the bi-prediction mode or the direct mode, high frequency components are lost unnecessarily, and there is the possibility that improvement of the encoding efficiency may not be obtained and the clear sense of the picture quality may be lost.

Although unnecessary loss of high frequency components can be suppressed by setting the spatial LPF characteristic of the AIF to a comparatively low strength, when weighted prediction is not carried out, since temporal high frequency components are not lost, there is the possibility that encoding deterioration of a reference picture may not be reduced sufficiently. In other words, a spatial LPF characteristic of the AIF which is optimum when weighted prediction is not carried out is excessive when weighted prediction is carried out, and there is the possibility that high frequency components of an image may be lost. Meanwhile, a spatial LPF characteristic of the AIF which is optimum when weighted prediction is carried out is insufficient, and there is the possibility that encoding deterioration of reference pictures may not be reduced sufficiently.

The present invention has been made in view of such a situation as described above and can suppress loss of high frequency components and achieve a clear sense of the picture quality.

### Technical Solution

An image processing apparatus according to an aspect of the present invention, includes an interpolation filter for interpolating pixels of a reference image corresponding to an encoded image with fractional accuracy; filter coefficient selection means for selecting filter coefficients of the interpolation filter based on use or non-use of weighted prediction by a plurality of such reference images different from each other in the encoded image; and motion compensation means for producing a predicted image using the reference image interpolated by the interpolation filter of the filter coefficients selected by the filter coefficient selection means and a motion vector corresponding to the encoded image.

Where the weighted prediction by the plural different reference images is used, the filter coefficient selection means may select filter coefficients of the interpolation filter based on whether or not the current mode is a bi-prediction mode.

The filter coefficient selection means may select the filter coefficients whose degree of amplification of high-frequency components is different based on whether or not the current mode is the bi-prediction mode.

Where the weighted prediction by the plural different reference images is used, the filter coefficient selection means may select filter coefficients of the interpolation filter based on whether the current mode is a bi-prediction mode, a direct mode or a skip mode.

The interpolation filter may interpolate the pixels of the reference image with fractional accuracy using the filter coefficients selected by the filter coefficient selection means and an offset value.

The image processing apparatus may further include decoding means for decoding the encoded image, the motion vector and the filter coefficients calculated upon encoding, and the filter coefficient selection means may select the filter coefficients decoded by the decoding means based on use or non-use of the weighted prediction by a plurality of such reference images different from each other in the encoded image.

The filter coefficients may include plural kinds of filter coefficients upon use of the weighted prediction and plural kinds of filter coefficients upon non-use of the weighted prediction, and the filter coefficient selection means may select the filter coefficients decoded by the decoding means based on use or non-use of the weighted prediction and information for specifying a kind of the filter coefficients.

The image processing apparatus may further include motion prediction means for carrying out motion prediction between an object image of encoding and the reference image interpolated by the interpolation filter of the filter coefficients selected by the filter coefficient selection means to detect the motion vector.

Where the weighted prediction by the plural different reference images is used, the filter coefficient selection means may select filter coefficients of the interpolation filter based on whether or not the current mode is a bi-prediction mode.

The image processing apparatus may further include filter coefficient calculation means for calculating filter coefficients of the interpolation filter using the object image of encoding, the reference images and the motion vector detected by the motion prediction means, and the filter coefficient selection means may select the filter coefficients calculated by the filter coefficient calculation means based on use or non-use of the weighted prediction by the plural different reference images.

The image processing apparatus may be configured such that the filter coefficient selection means determines, based on use or non-use of the weighted prediction by the plural different reference images, the filter coefficients calculated by the filter coefficient calculation means as a first selection candidate and determines a predetermined filter coefficient as a second selection candidate; the motion prediction means carries out motion prediction between the object image of the encoding and the reference image interpolated by the interpolation filter of the first selection candidate to detect a motion vector for the first selection candidate, and carries out motion prediction between the object image of the encoding and the reference image interpolated by the interpolation filter of the second selection candidate to detect a motion vector for the second selection candidate; the motion compensation means produces a predicted image for the first selection candidate using the reference image interpolated by the interpolation filter of the first selection candidate and the motion vector for the first selection candidate, and produces a predicted image for the second selection candidate using the reference image interpolated by the interpolation filter of the second selection candidate and the motion vector for the second selection candidate; and the filter coefficient selection means selects a filter coefficient corresponding to a smaller one of the difference between the predicted image for the first selection candidate and the object image of the encoding and the difference between the predicted image for the second selection candidate and the object image of the encoding.

The filter coefficients may include plural kinds of filter coefficients when the weighted prediction is used and plural kinds of filter coefficients when the weighted prediction is not used, and the filter coefficient selection means may select the filter coefficients based on use or non-use of the weighted prediction and a cost function value corresponding to each kind of the filter coefficients.

An image processing method according to the aspect of the present invention is a method for an image processing apparatus which includes an interpolation filter for interpolating pixels of a reference image corresponding to an encoded image with fractional accuracy, including the steps, executed by the image processing apparatus, of selecting filter coefficients of the interpolation filter based on use or non-use of weighted prediction by a plurality of reference images different from each other in the encoded image, and producing a predicted image using the reference images interpolated by the interpolation filter of the selected filter coefficients and a motion vector corresponding to the encoded image.

The image processing method may further include the step, executed by the image processing apparatus, of carrying out motion prediction between an object image of encoding and the reference image interpolated by the interpolation filter of the selected filter coefficients to detect a motion vector.

A program according to the aspect of the present invention causes a computer of an image processing apparatus, which includes an interpolation filter for interpolating pixels of a reference image corresponding to an encoded image with fractional accuracy, to function as filter coefficient selection means for selecting filter coefficients of the interpolation filter based on use or non-use of weighted prediction by a plurality of such reference images different from each other in the encoded image, and motion compensation means for producing a predicted image using the reference image interpolated by the interpolation filter of the filter coefficients selected by the filter coefficient selection means and a motion vector corresponding to the encoded image.

The program may further cause the computer to function as motion prediction means for carrying out motion prediction between an object image of encoding and the reference image interpolated by the interpolation filter of the filter coefficients selected by the filter coefficient selection means to detect the motion vector.

In the aspect of the present invention, filter coefficients of the interpolation filter for interpolating pixels of the reference image corresponding to the encoded image with fractional accuracy is selected based on use or non-use of the weighted prediction by plural different reference images different in the encoded image. Then, the prediction image is produced using the reference image interpolated by the interpolation filter of the selected filter coefficients and the decoded motion vector.

It is to be noted that the image processing apparatus described above may individually be provided as apparatus independent of each other or may be configured each as an internal block which configures one image encoding apparatus or one image decoding apparatus.

### Advantageous Effect

With the present invention, loss of high-frequency components can be suppressed and a clear sense of the picture quality can be obtained.

### BRIEF DESCRIPTION OF DRAWINGS

FIG. 1 is a view illustrating conventional inter prediction.

FIG. 2 is a view illustrating the conventional inter prediction particularly.

FIG. 3 is a view illustrating interpolation.

FIG. 4 is a view illustrating bidirectional prediction.

FIG. 5 is a view illustrating a relationship between encoding modes and a reference picture and a motion vector.

FIG. 6 is a view illustrating a Separable AIF.

FIG. 7 is a view illustrating an error between an input signal and a prediction signal.

FIG. 8 is a block diagram showing a configuration of a first embodiment of an image encoding apparatus to which the present invention is applied.

FIG. 9 is a block diagram showing an example of a configuration of a motion prediction and compensation section.

FIG. 10 is a view illustrating classification of filter coefficients.

FIG. 11 is a block diagram showing an example of a configuration of a filter coefficient storage portion in the case of a pattern A.

FIG. 12 is a block diagram showing an example of a configuration of a filter coefficient calculation portion in the case of the pattern A.

FIG. 13 is a view illustrating calculation of a filter coefficient in a horizontal direction.

FIG. 14 is a view illustrating calculation of a filter coefficient in a vertical direction.

FIG. 15 is a flow chart illustrating an encoding process of the image encoding apparatus of FIG. 8.

FIG. 16 is a flow chart illustrating a motion prediction and compensation process at step S22 of FIG. 13.

FIG. 17 is a flow chart illustrating a filter coefficient selection process at step S51 of FIG. 16.

FIG. 18 is a block diagram showing an example of the first embodiment of an image decoding apparatus to which the present invention is applied.

FIG. 19 is a block diagram showing an example of a configuration of a motion compensation portion of FIG. 18.

FIG. 20 is a block diagram showing an example of a configuration of a fixed filter coefficient storage portion in the case of the pattern A.

FIG. 21 is a block diagram showing an example of a configuration of a variable filter coefficient storage portion in the case of the pattern A.

FIG. 22 is a flow chart illustrating a decoding process of the image decoding apparatus of FIG. 18.

FIG. 23 is a flow chart illustrating a motion compensation process at step S139 of FIG. 22.

FIG. 24 is a flow chart illustrating a variable filter coefficient replacement process at step S153 of FIG. 23.

FIG. 25 is a view illustrating an example of an expanded block size.

FIG. 26 is a block diagram showing an example of a configuration of hardware of a computer.

FIG. 27 is a block diagram showing an example of a principal configuration of a television receiver to which the present invention is applied.

FIG. 28 is a block diagram showing an example of a principal configuration of a portable telephone set to which the present invention is applied.

FIG. 29 is a block diagram showing an example of a principal configuration of a hard disk recorder to which the present invention is applied.

FIG. 30 is a block diagram showing an example of a principal configuration of a camera to which the present invention is applied.

FIG. 31 is a block diagram showing a configuration of a second embodiment of an image encoding apparatus to which the present invention is applied.

FIG. 32 is a block diagram showing an example of a configuration of a motion prediction and compensation section of FIG. 31.

FIG. 33 is a block diagram showing an example of a configuration of a filter coefficient selection portion in the case of the pattern A.

FIG. 34 is a view illustrating an example of storage information of an A1 filter coefficient memory.

FIG. 35 is a flow chart illustrating a motion prediction and compensation process.

FIG. 36 is a block diagram showing a configuration of a second embodiment of an image decoding apparatus to which the present invention is applied.

FIG. 37 is a block diagram showing an example of a configuration of a motion compensation portion of FIG. 36.

FIG. 38 is a block diagram showing an example of a configuration of a filter coefficient set storage part in the case of the pattern A.

FIG. 39 is a flow chart illustrating a motion compensation process.

FIG. 40 is a view illustrating different classification of filter coefficients.

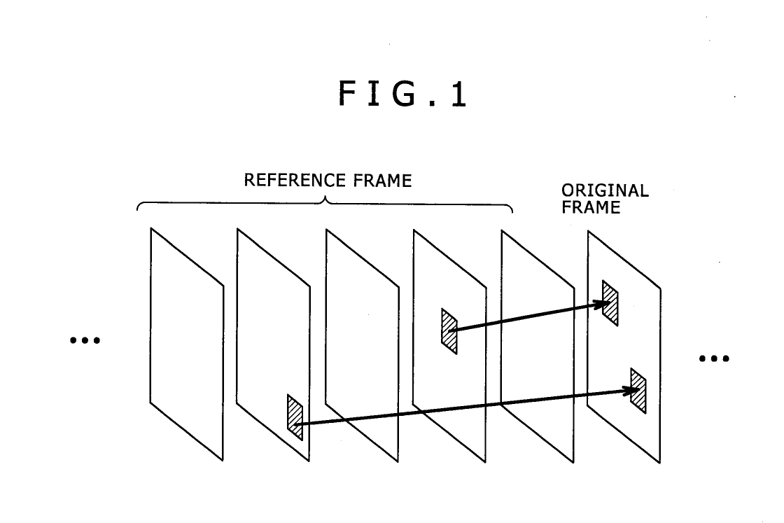

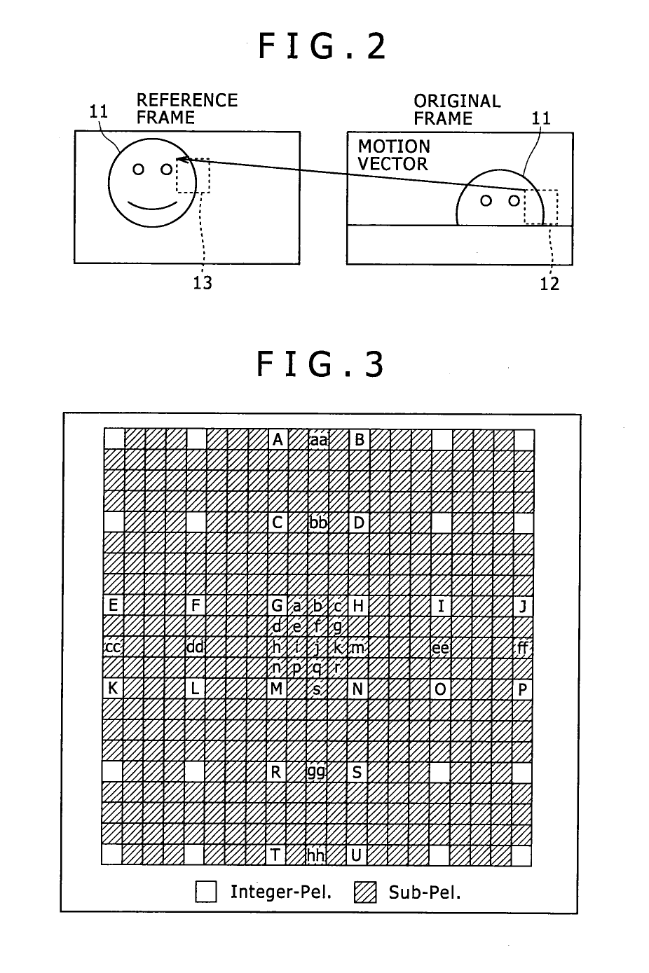

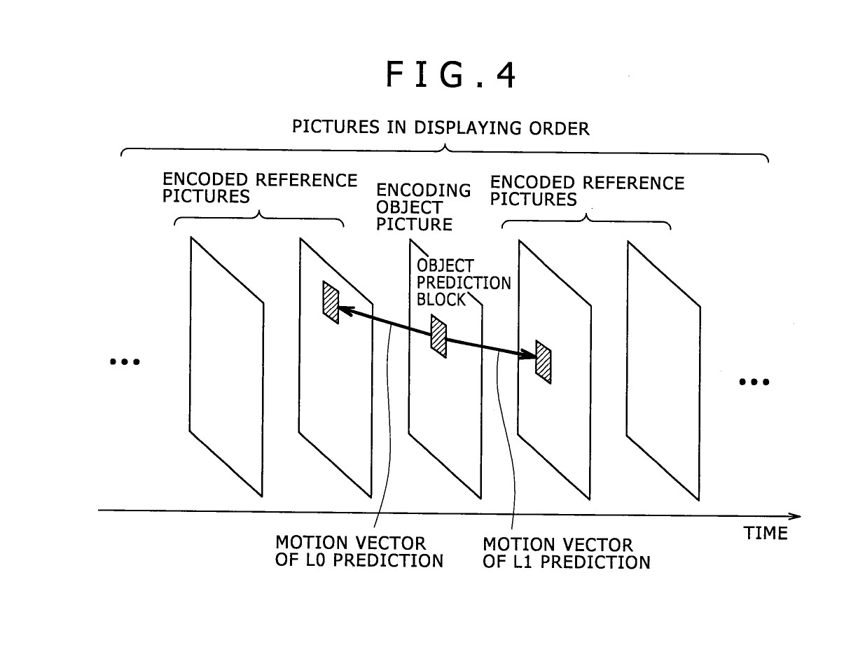

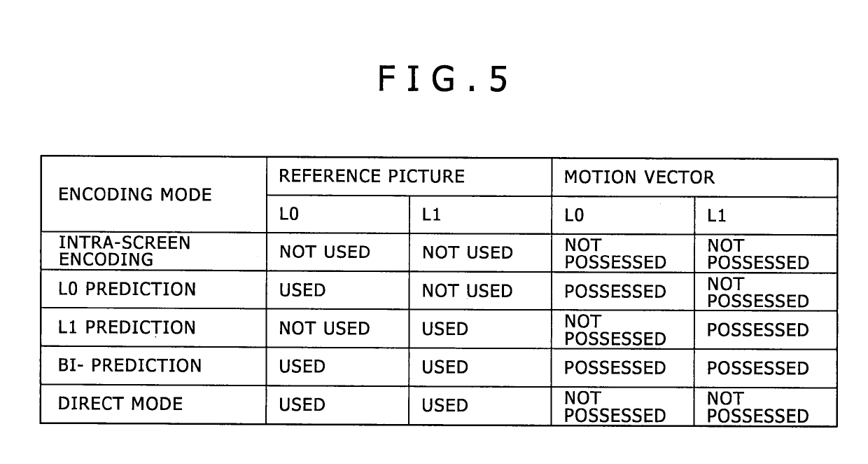

### MODE FOR CARRYING OUT THE INVENTION

In the following, embodiments of the present invention are described with reference to the drawings.

### First Embodiment

### [Example of the Configuration of the Image Encoding Apparatus]

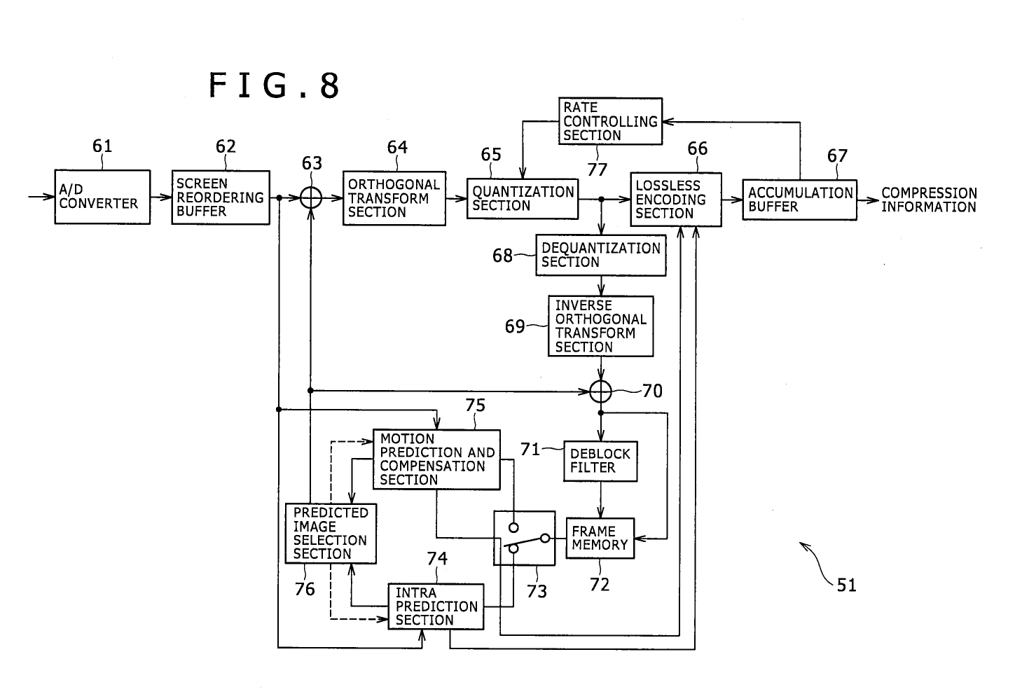

FIG. 8 shows a configuration of a first embodiment of an image encoding apparatus as an image processing apparatus to which the present invention is applied.

This image encoding apparatus 51 compression encodes an image inputted thereto on the basis of, for example, the H.264 and MPEG-4 Part 10 (Advanced Video Coding) (hereinafter referred to as H.264/AVC) method.

In the example of FIG. 8, the image encoding apparatus 51 is configured from an A/D converter 61, a screen reordering buffer 62, an arithmetic operation section 63, an orthogonal transform section 64, a quantization section 65, a lossless encoding section 66, an accumulation buffer 67, a dequantization section 68, an inverse orthogonal transform section 69, an arithmetic operation section 70, a deblock filter 71, a frame memory 72, a switch 73, an intra prediction section 74, a motion prediction and compensation section 75, a predicted image selection section 76 and a rate controlling section 77.

The A/D converter 61 A/D converts an image inputted thereto and outputs a resulting image to the screen reordering buffer 62 so as to be stored into the screen reordering buffer 62. The screen reordering buffer 62 rearranges images of frames in a displaying order stored therein into those in an order of frames for encoding in response to a GOP (Group of Picture).

The arithmetic operation section 63 subtracts a predicted image from the intra prediction section 74 or a predicted image from the motion prediction and compensation section 75 selected by the predicted image selection section 76 from an image read out from the screen reordering buffer 62 and outputs the difference information to the orthogonal transform section 64. The orthogonal transform section 64 carries out orthogonal transform such as discrete cosine transform or Karhunen-Lowe transform for the difference information from the arithmetic operation section 63 and outputs transform coefficients. The quantization section 65 quantizes the transform coefficients outputted from the orthogonal transform section 64.

Quantized transform coefficients outputted from the quantization section 65 are inputted to the lossless encoding section 66, by which lossless encoding such as variable length encoding or arithmetic encoding is carried out for the quantized transform coefficients and compression is carried out.

The lossless encoding section 66 acquires information indicative of intra prediction from the intra prediction section 74 and acquires information representative of an inter prediction mode or the like from the motion prediction and compensation section 75. It is to be noted that the information indicative of the intra prediction and the information indicative of the inter prediction are hereinafter referred to as intra prediction mode information and inter prediction mode information, respectively.

The lossless encoding section 66 encodes the quantized transform coefficients and encodes the information indicative of the intra prediction, the information indicative of the inter prediction mode and so forth, and uses resulting codes as part of header information of a compressed image. The lossless encoding section 66 supplies the encoded data to the accumulation buffer 67 so as to be accumulated into the accumulation buffer 67.

For example, the lossless encoding section 66 carries out a lossless encoding process such as variable length encoding or arithmetic encoding. As the variable length encoding, CAVLC (Context-Adaptive Variable Length Coding) prescribed in the H.264/AVC method or the like is available. As the arithmetic encoding, CABAC (Context-Adaptive Binary Arithmetic Coding) or the like is available.

The accumulation buffer 67 outputs data supplied thereto from the lossless encoding section 66 as an encoded compressed image, for example, to a recording apparatus or a transmission path not shown at the succeeding stage.

Meanwhile, the quantized transform coefficients outputted from the quantization section 65 are inputted also to the dequantization section 68, by which it is dequantized, and the dequantized transform coefficients are inversely orthogonally transformed by the inverse orthogonal transform section 69. The inversely orthogonally transformed output is added to a predicted image supplied from the predicted image selection section 76 by the arithmetic operation section 70 so that it is converted into a locally decoded image. The deblock filter 71 removes block distortion of the decoded image and supplies a resulting image to the frame memory 72 so as to be accumulated into the frame memory 72. Also the image before it is deblock filter processed by the deblock filter 71 is supplied to and accumulated into the frame memory 72.

The switch 73 outputs reference images accumulated in the frame memory 72 to the motion prediction and compensation section 75 or the intra prediction section 74.

In the image encoding apparatus 51, for example, I pictures, B pictures and P pictures from the screen reordering buffer 62 are supplied as images to be subjected to intra prediction (also referred to as intra process) to the intra prediction section 74. Further, B pictures and P pictures read out from the screen reordering buffer 62 are supplied as images to be subjected to inter prediction (also referred to as inter process) to the motion prediction and compensation section 75.

The intra prediction section 74 carries out an intra prediction process in all candidate intra prediction modes based on an image for intra prediction read out from the screen reordering buffer 62 and a reference image supplied from the frame memory 72 to produce a predicted image.

Thereupon, the intra prediction section 74 calculates a cost function value with regard to all candidate intra prediction modes and selects that one of the intra prediction modes which exhibits a minimum value among the calculated cost function values as an optimum intra prediction mode.

This cost function is also called RD (Rate Distortion) cost, and the value thereof is calculated based on such a technique as the High Complexity mode or the Low Complexity mode as are prescribed, for example, by the JM (Joint Model) which is reference software for the H.264/AVC method.

In particular, in the case where the High Complexity mode is adopted as the calculation technique for the cost function value, the processes up to the encoding process are carried out temporarily with regard to all candidate intra prediction modes, and a cost function represented by the following expression (6) is calculated with regard to the intra prediction modes.

Cost(Mode)=D+λ·R (6)

D is the difference (distortion) between the original image and the decoded image, R a generated code amount including up to orthogonal transform coefficients, and λ the Lagrange's multiplier given as a function of a quantization parameter QP.

On the other hand, in the case where the Low Complexity mode is adopted as the calculation technique for the cost function value, production of an intra prediction image and calculation of header bits of information representative of an intra prediction mode and so forth are carried out with regard to all candidate intra prediction modes, and a cost function represented by the following expression (7) is calculated with regard to the intra prediction modes.

Cost(Mode)=D+QPtoQuant(QP)·Header_Bit (7)

D is the difference (distortion) between the original image and the decoded image, Header_Bit a header bit for the intra prediction mode, and QPtoQuant a function given as a function of the quantization parameter QP.

In the Low Complexity mode, only it is necessary to produce an intra prediction image with regard to all intra prediction modes and there is no necessity to carry out an encoding process, and therefore, the amount of arithmetic operation may be small.

The intra prediction section 74 supplies the predicted image produced in the optimum intra prediction mode and the cost function value of the predicted image to the predicted image selection section 76. In the case where the predicted image produced in the optimum intra prediction mode is selected by the predicted image selection section 76, the intra prediction section 74 supplies information indicative of the optimum intra prediction mode to the lossless encoding section 66. The lossless encoding section 66 encodes this information and uses the encoded information as part of header information for the compressed image.

The motion prediction and compensation section 75 uses an interpolation filter of fixed filter coefficients to carry out a filter process for the reference image. It is to be noted that the representation that a filter coefficient is fixed does not mean to fix a filter coefficient to one, but it signifies fixation against variation in the AIF (Adaptive Interpolation Filter) and naturally it is possible to replace the coefficient. In the following, a filter process by a fixed interpolation filter is referred to as fixed filter process.

The motion prediction and compensation section 75 carries out motion prediction of a block in all candidate inter prediction modes based on an image to be inter processed and a reference image after the fixed filter process to produce a motion vector for each block. Then, the motion prediction and compensation section 75 carries out a compensation process for the reference image after the fixed filter process to produce a predicted image. At this time, the motion prediction and compensation section 75 determines a cost function value of a block of a processing object with regard to all candidate inter prediction modes and determines a prediction mode, and determines a cost function value of a slice of a processing object in the determined prediction mode.

Further, the motion prediction and compensation section 75 uses the produced motion vectors, the image to be inter processed and the reference image to determine filter coefficients of an interpolation filter (AIF) which has variable coefficients and has a tap number suitable for the type of the slice. Then, the motion prediction and compensation section 75 uses the filter of the determined filter coefficients to carry out a filter process for the reference image. It is to be noted that a filter process by the variable interpolation filter is hereinafter referred to also as variable filter process.

Here, in the motion prediction and compensation section 75, filter coefficients (hereinafter referred to as fixed filter coefficients) for fixed filters to be used for weighted prediction (hereinafter referred to as L0L1 weighted prediction) in which at least reference pixels of L0 and L1 are used and fixed filter coefficients used for any other prediction are stored. Also in the case of the variable filter process, the motion prediction and compensation section 75 calculates filter coefficients (hereinafter referred to as variable filter coefficients) for variable filters to be used at least for L0L1 weighted prediction and variable filter coefficients to be used for any other prediction.

For example, filter coefficients used for L0L1 weighted prediction have such a filter characteristic that high frequency components of an image after the filter process are amplified.

Then, in the case where L0L1 weighted prediction is carried out, the motion prediction and compensation section 75 carries out prediction with fixed filter coefficients and variable filter coefficients which are used for weighted prediction in which reference pixels of L0 and L1 are used. On the other hand, in the case where prediction other than L0L1 weighted prediction is to be carried out, the motion prediction and compensation section 75 carries out prediction with fixed filter coefficients and variable filter coefficients which are used for prediction other than weighted prediction in which reference pixels of L0 and L1 are used.

The motion prediction and compensation section 75 carries out motion prediction of blocks in all candidate inter prediction modes based on the image to be inter processed and the reference images after the variable filter process again to produce a motion vector for each block. Then, the motion prediction and compensation section 75 carries out a compensation process for the reference image after the variable filter process to produce a predicted image. At this time, the motion prediction and compensation section 75 determines a cost function value of a block of a processing object with regard to all candidate inter prediction modes and determines a prediction mode, and then determines a cost function value of a slice of the processing object in the determined prediction mode.

Then, the motion prediction and compensation section 75 compares the cost function value after the fixed filter process and the cost function value after the variable filter process. The motion prediction and compensation section 75 adopts that one of the cost function values which has a lower value and outputs the prediction image and the cost function value to the predicted image selection section 76, and sets an AIF use flag indicative of whether or not the slice of the processing object uses the AIF. This AIF use flag is used for each of filter coefficients to be used for L0L1 weighted prediction and filter coefficients to be used for any other prediction.

In the case where a prediction image of an object block in an optimum inter prediction mode is selected by the predicted image selection section 76, the motion prediction and compensation section 75 outputs information indicative of the optimum inter prediction mode (inter prediction mode information) to the lossless encoding section 66.

At this time, the motion vector information, reference frame information, information of the slice and AIF use flag as well as, in the case where the AIF is used, filter coefficients and so forth are outputted to the lossless encoding section 66. The lossless encoding section 66 carries out a lossless encoding process such as variable length encoding or arithmetic encoding again for the information from the motion prediction and compensation section 75 and inserts resulting information into the header part of the compressed image. It is to be noted that the slice information, AIF use flag and filter coefficients are inserted into the slice header.

The predicted image selection section 76 determines an optimum prediction mode from an optimum intra prediction mode and an optimum inter prediction mode based on cost function values outputted from the intra prediction section 74 or the motion prediction and compensation section 75. Then, the predicted image selection section 76 selects a predicted image of the determined optimum prediction mode and supplies the prediction image to the arithmetic operation sections 63 and 70. At this time, the predicted image selection section 76 supplies a selection signal of the prediction image to the intra prediction section 74 or the motion prediction and compensation section 75 as indicated by a dotted line.

The rate controlling section 77 controls the rate of the quantization operation of the quantization section 65 based on compressed images accumulated in the accumulation buffer 67 so that an overflow or an underflow may not occur.

### [Example of the Configuration of the Motion Prediction and Compensation Section]

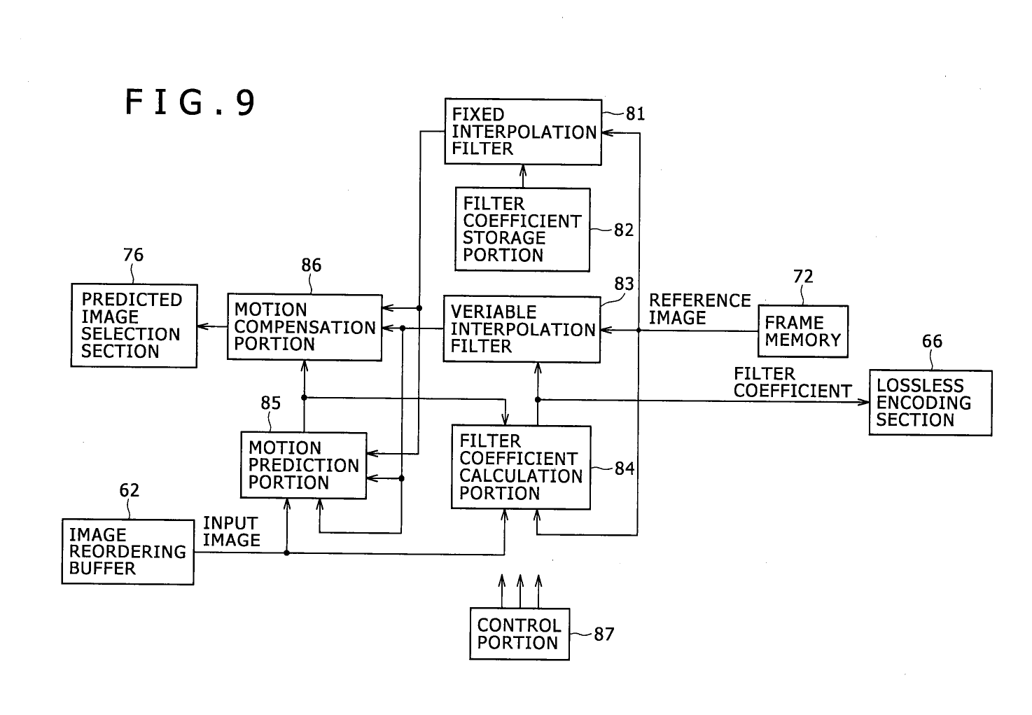

FIG. 9 is a block diagram showing an example of a configuration of the motion prediction and compensation section 75. It is to be noted that, in FIG. 9, the switch 73 of FIG. 8 is omitted.

In the example of FIG. 9, the motion prediction and compensation section 75 is configured from a fixed interpolation filter 81, a filter coefficient storage portion 82, a variable interpolation filter 83, a filter coefficient calculation portion 84, a motion prediction portion 85, a motion compensation portion 86 and a control portion 87.

An input image (image to be inter processed) from the screen reordering buffer 62 is inputted to the filter coefficient calculation portion 84 and the motion prediction portion 85. A reference image from the frame memory 72 is inputted to the fixed interpolation filter 81, variable interpolation filter 83 and filter coefficient calculation portion 84.

The fixed interpolation filter 81 is an interpolation filter having fixed filter coefficients (that is, different from an AIF). The fixed interpolation filter 81 carries out a filter process for the reference image from the frame memory 72 using the filter coefficients from the filter coefficient storage portion 82 and outputs the reference image after the fixed filter process to the motion prediction portion 85 and the motion compensation portion 86.

The filter coefficient storage portion 82 stores fixed filter coefficients at least for L0L1 weighted prediction and for any other prediction to be used by the fixed interpolation filter 81 and reads out and selects the filter coefficients under the control of the control portion 87. Then, the filter coefficient storage portion 82 supplies the selected fixed filter coefficients to the fixed interpolation filter 81.

The variable interpolation filter 83 is an interpolation filter having variable coefficients (that is, an AIF). The variable interpolation filter 83 carries out a filter process for the reference image from the frame memory 72 using variable filter coefficients calculated by the filter coefficient calculation portion 84 and outputs the reference image after the variable filter process to the motion prediction portion 85 and the motion compensation portion 86.

The filter coefficient calculation portion 84 calculates filter coefficients for adjusting the reference image after the filter process of the variable interpolation filter 83 toward the input image using the input image from the screen reordering buffer 62, the reference image from the frame memory 72, and motion vectors for the first time from the motion prediction portion 85. For example, the filter coefficient calculation portion 84 calculates at least variable filter coefficients to be used for L0L1 weighted prediction and variable filter coefficients for use for any other prediction. The filter coefficient calculation portion 84 selects the calculated variable filter coefficients under the control of the control portion 87 and supplies the selected variable filter coefficients to the variable interpolation filter 83.

Further, in the case where an inter prediction image is selected by the control portion 87 in the predicted image selection section 76 and a variable filter is to be used for an object slice, the filter coefficient calculation portion 84 outputs the variable filter coefficients corresponding to L0L1 weighted prediction or any other prediction to the lossless encoding section 66 under the control of the control portion 87.

The motion prediction portion 85 produces a motion vector for the first time for all candidate inter prediction modes based on the input image from the screen reordering buffer 62 and the reference image after the fixed filtering from the fixed interpolation filter 81, and outputs the produced motion vectors to the filter coefficient calculation portion 84 and the motion compensation portion 86. Further, the motion prediction portion 85 produces a motion vector for the second time for all candidate inter prediction modes based on the input image from the screen reordering buffer 62 and the reference image after the variable filter from the variable interpolation filter 83 and outputs the produced motion vectors to the motion compensation portion 86.

The motion compensation portion 86 uses the motion vectors for the first time to carry out a compensation process for the reference image after the fixed filtering from the fixed interpolation filter 81 to produce a prediction image. Then, the motion compensation portion 86 calculates a cost function value for each block to determine an optimum inter prediction mode and calculates a cost function value for the first time of an object slice in the determined optimum inter prediction mode.

The motion compensation portion 86 subsequently uses the motion vectors for the second time to carry out a compensation process for the reference image after the variable filtering from the variable interpolation filter 83 to produce a prediction image. Then, the motion compensation portion 86 calculates a cost function value for each block to determine an optimum inter prediction mode and calculates a cost function value for the second time of the object slice in the determined optimum inter prediction mode.

Then, the motion compensation portion 86 compares the cost function value for the first time and the cost function value for the second time with each other with regard to the object slice and determines to use that one of the filters which exhibits a lower value. In particular, in the case where the cost function value for the first time is lower, the motion compensation portion 86 determines to use the fixed filter with regard to the object slice and supplies the prediction image and the cost function value produced with the reference image after the fixed filtering to the predicted image selection section 76 and then sets the value of the AIF use flag to 0 (not used). On the other hand, in the case where the cost function value for the second time is lower, the motion compensation portion 86 determines to use a variable filter with regard to the object slice. Then, the motion compensation portion 86 supplies the prediction image and the cost function value produced with the reference image after the variable filtering to the predicted image selection section 76 and sets the value of the AIF use flag to 1 (used).

It is to be noted that this AIF use flag is set for each of filter coefficients to be used for L0L1 weighted prediction and filter coefficients to be used for any other prediction. Accordingly, in the case where fixed filters are to be used with regard to the object slice, the values of both flags corresponding to them are set to 0. In the case where variable filters are used with regard to the object slice, the values of both flags are set to 1 if filter coefficients for both the filters are calculated. In other words, a flag corresponding to a filter coefficient which is not calculated (that is, in which a corresponding prediction mode is not used) is set to 0 even in the case where a variable filter is used.

In the case where the predicted image selection section 76 selects an inter prediction image, the motion compensation portion 86 outputs the information of the optimum inter prediction mode, information of the slice which includes the type of the slice, AIF use flag, motion vector, information of the reference image and so forth to the lossless encoding section 66 under the control of the control portion 87.

The control portion 87 controls the filter coefficient storage portion 82 and the filter coefficient calculation portion 84 in response to the type of the prediction, that is, in response to L0L1 weighted prediction or any other prediction. In particular, in the case of L0L1 weighted prediction, the control portion 87 controls the filter coefficient storage portion 82 to select filter coefficients to be used for L0L1 weighted prediction and controls the filter coefficient calculation portion 84 to select filter coefficients to be used for L0L1 weighted prediction. Further, in the case of any other prediction (that is, in the case of prediction in which L0L1 weighted prediction is not carried out), the control portion 87 controls the filter coefficient storage portion 82 to select filter coefficients to be used for the other prediction and controls the filter coefficient calculation portion 84 to select filter coefficients to be used for the other prediction.

On the other hand, if a signal representing that an inter prediction image from the predicted image selection section 76 is selected is received, then the control portion 87 carries out control of causing the motion compensation portion 86 and the filter coefficient calculation portion 84 to output necessary information to the lossless encoding section 66.

### [Classification of Filter Coefficients]

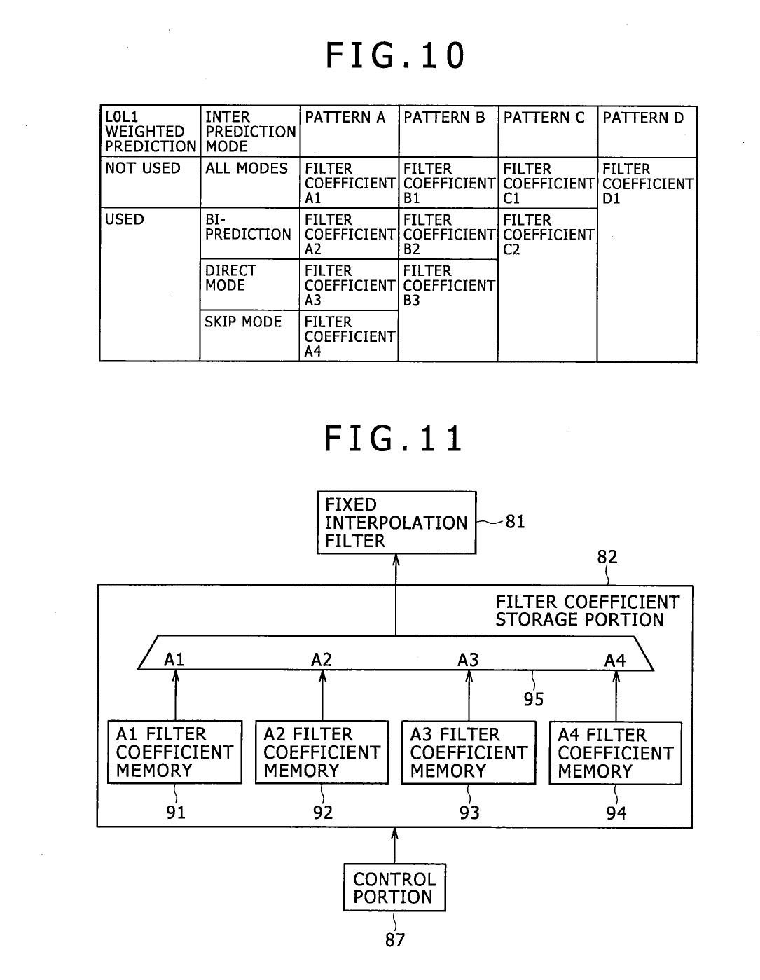

Now, a classification method of filter coefficients is described with reference to FIG. 10. It is to be noted that, in the example of FIG. 10, if a numeral and an alphabetical letter at a portion represented as filter [X][X] in the example of FIG. 10 are different, then this represents that the filter is different in characteristic.

The method of classifying filter coefficients by the motion prediction and compensation section 75 involves three different patterns A to C illustrated in FIG. 10 depending upon whether or not the L0L1 weighted prediction is used. It is to be noted that, in the bi-prediction mode, direct mode and skip mode from among all prediction modes, there is the possibility that the L0L1 weighted prediction may be used.

The pattern A is a method of classifying filter coefficients into four filter coefficients A1 to A4. The filter coefficient A1 is used for all inter prediction modes in the case where the L0L1 weighted prediction is not used. The filter coefficient A2 is used in the bi-prediction mode in the case where the L0L1 weighted prediction is used. The filter coefficient A3 is used in the direct mode in the case where the L0L1 weighted prediction is used. The filter coefficient A4 is used in the skip mode in the case where the L0L1 weighted prediction is used.

The pattern B is a method of classifying filter coefficients into three filter coefficients B1 to B3. The filter coefficient B1 is used in all of the inter prediction modes in the case where the L0L1 weighted prediction is not used. The filter coefficient B2 is used in the bi-prediction mode in the case where the L0L1 weighted prediction is used. The filter coefficient B3 is used in modes other than the bi-prediction mode in the case where the L0L1 weighted prediction is used, that is, in the direct mode or skip mode.

The pattern C is a method of classifying filter coefficients into two filter coefficients C1 and C2. The filter coefficient C1 is used in all inter prediction modes in the case where the L0L1 weighted prediction is not used. The filter coefficient C2 is used in a prediction mode in the case where the L0L1 weighted prediction is used, that is, in the bi-prediction mode, direct mode or skip mode.

For reference, in the prior art, filter coefficients are not classified depending upon whether or not the L0L1 weighted prediction is used, but prediction is carried out with one kind of a filter coefficient D1.

In particular, the pattern C is an example wherein filter coefficients are classified roughly depending upon whether or not the L0L1 weighted prediction is used or not, and the pattern B is an example wherein, in the case where the L0L1 weighted prediction is used, filter coefficients are further classified from the pattern C depending upon whether or not the prediction mode is the bi-prediction mode. Further, the pattern A is an example wherein the pattern is further classified from the pattern B, in the case where the prediction mode is not the bi-prediction mode, depending upon whether the prediction mode is the direct mode or the skip mode.

In the pattern C, the filter coefficient C2 in the case where weighted prediction is carried out rather than the filter coefficient C1 has such a characteristic that high frequency components which are lost by weighted prediction are amplified. By this, high frequency components which are to be lost by weighted prediction can be supplemented.

In the pattern B, the filter coefficient B2 and the filter coefficient B3 further have different characteristics from each other in the case where weighted prediction is carried out. For example, as a difference between the filter characteristics of the filter coefficient B2 and the filter coefficient B3, the degree of amplification of high frequency components which are lost by weighted prediction is different. Consequently, as described hereinabove with reference to FIG. 7, it is possible to cope with a case in which the degree of displacement is different between the bi-prediction mode and the direct mode (skip mode).

In the pattern A, the filter coefficients A2 to A4 further have different characteristics from each other in the case where weighted prediction is carried out. For example, as a difference in filter characteristic among the filter coefficients A2 to A4, the degree of amplification of high frequency components which are lost by weighted prediction is different among the filter coefficients A2 to A4. Consequently, it is possible to cope with a case in which the degree of positional displacement is different among the bi-prediction mode, direct mode and skip mode.

It is to be noted that, while the following description is given of a case of the pattern A as a representative of the patterns A to C, the following description applies similarly also to the pattern B and the pattern C although only the number of filter coefficients is different.

### [Example of the Configuration of the Filter Coefficient Storage Portion]

FIG. 11 is a block diagram showing an example of a configuration of the filter coefficient storage portion in the case of the pattern A.

In the example of FIG. 11, the filter coefficient storage portion 82 is configured from an A1 filter coefficient memory 91, an A2 filter coefficient memory 92, an A3 filter coefficient memory 93, an A4 filter coefficient memory 94, and a selector 95.

The A1 filter coefficient memory 91 stores filter coefficients A1 for use in all inter prediction modes in the case where the L0L1 weighted prediction is not used and outputs a filter coefficient A1 to the selector 95. The A2 filter coefficient memory 92 stores filter coefficients A2 for use in the bi-prediction mode in the case where the L0L1 weighted prediction is used and outputs a filter coefficient A2 to the selector 95.

The A3 filter coefficient memory 93 stores filter coefficient A3 for use in the direct mode in the case where the L0L1 weighted prediction is used and outputs a filter coefficient A3 to the selector 95. The A4 filter coefficient memory 94 stores filter coefficients A4 for use in the skip mode in the case where the L0L1 weighted prediction is used and outputs a filter coefficient A4 to the selector 95.

The selector 95 selects one of the filter coefficients A1 to A4 under the control of the control portion 87 and outputs the selected filter coefficient to the fixed interpolation filter 81.

### [Example of the Configuration of the Filter Coefficient Calculation Portion]

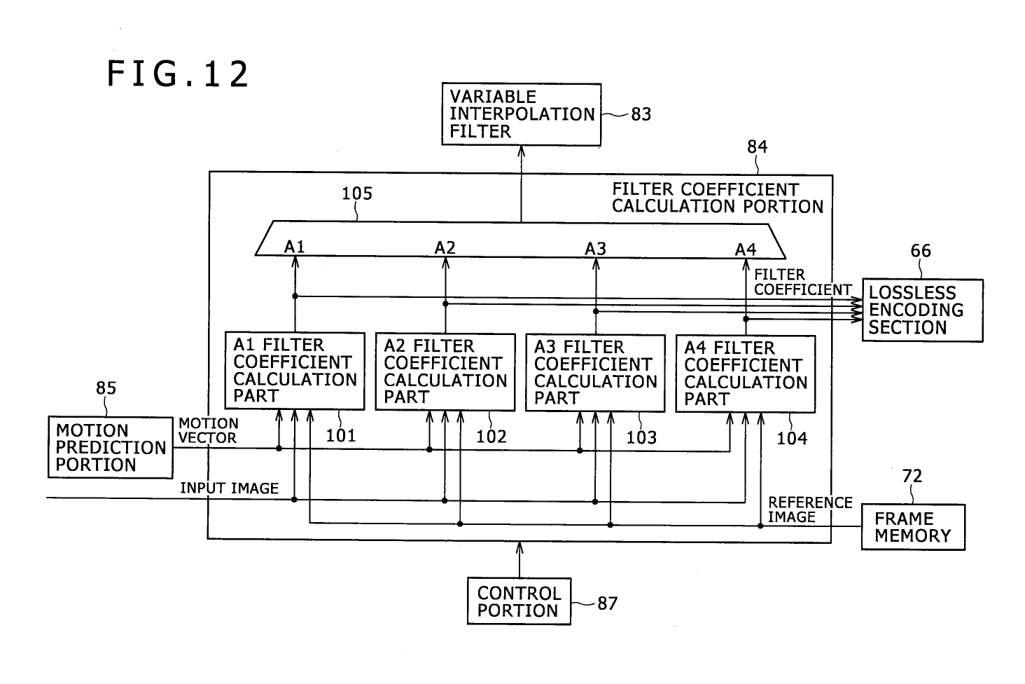

FIG. 12 is a block diagram showing an example of a configuration of the filter coefficient calculation portion in the case of the pattern A.

In the example of FIG. 12, the filter coefficient calculation portion 84 is configured from an A1 filter coefficient calculation part 101, an A2 filter coefficient calculation part 102, an A3 filter coefficient calculation part 103, an A4 filter coefficient calculation part 104 and a selector 105.

The A1 filter coefficient calculation part 101 uses an input image from the screen reordering buffer 62, a reference image from the frame memory 72 and motion vectors for the first time from the motion prediction portion 85 to calculate the filter coefficient A1 which is used in all inter prediction modes in the case where the L0L1 weighted prediction is not used, and outputs the filter coefficient A1 to the selector 105. The A2 filter coefficient calculation part 102 uses an input image from the screen reordering buffer 62, a reference image from the frame memory 72 and motion vectors for the first time from the motion prediction portion 85 to calculate the filter coefficient A2 which is used in the bi-prediction mode in the case where the L0L1 weighted prediction is used, and outputs the filter coefficient A2 to the selector 105.

The A3 filter coefficient calculation part 103 uses an input image from the screen reordering buffer 62, a reference image from the frame memory 72 and motion vectors for the first time from the motion prediction portion 85 to calculate the filter coefficient A3 which is used in the direct mode in the case where the L0L1 weighted prediction is used, and outputs the filter coefficient A3 to the selector 105. The A4 filter coefficient calculation part 104 uses an input image from the screen reordering buffer 62, a reference image from the frame memory 72 and motion vectors for the first time from the motion prediction portion 85 to calculate the filter coefficient A4 for use in the skip mode in the case where the L0L1 weighted prediction is used, and outputs the filter coefficient A4 to the selector 105.

The selector 105 selects one of the filter coefficients A1 to A4 under the control of the control portion 87 and outputs the selected coefficient to the variable interpolation filter 83.

### [Calculation Method of a Filter Coefficient]

Now, a calculation method of a filter coefficient is described. It is to be noted that a calculation method of the filter coefficient A1 which is used in all inter prediction modes in the case where the L0L1 weighted prediction by the A1 filter coefficient calculation part 101 is not used is described first.

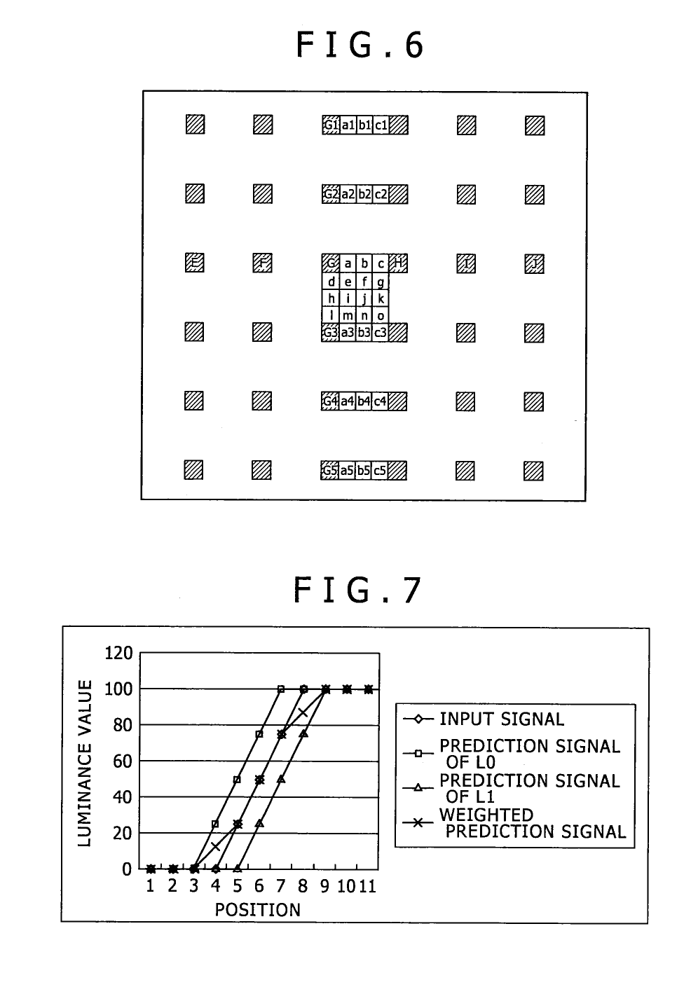

As regards the calculation method of a filter coefficient, since several types are available with the interpolation method of an AIF, although there are slight differences, they are same in such a basic portion that the least squares method is used. The variable interpolation filter 83 carries out an interpolation process, for example, by a Separable adaptive interpolation filter (hereinafter referred to as Separable AIF) described hereinabove with reference to FIG. 6. Therefore, an interpolation method is described wherein, after a horizontal interpolation process, interpolation in the vertical direction is carried out at two stages by a Separable AIF as a representative.

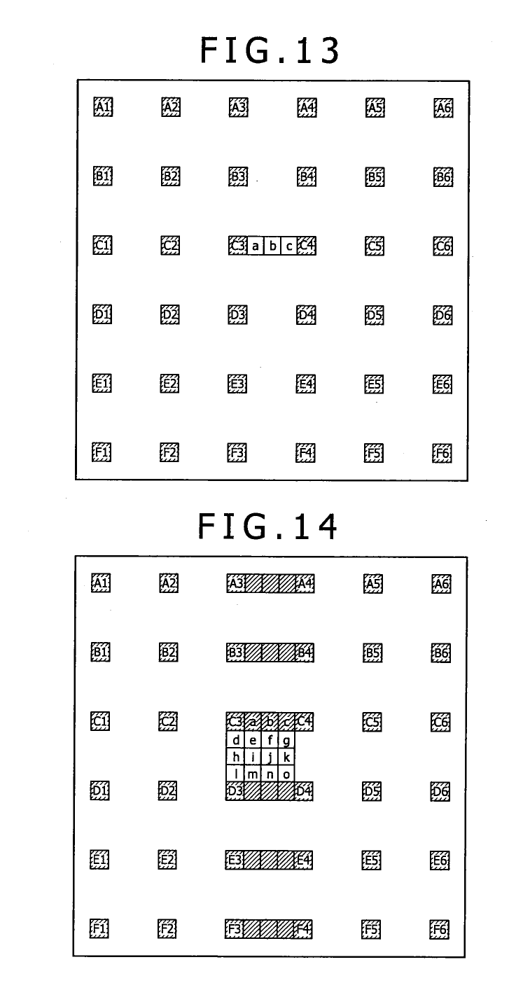

FIG. 13 represents a filter in the horizontal direction of the Separable AIF. In the filter in the horizontal direction shown in FIG. 13, a square to which slanting lines are applied represents a pixel at an integral position (Integer pel (int. pel)), and a blank square represents a pixel at a fractional position (Sub pel). Further, an alphabetical letter in a square represents a pixel value of a pixel represented by the square.

First, interpolation in the horizontal direction is carried out, that is, filter coefficients for pixel positions of fractional positions of pixel values a, b and c of FIG. 13 are determined. Here, since a six-tap filter is used, in order to calculate the pixel values a, b and c at the fractional positions, pixel values C1, C2, C3, C4, C5 and C6 at integral positions are used, and the filter coefficients are calculated so as to minimize the following expression (8).

[Expression 1]

eₛₚ²=Σ_{x,y}[S_{x,y}−Σᵢ₌₀⁵h_{sp,i}·P_{\tilde{x}+i,y}]² (8)

Here, e is a prediction error, sp one of the pixel values a, b and c at the fractional positions, S an original signal, P a decoded reference pixel value, and x and y are a pixel position of an object of the original signal.

Further, in the expression (8), \tilde{x} is the following expression (9).

[Expression 2]

\tilde{x}=x+MVₓ−FilterOffset (9)

MVₓ and sp are detected by motion prediction for the first time, and wherein MVₓ is a motion vector in the horizontal direction in integral accuracy and sp represents a pixel position of a fractional position and corresponds to a fraction part of the motion vector. FilterOffset corresponds to a value obtained by subtracting 1 from one half of the tap number of the filter, and here, 2=6/2−1. h is a filter coefficient, and i assumes a value from 0 to 5.

Optimum filter coefficients for the pixel values a, b and c can be determined as h which minimizes the square of e. As indicated by the following expression (10), simultaneous equations are obtained such that a value obtained by partial differentiation of the square of a prediction error by h is set to be 0. By solving the simultaneous equations, filter coefficients which are independent of each other with regard to i from 0 to 5 where the pixel value (sp) of a fractional position is a, b and c can be determined.

$$\begin{matrix}[ Expression 3 ] & \\ \begin{matrix}0 = \frac{{( \partial {e}_{sp} )}^{2}}{\partial {h}_{sp , i}} \\ = {\frac{\partial }{\partial {h}_{sp , i}} [ {\sum }_{x , y} [ {S}_{x , y} - {\sum }_{i = 0}^{5} {h}_{sp , i} {P}_{\tilde{x} + i , y} ] ]}^{2} \\ = {\sum }_{x , y} [ {S}_{x , y} - {\sum }_{i = 0}^{5} {h}_{sp , i} {P}_{\tilde{x} + i , y} ] {P}_{\tilde{x} + i , y}\end{matrix} \\ ∀ sp ∈ \{ a , b , c \} \\ ∀ i ∈ \{ 0 , 1 , 2 , 3 , 4 , 5 \} & ( 10 )\end{matrix}$$

Describing more particularly, a motion vector is determined with regard to all blocks by a motion search for the first time. The pixel values a, b and c are determined such that the following expression (11) in the expression (10) is determined using a block whose fractional position is the pixel value a as input data in the motion vector and can be solved with regard to a filter coefficient h_{a,i}, ∀iε{0,1,2,3,4,5} for the interpolation for the pixel position of the pixel value a.

[Expression 4]

P_{\tilde{x}+i,y},S_{x,y} (11)

Since the filter coefficients in the horizontal direction are determined and it becomes possible to carry out an interpolation process, if interpolation is carried out with regard to the pixel values a, b and c, then such a filter in the vertical direction illustrated in FIG. 14 is obtained. In FIG. 14, the pixel values a, b and c are interpolated using optimum filter coefficients, and interpolation is carried out also between the pixel values A3 and A4, between the pixel values B3 and B4, between the pixel values D3 and D4, between the pixel values E3 and E4 and between the pixel values F3 and F4 similarly.

In particular, in the filters in the horizontal direction of the Separable AIF illustrated in FIG. 14, a square to which slanting lines are applied represents a pixel at an integral position or a pixel at a fractional position determined already by a filter in the horizontal direction, and a blank square represents a pixel at a fractional position to be determined by a filter in the horizontal direction. Further, an alphabetical letter in a square represents a pixel value of a pixel represented by the square.

Also in the case of the vertical direction illustrated in FIG. 14, a filter coefficient can be determined so as to minimize the prediction error of the following expression (12) similarly as in the case of the horizontal direction.

[Expression 5]

eₛₚ²=Σ_{x,y}[S_{x,y}−Σⱼ₌₀⁵h_{sp,j}·\hat{P}_{\tilde{x},\tilde{y}+j}]² (12)

Here, the expression (13) represents a reference pixel encoded already or an interpolated pixel, an expression (14), and an expression (15).

[Expression 6]

\hat{P} (13)

[Expression 7]

\tilde{x}=4·x+MVₓ (14)

[Expression 8]

\tilde{y}=y+MV_{y}−FilterOffset (15)

Further, MV_{y} and sp are detected by motion prediction for the first time, and wherein MV_{y} is a motion vector in the vertical direction in integral accuracy and sp represents a pixel position of a fractional position and corresponds to the fraction part of the motion vector. FilterOffset corresponds to a value obtained by subtracting 1 from one half of the tap number of the filter, and here is 2=6/2−1. h is a filter coefficient, and j varies from 0 to 5.

Similarly as in the case of the horizontal direction, the filter coefficient h is calculated such that the square of the prediction error of the expression (12) may be minimized. Therefore, as seen from the expression (16), a result obtained by partial differentiation of the square of the prediction error by h is set to 0 to obtain simultaneous equations. By solving the simultaneous equations regarding the pixels at the fractional positions, that is, the pixel values d, e, f, g, h, i, j, k, l, m, n and o, optimum filter coefficients of interpolation filters in the vertical direction at the pixels at the fractional positions can be obtained.

$$\begin{matrix}[ Expression 9 ] & \\ \begin{matrix}0 = \frac{{( \partial {e}_{sp} )}^{2}}{\partial {h}_{sp , j}} \\ = {\frac{\partial }{\partial {h}_{sp , j}} [ {\sum }_{x , y} [ {S}_{x , y} - {\sum }_{j = 0}^{5} {h}_{sp , j} {\hat{P}}_{\tilde{x} , \tilde{y} + j} ] ]}^{2} \\ = {\sum }_{x , y} [ {S}_{x , y} - {\sum }_{j = 0}^{5} {h}_{sp , j} {\hat{P}}_{\tilde{x} , \tilde{y} + j} ] {\hat{P}}_{\tilde{x} , \tilde{y} + j}\end{matrix} \\ ∀ sp ∈ \{ d , e , f , g , h , i , j , k , l , m , n , o \} & ( 16 )\end{matrix}$$

Now, a calculation method of a filter coefficient used in the bi-prediction mode, for example, in the case where the L0L1 weighted prediction by the A2 filter coefficient calculation part 102 is used is described.

It is to be noted that, conventionally, even in a prediction mode in which weighted prediction is carried out, a filter coefficient is calculated by a calculation method by the A1 filter coefficient calculation part 101 described hereinabove between an L0 reference picture and a source signal (input image) or between an L1 reference picture and a source signal.

In contrast, in a calculation method of a filter coefficient to be used in the bi-prediction mode, for example, in the case where the L0L1 weighted prediction is used, the prediction error of the expression (8) described hereinabove undergoes a change like the prediction error of multiple reference indicated by the following expression (17).

$$\begin{matrix}[ Expression 10 ] & \\ {e}_{spL 0 , sp L 1}^{2} = {\sum }_{x , y} {[ {S}_{x , y} - \frac{1}{2} [ {\hat{P}}_{sp L 0 , x , y , MVL 0} + {\hat{P}}_{sp L 1 , x , y , MVL 1} ] ]}^{2} \\ {\hat{P}}_{spL 0 , x , y , MVL 0} = {\sum }_{i = 0}^{5} {h}_{spL 0 , i} \cdot {P}_{L 0 , \tilde{x} + i , y} \\ {\hat{P}}_{spL 1 , x , y , MVL 1} = {\sum }_{i = 0}^{5} {h}_{spL 1 , i} \cdot {P}_{L 1 , \tilde{x} + i , y} & ( 17 )\end{matrix}$$

Here, in the expression (17), spL0 is an interpolation position corresponding to the fraction part of a motion vector of L0 reference obtained by motion search for the first time, and spL1 is an interpolation position corresponding to the fraction part of a motion vector of L1 reference. MVL0 corresponds to a motion vector of integral accuracy for L0 reference and MVL1 corresponds to a motion vector of integral accuracy for L1 reference. e²_{sp0,sp1} is an L1 prediction error.

Further, the following expression (18) represents a reference pixel after an interpolation process of L0 prediction and the following expression (19) represents a reference pixel after an interpolation process of L1 prediction, and the following expression (20) is a picture of L0 reference and L1 reference.

[Expression 11]

\hat{P}_{L0,spL0,x,y,MVL0} (18)

[Expression 12]

\hat{P}_{L1,spL1,x,y,MVL1} (19)

[Expression 13]

P_{L0,\tilde{x}+i,y},P_{L1,x+i,y} (20)

Further, in the expression (17), h_{spL0,i} and h_{spL1,i} are filter coefficients of L0 reference and L1 reference, and spL0 and spL1 individually become a, b or c.

Here, for simplified description, the weighted prediction uses an equal weight for L0 and L1. By minimizing the prediction error e²_{sp0,sp1} similarly as in the past, optimum filter coefficients h_{spL0,i} and h_{spL1,i} are calculated. By partially differentiating this e²_{sp0,sp1} by h and setting the same to 0, simultaneous equations indicated by the following expression (21) are obtained.

$$\begin{matrix}[ Expression 14 ] & \\ 0 = \frac{\partial {e}_{spL 0 , spL 1}^{2}}{\partial {h}_{spLx , i}} \\ 0 = {\frac{\partial }{\partial {h}_{spLx , i}} [ {\sum }_{x , y} [ {S}_{x , y} - \frac{1}{2} [ {\hat{P}}_{spL 0 , x , y , MVL 0} + {\hat{P}}_{spL 1 , x , y , MVL 1} ] ] ]}^{2} \\ 0 = {\sum }_{x , y} [ {S}_{x , y} - \frac{1}{2} [ {\sum }_{i = 0}^{5} {h}_{spL 0 , i} \cdot {P}_{L 0 , \tilde{x} + i , y} + {\sum }_{i = 0}^{5} {h}_{spL 1 , i} \cdot {P}_{L 1 , \tilde{x} + i , y} ] ] {P}_{Lx , \tilde{x} + i , y} \\ ∀ spL 0 , spL 1 ∈ \{ a , b , c \} \\ ∀ x ∈ \{ 0 , 1 \} \\ ∀ i ∈ \{ 0 , 1 , 2 , 3 , 4 , 5 \} \\ \begin{matrix}0 = \frac{{( \partial {e}_{c} )}^{2}}{\partial {h}_{a , 5 - i}} \\ = {\frac{\partial }{\partial {h}_{a , 5 - i}} [ {\sum }_{x , y} [ {S}_{x , y} - {\sum }_{i = 0}^{5} {h}_{a , 5 - i} {P}_{\tilde{x} + i , y} ] ]}^{2} \\ = {\sum }_{x , y} [ {S}_{x , y} - {\sum }_{i = 0}^{5} {h}_{a , 5 - i} {P}_{\tilde{x} + i , y} ] {P}_{\tilde{x} + i , y}\end{matrix} \\ ∀ i ∈ \{ 0 , 1 , 2 , 3 , 4 , 5 \} & ( 21 )\end{matrix}$$

Here, x is a part of a numeral of L0 and L1 in the reference direction, and by solving the simultaneous equations of this expression (21), optimum filter coefficients h_{spL0,i} and h_{spL1,i} in the combination of spL0 and spL1 are obtained.

If the method described above is carried out, then a number of filter coefficients corresponding to the number of combinations of pixel positions of fractional positions of the L0 motion vectors and pixel positions of fractional positions of the L1 motion vectors are obtained. However, if all of the combinations are used, then 15×15=225 combinations are used like such combinations as a-a, a-b, a-c, . . . , o-m and o-o.

If the number of kinds of filter coefficients becomes excessively great in this manner, then an overhead to be included in stream information cannot be ignored any more. Therefore, a method of decreasing combinations of filter coefficients is described below.

Again, the prediction error is defined as given by the following expression (22) from the expression (17).

$$\begin{matrix}[ Expression 15 ] & \\ {e}_{spL 0}^{2} = {\sum }_{x , y} {[ {S}_{x , y} - \frac{1}{2} [ {\hat{P}}_{spL 0 , x , y , MVL 0} + {\hat{P}}_{spL 1 , x , y , MVL 1} ] ]}^{2} \\ {\hat{P}}_{spL 0 , x , y , MVL 0} = {\sum }_{i = 0}^{5} {h}_{spL 0 , i} \cdot {P}_{L 0 , \tilde{x} + i , y} \\ {\hat{P}}_{spL 1 , x , y , MVL 1} = {\sum }_{i = 0}^{5} {h}_{spL 1 , i}^{FIX} \cdot {P}_{L 1 , \tilde{x} + i , y} & ( 22 )\end{matrix}$$

Here, e²ₛₚ₀ is a prediction error when the fraction part of the motion vector of L0 (pixel position at the fractional position) is spL0, and h^{FIX}_{spL1,i} is a fixed filter coefficient, as which a filter coefficient which is used by a representative interpolation filter is used. While, in the expression (17) given hereinabove, the prediction error is given by a combination of spL0 and spL1, in the expression (22), the prediction error is given only to spL0.

By minimizing the prediction error e²_{sp0,sp1} similarly as in the foregoing, optimum filter coefficients h_{spL0,i} and h_{spL1,i} are calculated from the expression (22). By partially differentiating this e²_{sp0,sp1} by h and setting the same to 0, simultaneous equations indicated by the following expression (23) are obtained.

$$\begin{matrix}[ Expression 16 ] & \\ 0 = \frac{\partial {e}_{spL 0}^{2}}{\partial {h}_{spL 0 , i}} \\ 0 = {\frac{\partial }{\partial {h}_{spL 0 , i}} [ {\sum }_{x , y} [ {S}_{x , y} - \frac{1}{2} [ {\hat{P}}_{spL 0 , x , y , MVL 0} + {\hat{P}}_{spL 1 , x , y , MVL 1} ] ] ]}^{2} \\ 0 = {\sum }_{x , y} [ {S}_{x , y} - \frac{1}{2} [ {\sum }_{i = 0}^{5} {h}_{spL 0 , i} \cdot {P}_{L 0 , \tilde{x} + i , y} + {\sum }_{i = 0}^{5} {h}_{spL 1 , i}^{FIX} \cdot {P}_{L 1 , \tilde{x} + i , y} ] ] {P}_{L 0 , \tilde{x} + i , y} \\ ∀ spL 0 ∈ \{ a , b , c \} \\ ∀ i ∈ \{ 0 , 1 , 2 , 3 , 4 , 5 \} & ( 23 )\end{matrix}$$

By solving this expression (23) for h_{spL0,i}, filter coefficients of the pixel positions a, b and c of the fractional positions with the L0L1 weighted prediction taken into consideration are determined. Since the expression (23) does not provide complete optimization because the interpolation filter for the L1 reference picture is fixed, an approximately optimum value is obtained.

Further, although a filter coefficient is obtained regarding h_{spL0,i}, also a filter coefficient on the L1 side is determined similarly by replacing L1 and L0 in the expression (23) with each other and calculating the L0 side as a fixed filter coefficient, and by calculating both of L0 and L1, a filter coefficient integrated between L0 and L1 is determined. Also with regard to the vertical direction, by carrying out similar calculation, filter coefficients at positions other than the a, b and c positions can be obtained.

Consequently, filter coefficients for use in L0L1 weighted prediction having such a filter characteristic that high frequency components of an image after a filter process are amplified are calculated.

It is to be noted that, for calculation of filter coefficients for the bi-prediction mode, pixels of a block for which the bi-prediction mode is determined by the motion prediction for the first time are used. In contrast, calculation of filter coefficients for the direct mode and for the skip mode is only different in that pixels of a block for which the direct mode and the skip mode are determined by the motion prediction for the first time are used, and except this, the calculation is similar to the calculation of filter coefficients for the bi-prediction mode.

### [Description of the Encoding Process of the Image Encoding Apparatus]

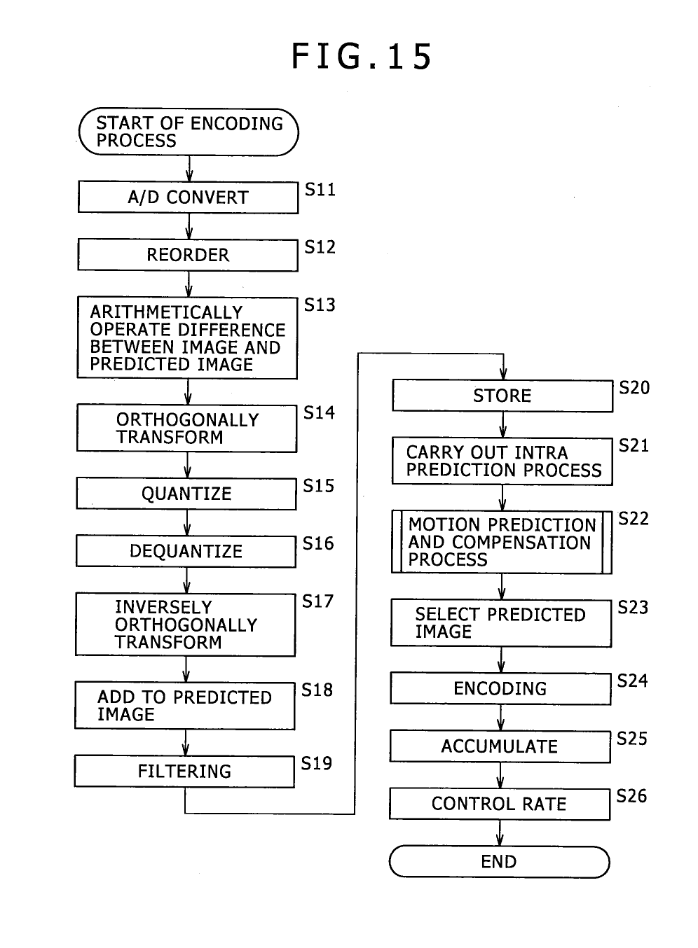

Now, an encoding process of the image encoding apparatus 51 of FIG. 8 is described with reference to a flow chart of FIG. 15.

At step S11, the A/D converter 61 A/D converts an image inputted thereto. At step S12, the screen reordering buffer 62 stores the image supplied thereto from the A/D converter 61 and carries out reordering from an order in which pictures of the image are to be displayed into another order in which the pictures are to be encoded.

At step S13, the arithmetic operation section 63 arithmetically operates a difference between the image reordered at step S12 and a prediction image. The prediction image is supplied, in the case where inter prediction is to be carried out, from the motion prediction and compensation section 75, but is supplied, in the case where intra prediction is to be carried out, from the intra prediction section 74, to the arithmetic operation section 63 through the predicted image selection section 76.

The difference data is reduced in data amount in comparison with the original image data. Accordingly, the data amount can be compressed in comparison with that in an alternative case in which the image is encoded as it is.

At step S14, the orthogonal transform section 64 orthogonally transforms the difference information supplied thereto from the arithmetic operation section 63. In particular, orthogonal transform such as discrete cosine transform or Karhunen-Lowe transform is carried out, and transform coefficients are outputted. At step S15, the quantization section 65 quantizes the transform coefficients. Upon this quantization, the rate is controlled in such a manner as described in the description of a process at step S26 hereinafter described.

The difference information quantized in such a manner as described above is decoded locally in the following manner. In particular, at step S16, the dequantization section 68 dequantizes the transform coefficients quantized by the quantization section 65 with a characteristic corresponding to the characteristic of the quantization section 65. At step S17, the inverse orthogonal transform section 69 inversely orthogonally transforms the transform coefficients dequantized by the dequantization section 68 with a characteristic corresponding to the characteristic of the orthogonal transform section 64.

At step S18, the arithmetic operation section 70 adds the prediction image inputted thereto through the predicted image selection section 76 to the locally decoded difference information to produce a locally decoded image (image corresponding to the input to the arithmetic operation section 63). At step S19, the deblock filter 71 filters the image outputted from the arithmetic operation section 70. Consequently, block distortion is removed. At step S20, the frame memory 72 stores the filtered image. It is to be noted that also the image which has not been filtered by the deblock filter 71 is supplied from the arithmetic operation section 70 to and stored into the frame memory 72.

At step S21, the intra prediction section 74 carries out an intra prediction process. In particular, the intra prediction section 74 carries out, based on the image to be intra predicted read out from the screen reordering buffer 62 and the image supplied from the frame memory 72 through the switch 73, an intra prediction process in all candidate intra prediction modes to produce an intra prediction image.

The intra prediction section 74 calculates a cost function value for all candidate intra prediction modes. The intra prediction section 74 determines that one of the intra prediction modes which provides a minimum value from among the calculated cost function values as an optimum intra prediction mode. Then, the intra prediction section 74 supplies the intra prediction image produced in the optimum intra prediction mode and the cost function value of the same to the predicted image selection section 76.

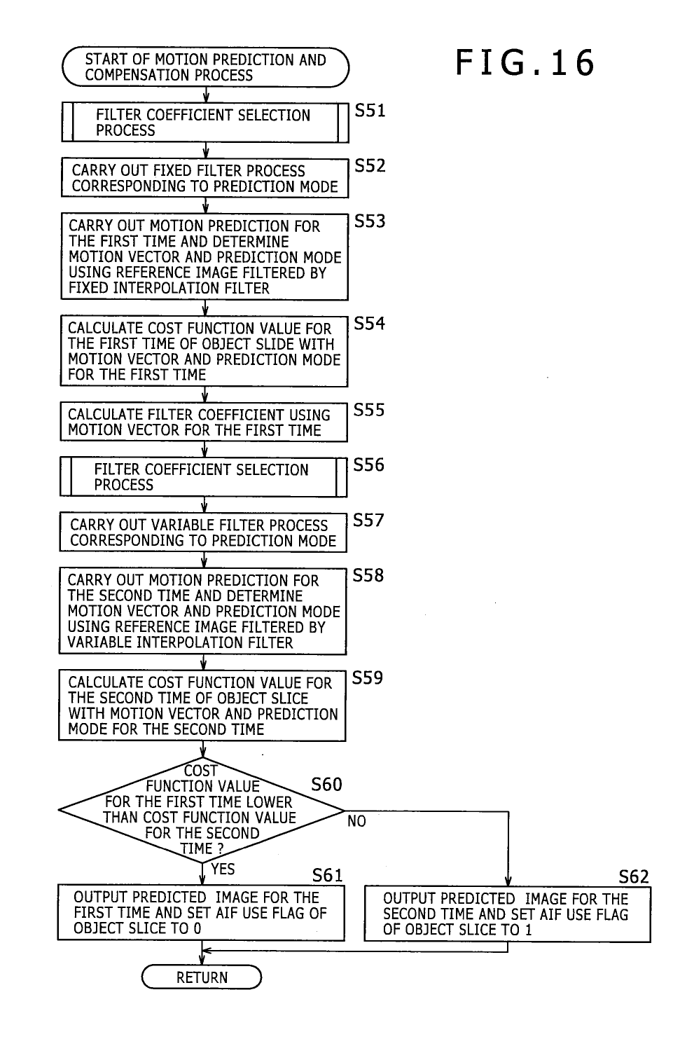

At step S22, the motion prediction and compensation section 75 carries out a motion prediction and compensation process. Details of the motion prediction and compensation process at step S22 are hereinafter described with reference to FIG. 16.

By this process, at least the fixed filters and the variable filters of filter coefficients corresponding to L0L1 weighted prediction or any other prediction are used to carry out a filter process, and the filtered reference image is used to determine a motion vector and a prediction mode for each block, and a cost function value of an object slice is calculated. Then, the cost function value of the object slice by the fixed filter and the cost function value of the object slice by the variable filter are compared with each other, and it is determined based on a result of the comparison whether or not an AIF (variable filter) is to be used. Then, the motion prediction and compensation section 75 supplies the determined predicted image and the cost function value to the predicted image selection section 76.

At step S23, the predicted image selection section 76 determines one of the optimum intra prediction mode and the optimum inter prediction mode as an optimum prediction mode based on the cost function values outputted from the intra prediction section 74 and the motion prediction and compensation section 75. Then, the predicted image selection section 76 selects the predicted image of the determined optimum prediction mode and supplies the selected predicted image to the arithmetic operation sections 63 and 70. This predicted image is used for the arithmetic operation at steps S13 and S18 as described hereinabove.

It is to be noted that the selection information of the predicted image is supplied to the intra prediction section 74 or the motion prediction and compensation section 75. In the case where the predicted image of the optimum intra prediction mode is selected, the intra prediction section 74 supplies information representative of the optimum intra prediction mode (that is, intra prediction mode information) to the lossless encoding section 66.

In the case where the predicted image of the optimum inter prediction mode is selected, the motion compensation portion 86 of the motion prediction and compensation section 75 outputs the information representative of the optimum inter prediction mode, the motion vector information and the reference frame information to the lossless encoding section 66. Further, the motion compensation portion 86 outputs, for each slice, information of the slice and the AIF use flag information to the lossless encoding section 66.

It is to be noted that the AIF use flag information is set for each of the filter coefficients used. Accordingly, in the case of the pattern A, values of an AIF use flag (aif_other_flag) for the case where the L0L1 weighted prediction is not used, an AIF use flag (aif_bipred_flag) for the bi-prediction mode, an AIF use flag (aif_direct_flag) for the direct mode and an AIF use flag (aif_skip_flag) for the skip mode are set.

At step S24, the lossless encoding section 66 encodes the quantized transform coefficients outputted from the quantization section 65. In particular, the difference image is reversely encoded by variable length encoding, arithmetic encoding or the like and compressed. At this time, also the intra prediction mode information from the intra prediction section 74 or the optimum inter prediction mode from the motion prediction and compensation section 75, the various kinds of information described hereinabove and so forth, inputted to the lossless encoding section 66 at step S23, are encoded and added to header information.

For example, the information representative of the inter prediction mode is encoded for each macro block. The motion vector information or the reference frame information is encoded for each block which becomes an object. Further, the information of the slice, the AIF use flag information and the filter coefficients are inserted into the slice header and encoded for each slice.

At step S25, the accumulation buffer 67 accumulates the difference image as a compressed image. The compressed image accumulated in the accumulation buffer 67 is suitably read out and transmitted to the decoding side through the transmission path.

At step S26, the rate controlling section 77 controls the rate of the quantization operation of the quantization section 65 based on the compressed image accumulated in the accumulation buffer 67 so that an overflow or an underflow may not occur.

### [Description of the Motion Prediction and Compensation Process]

Now, the motion prediction and compensation process at step S22 of FIG. 15 is described with reference to the flowchart shown in FIG. 16.

In the case where the image of a processing object supplied from the screen reordering buffer 62 is an image to be inter processed, an image to be referred to is read out from the frame memory 72 and is supplied to the fixed interpolation filter 81 through the switch 73. Further, the image to be referred to is inputted also to the variable interpolation filter 83 and the filter coefficient calculation portion 84.

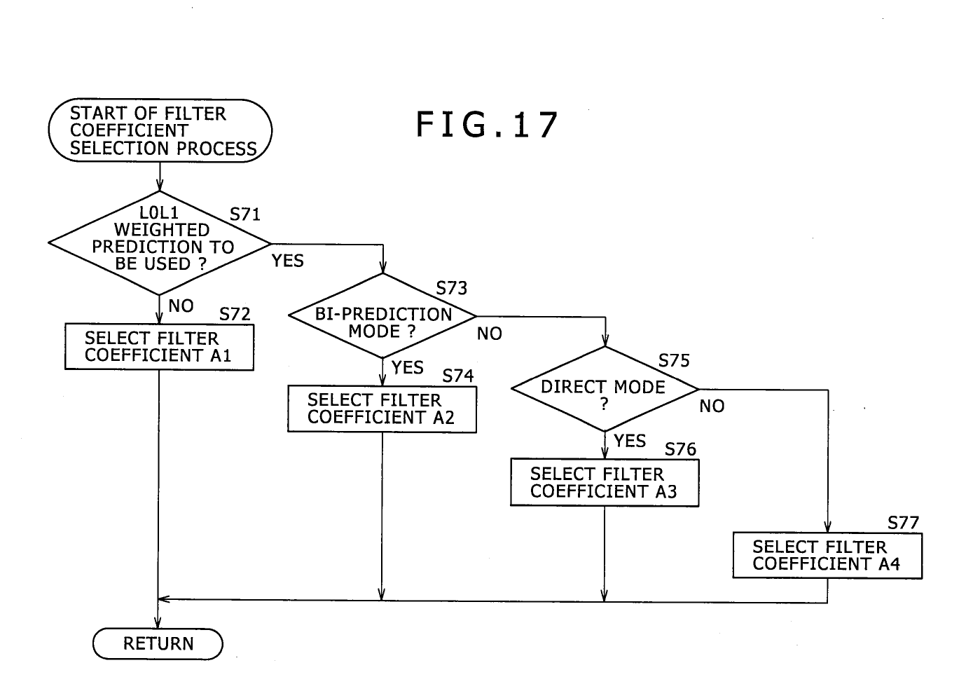

At step S51, the filter coefficient storage portion 82 carries out a filter coefficient selection process under the control of the control portion 87. Although this filter coefficient selection process is hereinafter described with reference to FIG. 17, by the process at this step S51, filter coefficients corresponding to the prediction mode are supplied to the fixed interpolation filter 81.

In particular, the filter coefficient A1 for the case where the L0L1 weighted prediction is not used, the filter coefficient A2 for the bi-direction mode, the filter coefficient A3 for the direct mode and the filter coefficient A4 for the skip mode are selected in response to the prediction mode and supplied to the fixed interpolation filter 81.

At step S52, the fixed interpolation filter 81 carries out a fixed filter process corresponding to the prediction mode for the reference image using the filter coefficients from the filter coefficient storage portion 82. In particular, the fixed interpolation filter 81 carries out a filter process for the reference image from the frame memory 72 and outputs the reference image after the fixed filter process to the motion prediction portion 85 and the motion compensation portion 86.

The processes at steps S51 and S52 described above are carried out for each prediction mode.

At step S53, the motion prediction portion 85 and the motion compensation portion 86 carry out motion prediction for the first time and determine motion vectors and a prediction mode using the reference image filtered by the filter coefficient storage portion 82.

In particular, the motion prediction portion 85 produces motion vectors for the first time for all candidate inter prediction modes based on the input image from the screen reordering buffer 62 and the reference image after the fixed filtering from the fixed interpolation filter 81, and outputs the produced motion vectors to the motion compensation portion 86. It is to be noted that the motion vectors for the first time are outputted also to the filter coefficient calculation portion 84 and are used in a process at step S55 hereinafter described.

The motion compensation portion 86 uses the motion vectors for the first time to carry out a compensation process for the reference image after the fixed filtering from the fixed interpolation filter 81 to produce a predicted image. Then, the motion compensation portion 86 calculates a cost function value for each block and compares such cost function values to determine an optimum inter prediction mode.

The processes described above are carried out for each block, and after the processing for all blocks in the object slice comes to an end, the motion compensation portion 86 calculates a cost function value for the first time of the object slice with the motion vectors for the first time and in the optimum prediction mode at step S54.

At step S55, the filter coefficient calculation portion 84 uses the motion vectors for the first time from the motion prediction portion 85 to calculate filter coefficients.

In particular, the filter coefficient calculation portion 84 uses the input image from the screen reordering buffer 62, reference image from the frame memory 72 and motion vectors for the first time from the motion prediction portion 85 to calculate filter coefficients suitable for the prediction mode for approximating the reference image after the filter process of the variable interpolation filter 83 to the input image. In particular, the filter coefficient A1 for the case where the L0L1 weighted prediction is not used, the filter coefficient A2 for the bi-direction mode, the filter coefficient A3 for the direct mode and the filter coefficient A4 for the skip mode are calculated.

It is to be noted that the calculated filter coefficients are outputted to the lossless encoding section 66 and encoded at step S24 when a predicted image of the optimum inter prediction mode is selected and a variable filter is used in the object slice at step S23 of FIG. 13 described hereinabove.

At step S56, the filter coefficient calculation portion 84 carries out a filter coefficient selection process under the control of the control portion 87. Since this filter coefficient selection process is similar to the process at step S51 hereinafter described with reference to FIG. 17, detailed description of the same is omitted. By the process at step S56, filter coefficients corresponding to the prediction mode are supplied to the variable interpolation filter 83.

In particular, the filter coefficient A1 for the case where the L0L1 weighted prediction is not used, the filter coefficient A2 for the bi-direction mode, the filter coefficient A3 for the direct mode and the filter coefficient A4 for the skip mode are selected in response to the prediction mode and supplied to the variable interpolation filter 83.

At step S57, the variable interpolation filter 83 uses the filter coefficients from the filter coefficient calculation portion 84 to carry out a variable filter process for the reference image. In particular, the variable interpolation filter 83 carries out a filter process for the reference image from the frame memory 72 using the filter coefficients calculated by the filter coefficient calculation portion 84 and outputs the reference image after the variable filter process to the motion prediction portion 85 and the motion compensation portion 86.

The processes at steps at S56 and S57 described above are carried out for each prediction mode.

At step S58, the motion prediction portion 85 and the motion compensation portion 86 carry out motion prediction for the second time and determine motion vectors and a prediction mode using the reference image filtered by the variable interpolation filter 83.

In particular, the motion prediction portion 85 produces a motion vector for the second time for all candidate inter prediction modes based on the input image from the screen reordering buffer 62 and the reference image after the variable filtering from the variable interpolation filter 83 and outputs the produced motion vectors to the motion compensation portion 86.

The motion compensation portion 86 uses the motion vectors for the second time to carry out a compensation process for the reference image after the variable filtering from the variable interpolation filter 83 to produce a predicted image. Then, the motion compensation portion 86 calculates a cost function value for each block and compares the cost function values to determine an optimum inter prediction mode.

The processes described above are carried out for each block, and when the processing for all blocks of the object slice comes to an end, the motion compensation portion 86 calculates a cost function value for the second time of the object slice with the motion vectors for the second time and in the optimum inter prediction mode at step S59.

At step S60, the motion compensation portion 86 compares the cost function value for the first time and the cost function value for the second time of the object slice with each other to determine whether or not the cost function value for the first time of the object slice is lower than the cost function value for the second time.

If it is determined that the cost function for the first time of the object slice is lower than the cost function value for the second time, then the processing advances to step S61. At step S61, the motion compensation portion 86 determines to use a fixed filter for the object slice, and supplies the predicted image for the first time (produced from the reference image after the fixed filtering) and the cost function value to the predicted image selection section 76 and then sets the value of the AIF use flag of the object slice to 0.

If it is determined that the cost function value for the first time of the object slice is not lower than the cost function value for the second time, then the processing advances to step S62. At step S62, the motion compensation portion 86 determines that a variable filter (AIF) is to be used for the object slice and supplies the predicted image for the second time (produced from the reference image after the variable filter) and the cost function value to the predicted image selection section 76 and then sets the AIF use flag of the object slice to 1.

The information of the set AIF use flag of the object slice is outputted, when the predicted image of the optimum inter prediction mode is selected, to the lossless encoding section 66 together with the information of the slice under the control of the control portion 87 at step S23 of FIG. 13 described hereinabove. Then, the information is inserted into the slice header and encoded.

### [Filter Coefficient Selection Process]

Now, the filter coefficient selection process at step S51 of FIG. 16 is described with reference to a flow chart of FIG. 17.

The A1 filter coefficient memory 91 to the A4 filter coefficient memory 94 output filter coefficients A1 to A4 stored therein to the selector 95, respectively.

At step S71, the control portion 87 determines whether or not the prediction mode in which a motion prediction process is to be carried out subsequently uses the L0L1 weighted prediction. If it is determined at step S71 that the prediction mode in which a motion prediction process is to be carried out subsequently does not use the L0L1 weighted prediction, then the processing advances to step S72. At step S72, the selector 95 selects the filter coefficient A1 from the A1 filter coefficient memory 91 under the control of the control portion 87 and supplies the filter coefficient A1 to the fixed interpolation filter 81.

If it is determined at step S71 that the L0L1 weighted prediction is used, then the processing advances to step S73. At step S73, the control portion 87 determines whether or not the prediction mode in which a motion prediction process is to be carried out subsequently is the bi-prediction mode. If it is determined at step S73 that the prediction mode is the bi-prediction mode, then the processing advances to step S74. At step S74, the selector 95 selects the filter coefficient A2 from the A2 filter coefficient memory 92 under the control of the control portion 87 and supplies the filter coefficient A2 to the fixed interpolation filter 81.

If it is determined at step S73 that the prediction mode is not the bi-prediction mode, then the processing advances to step S75. At step S75, the control portion 87 determines whether or not the prediction mode in which motion prediction process is to be carried out subsequently is the direct mode. If it is determined at step S75 that the prediction mode is the direct mode, then the processing advances to step S76. At step S76, the selector 95 selects the filter coefficient A3 from the A3 filter coefficient memory 93 under the control of the control portion 87 and supplies the filter coefficient A3 to the fixed interpolation filter 81.

If it is determined at step S73 that the prediction mode is not the direct mode, then the processing advances to step S77. In particular, in this instance, since it is determined that the prediction mode is the skip mode, the selector 95 selects the filter coefficient A4 from the A4 filter coefficient memory 94 under the control of the control portion 87 and supplies the filter coefficient A4 to the fixed interpolation filter 81 at step S77.

In this manner, in the image encoding apparatus 51, filter coefficients to be used by an interpolation filter are selected at least depending upon whether or not the L0L1 weighted prediction is to be used. In particular, in the case where the L0L1 weighted prediction is to be used, filter coefficients having such a characteristic that high frequency components of an image after a filter process are amplified are selected.

Accordingly, since high frequency components which are lost by the L0L1 weighted prediction are amplified in advance, frequency components after weighted prediction are suppressed from being lost, and the prediction accuracy is improved.

Consequently, since a residual signal which needs to be included in stream information to be sent to the decoding side is reduced, the bit amount can be reduced and the encoding efficiency is improved. Further, if the residual signal is reduced, then also coefficients after the orthogonal transform of the same decrease, and it is expected that many coefficients become zero after the quantization.

In H.264/AVC, the number of successive 0s is included into stream information. Since usually the code amount is much smaller where representation by the number of 0s is used than where a value other than 0 is replaced with a determined code, that many coefficients become zero by the present invention leads to reduction of the code bit amount.

Further, the loss of high frequency components signifies damage to the clear sense of the picture quality. Usually, as an impression of the picture quality, if high frequency components are lost, then since a feeling of blur is provided, the impression is degraded. In contrast, since high frequency components which are lost by the L0L1 weighted prediction can be recovered, a clear sense of the picture quality is obtained.

Further, when weighted prediction is to be carried out, filter coefficients are selected in response to the bi-prediction mode, direct mode and skip mode. In particular, a filter having a characteristic of the degree of amplification of high frequency components in response to the modes is selected. Consequently, it is possible to cope with a case in which the degree of positional displacement is different among the bi-prediction mode, direct mode and skip mode as described hereinabove with reference to FIG. 7.

The encoded compressed image is transmitted through a predetermined transmission path and decoded by the image decoding apparatus.

### [Example of the Configuration of the Image Decoding Apparatus]

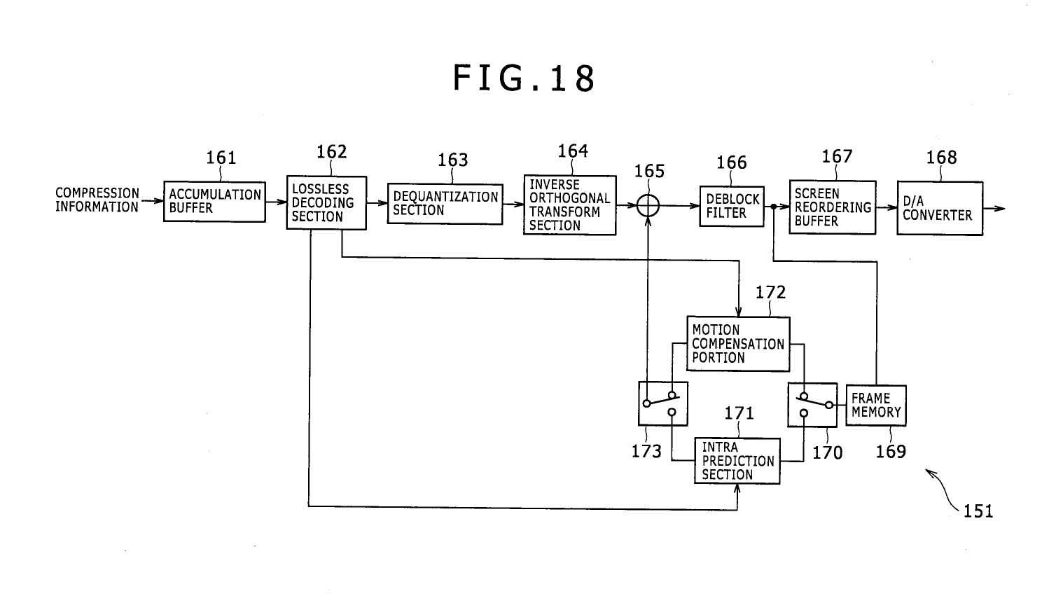

FIG. 18 shows a configuration of a first embodiment of an image decoding apparatus as an image processing apparatus to which the present invention is applied.

The image decoding apparatus 151 is configured from an accumulation buffer 161, a lossless decoding section 162, a dequantization section 163, an inverse orthogonal transform section 164, an arithmetic operation section 165, a deblock filter 166, a screen reordering buffer 167, a D/A converter 168, a frame memory 169, a switch 170, an intra prediction section 171, a motion compensation portion 172 and a switch 173.

The accumulation buffer 161 accumulates a compressed image transmitted thereto. The lossless decoding section 162 decodes information supplied thereto from the accumulation buffer 161 and encoded by the lossless encoding section 66 of FIG. 8 in accordance with a method corresponding to the encoding method of the lossless encoding section 66. The dequantization section 163 dequantizes an image decoded by the lossless decoding section 162 in accordance with a method corresponding to the quantization method of the quantization section 65 of FIG. 8. The inverse orthogonal transform section 164 inversely orthogonally transforms an output of the dequantization section 163 in accordance with a method corresponding to the orthogonal transform method of the orthogonal transform section 64 of FIG. 8.

The inversely orthogonally transformed output is added to a predicted image supplied thereto from the switch 173 and is decoded by the arithmetic operation section 165. The deblock filter 166 removes block distortion of the decoded image and supplies a resulting image to the frame memory 169 so as to be accumulated into the frame memory 169 and besides outputs the resulting image to the screen reordering buffer 167.

The screen reordering buffer 167 carries out reordering of an image. In particular, the order of frames reordered into the order for encoding by the screen reordering buffer 62 of FIG. 8 is reordered into the original displaying order. The D/A converter 168 D/A converts the image supplied thereto from the screen reordering buffer 167 and outputs the resulting image to a display unit not shown so as to be displayed on the display unit.

The switch 170 reads out an image to be referred to from the frame memory 169 and outputs the image to the motion compensation portion 172. Further, the switch 170 reads out an image to be used for intra prediction from the frame memory 169 and supplies the image to the intra prediction section 171.

To the intra prediction section 171, information representative of the intra prediction mode obtained by decoding header information is supplied from the lossless decoding section 162. The intra prediction section 171 produces a predicted image based on this information and outputs the produced predicted image to the switch 173.

To the motion compensation portion 172, the inter prediction mode information, motion vector information, reference frame information, AIF use flag information, filter coefficients and so forth from within the information obtained by decoding the header information are supplied from the lossless decoding section 162. The inter prediction mode information is transmitted for each macro block. The motion vector information and the reference frame information are transmitted for each object block. The slice information in which the information of the type of the slice, the AIF use flag information, filter coefficients and so forth are included is inserted into and transmitted together with the slice header for each object slice.

When the object slice uses an AIF based on the AIF use flag information of the slice header from the lossless decoding section 162, the motion compensation portion 172 carries out replacement of currently stored variable filter coefficients with the variable filter coefficients included in the slice header. Then, the motion compensation portion 172 uses variable interpolation filters to carry out a variable filter process for the reference image from the frame memory 169. The motion compensation portion 172 uses motion vectors from the lossless decoding section 162 to carry out a compensation process for the reference image after the variable filter process to produce a predicted image of the object block. The produced predicted image is outputted to the arithmetic operation section 165 through the switch 173.

If the object slice including the object block is not to use an AIF, then the motion compensation portion 172 uses interpolation filters of fixed coefficients to carry out a fixed filter process for the reference image from the frame memory 169. Then, the motion compensation portion 172 carries out a compensation process for the reference image after the fixed filter process using the motion vector from the lossless decoding section 162 to produce a predicted image of the objet block. The produced predicted image is outputted to the arithmetic operation section 165 through the switch 173.

Here, in the motion compensation portion 172, at least fixed filter coefficients to be used for the L0L1 weighted prediction and fixed filter coefficients to be used for any other prediction are stored similarly to the motion prediction and compensation section 75 of FIG. 8. Also in the case of the variable, in the motion compensation portion 172, at least filter coefficients for a variable filter to be used for L0L1 weighted prediction and variable filter coefficients to be used for any other prediction are acquired from the lossless decoding section 162 and stored similarly.

The switch 173 selects a predicted image produced by the motion compensation portion 172 or the intra prediction section 171 and supplies the predicted image to the arithmetic operation section 165.

### [Example of the Configuration of the Motion Compensation Portion]

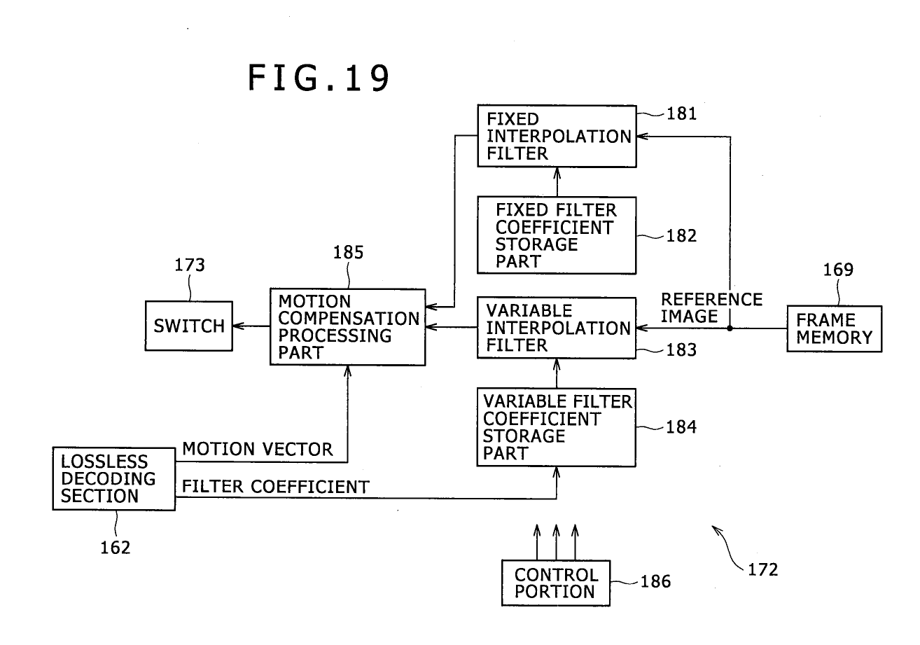

FIG. 19 is a block diagram showing an example of a detailed configuration of the motion compensation portion 172. It is to be noted that, in FIG. 19, the switch 170 of FIG. 18 is omitted.

In the example of FIG. 19, the motion compensation portion 172 is configured from a fixed interpolation filter 181, a fixed filter coefficient storage part 182, a variable interpolation filter 183, a variable filter coefficient storage part 184, a motion compensation processing part 185 and a control portion 186.

For each slice, slice information representative of a type of the slice and AIF use flag information included in the slice header are supplied from the lossless decoding section 162 to the control portion 186, and filter coefficients are supplied from the lossless decoding section 162 to the variable filter coefficient storage part 184. Also information representative of an inter prediction mode for each macro block from the lossless decoding section 162 is supplied to the control portion 186, and a motion vector for each block is supplied to the motion compensation processing part 185 while reference frame information is supplied to the control portion 186.

A reference image from the frame memory 169 is inputted to the fixed interpolation filter 181 and the variable interpolation filter 183 under the control of the control portion 186.

The fixed interpolation filter 181 is an interpolation filter whose filter coefficients are fixed (that is, not an AIF). The fixed interpolation filter 181 carries out a filter process for the reference image from the frame memory 169 using fixed filter coefficients from the fixed filter coefficient storage part 182 and outputs the reference image after the fixed filter process to the motion compensation processing part 185.

The fixed filter coefficient storage part 182 stores at least fixed filter coefficients for the L0L1 weighted prediction and for any other prediction to be used by the fixed interpolation filter 181, and reads out the filter coefficients and selects the filter coefficients under the control of the control portion 186. Then, the fixed filter coefficient storage part 182 supplies the selected fixed filter coefficient to the fixed interpolation filter 181.

The variable interpolation filter 183 is an interpolation filter having variable filter coefficients (that is, an AIF). The variable interpolation filter 183 carries out a filter process for a reference image from the frame memory 169 using the variable filter coefficients from the variable filter coefficient storage part 184 and outputs the reference image after the variable filter process to the motion compensation processing part 185.

The variable filter coefficient storage part 184 temporarily stores at least variable filter coefficients for the L0L1 weighted prediction and for any other prediction to be used by the variable interpolation filter 183 and, when corresponding variable filter coefficients are supplied thereto from the lossless decoding section 162, rewrites, for each slice, the variable filter coefficients into the coefficients stored therein. The variable filter coefficient storage part 184 reads out and selects the temporarily stored filter coefficients under the control of the control portion 186 and supplies the selected variable filter coefficients to the variable interpolation filter 183.

The motion compensation processing part 185 carries out a compensation process for the reference image after the filtering from the fixed interpolation filter 181 or the variable interpolation filter 183 using the motion vectors from the lossless decoding section 162 in the prediction mode controlled by the control portion 186 to produce a predicted image of the object block. Then, the motion compensation processing part 185 outputs the produced predicted image to the switch 173.

The control portion 186 acquires, for each slice, an AIF use flag included in the information of the slice header from the lossless decoding section 162, refers to the acquired AIF use flag and controls, depending upon whether or not an AIF is to be used, the fixed interpolation filter 181, fixed filter coefficient storage part 182, variable interpolation filter 183 and variable filter coefficient storage part 184. Further, the control portion 186 instructs the fixed filter coefficient storage part 182 or the variable filter coefficient storage part 184 of which one of the filter coefficients for the L0L1 weighted prediction and for any other prediction should be selected in response to the prediction mode information.

In particular, in the case where the slice in which the block of the processing object is included is to use an AIF, the control portion 186 controls the variable filter coefficient storage part 184 to rewrite the stored variable filter coefficients with the filter coefficients from the lossless decoding section 162 and select fixed filter coefficients for the L0L1 weighted prediction and any other prediction corresponding to the prediction mode and controls the variable interpolation filter 183 to carry out a filter process.

On the other hand, in the case where the slice included in the block of the processing object is not to use an AIF, the control portion 186 controls the fixed filter coefficient storage part 182 to select fixed filter coefficients for the L0L1 weighted prediction and for any other prediction corresponding to the prediction mode and controls the fixed interpolation filter 181 to carry out a filter process.

Further, the control portion 186 controls the motion compensation processing part 185 to carry out a compensation process of the prediction mode based on the prediction mode information.

### [Example of the Configuration of the Fixed Filter Coefficient Storage Portion]

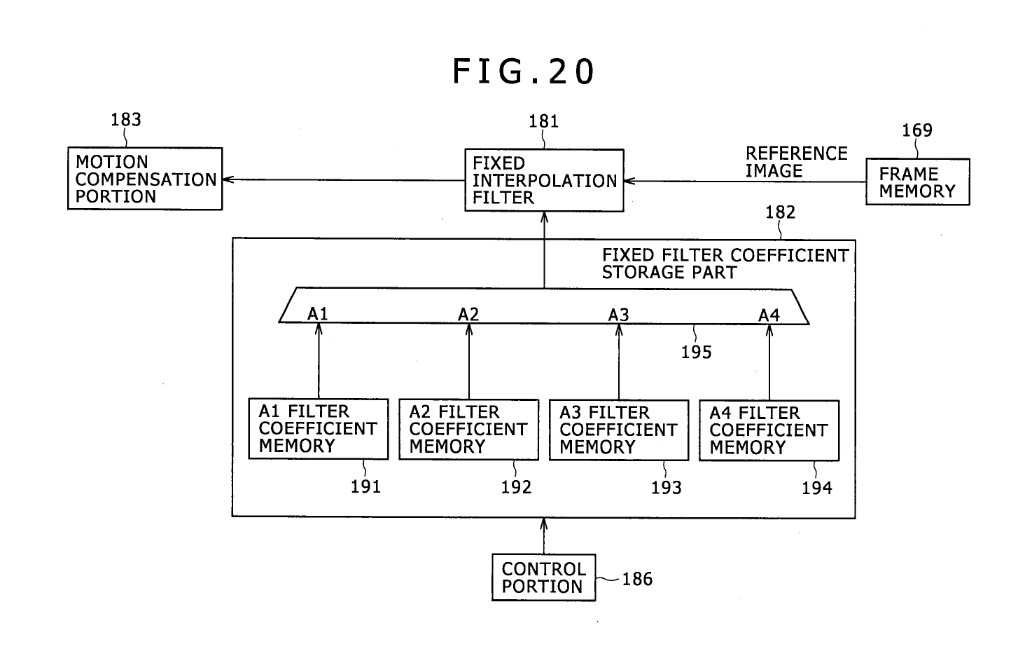

FIG. 20 is a block diagram showing an example of a configuration of a fixed filter coefficient storage portion in the case of the pattern A.

In the example of FIG. 20, the fixed filter coefficient storage part 182 is configured from an A1 filter coefficient memory 191, an A2 filter coefficient memory 192, an A3 filter coefficient memory 193, an A4 filter coefficient memory 194 and a selector 195.

The A1 filter coefficient memory 91 stores a fixed filter coefficient A1 to be used for all inter prediction modes in the case where the L0L1 weighted prediction is not used and outputs the fixed filter coefficients A1 to the selector 95. The A2 filter coefficient memory 92 stores fixed filter coefficients A2 to be used for the bi-prediction mode in the case where the L0L1 weighted prediction is used and outputs the fixed filter coefficients A2 to the selector 95.

The A3 filter coefficient memory 93 stores fixed filter coefficients A3 to be used for the direct mode in the case where the L0L1 weighted prediction is to be carried out and outputs the fixed filter coefficients A3 to the selector 95. The A4 filter coefficient memory 94 stores fixed filter coefficients A4 to be used for the skip mode in the case where the L0L1 weighted prediction is used and outputs the fixed filter coefficients A4 to the selector 95.

The selector 195 selects one of the fixed filter coefficients A1 to A4 under the control of the control portion 186 and outputs the selected filter coefficient to the fixed interpolation filter 181.

### [Example of the Configuration of the Variable Filter Coefficient Storage Portion]

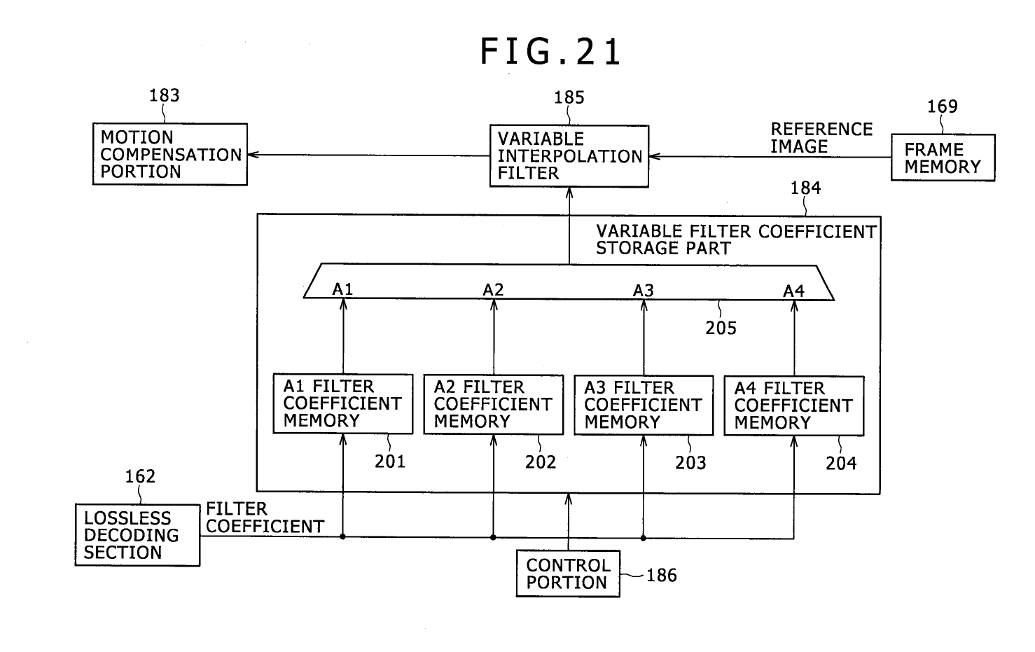

FIG. 21 is a block diagram showing an example of a configuration of the variable filter coefficient storage portion in the case of the pattern A.

In the example of FIG. 21, the variable filter coefficient storage part 184 is configured from an A1 filter coefficient memory 201, an A2 filter coefficient memory 202, an A3 filter coefficient memory 203, an A4 filter coefficient memory 204 and a selector 205.

The A1 filter coefficient memory 201 stores variable filter coefficients A1 to be used for all inter prediction modes in the case where the L0L1 weighted prediction is not used and rewrites the filter coefficients stored therein with a variable filter coefficients A1 sent thereto from the lossless decoding section 162 under the control of the control portion 186. Then, the A1 filter coefficient memory 201 outputs the rewritten variable filter coefficients A1 to the selector 95.

The A2 filter coefficient memory 92 stores variable filter coefficients A2 to be used for the bi-prediction mode in the case where the L0L1 weighted prediction is used and rewrites the filter coefficients stored therein with a variable filter coefficients A2 sent thereto from the lossless decoding section 162 under the control of the control portion 186. Then, the A2 filter coefficient memory 92 outputs the rewritten variable filter coefficients A2 to the selector 95.

The A3 filter coefficient memory 93 stores variable filter coefficients A3 to be used for the direct mode in the case where the L0L1 weighted prediction is used and rewrites the filter coefficient stored therein with a variable filter coefficients A3 sent thereto from the lossless decoding section 162 under the control of the control portion 186. Then, the A3 filter coefficient memory 93 outputs the rewritten variable filter coefficients A3 to the selector 95.

The A4 filter coefficient memory 94 stores variable filter coefficients A4 to be used for the skip mode in the case where the L0L1 weighted prediction is used and rewrites the filter coefficient stored therein with a variable filter coefficient A3 sent thereto from the lossless decoding section 162 under the control of the control portion 186. Then, the A4 filter coefficient memory 94 outputs the rewritten variable filter coefficients A4 to the selector 95.

The selector 205 selects one of the variable filter coefficients A1 to A4 under the control of the control portion 87 and outputs the selected filter coefficient to the variable interpolation filter 183.

It is to be noted that, in each filter coefficient memory, the period within which a written filter coefficient is valid may be only that of the object slice or may be a period until it is rewritten subsequently. However, in any case, if an IDR (instantaneous decoding refresh) picture is found, the filter coefficient is replaced by an initial value. In other words, the filter coefficient is reset.

Here, the IDR picture is prescribed by the H.264/AVC method and signifies a picture at the top of an image sequence so that decoding can be started beginning with the IDR picture. This countermeasure makes random access possible.

### [Description of the Decoding Process of the Image Decoding Apparatus]

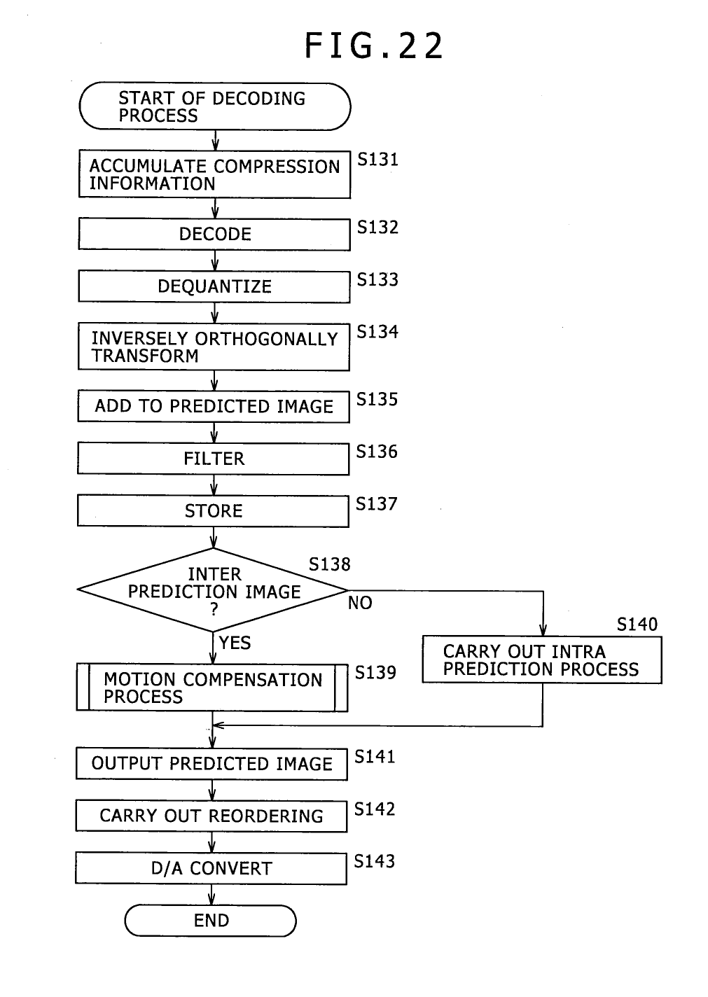

Now, a decoding process executed by the image decoding apparatus 151 is described with reference to a flow chart of FIG. 22.

At step S131, the accumulation buffer 161 accumulates an image transmitted thereto. At step S132, the lossless decoding section 162 decodes the compressed image supplied thereto from the accumulation buffer 161. In particular, I pictures, B pictures and P pictures encoded by the lossless encoding section 66 of FIG. 8 are decoded.

At this time, also motion vector information, reference frame information and so forth are decoded for each block. Further, for each macro block, also prediction mode information (information representative of the intra prediction mode or the inter prediction mode) and so forth are decoded. Furthermore, for each slice, also slice header information including information of a type of the slice, AIF use flag information, filter coefficients and so forth is decoded.

At step S133, the dequantization section 163 dequantizes transform coefficients determined by the lossless decoding section 162 with a characteristic corresponding to the characteristic of the quantization section 65 of FIG. 8. At step S134, the inverse orthogonal transform section 164 inversely orthogonally transforms transform coefficients dequantized by the dequantization section 163 with a characteristic corresponding to the characteristic of the orthogonal transform section 64. Consequently, difference information corresponding to the input of the orthogonal transform section 64 (output of the arithmetic operation section 63) of FIG. 8 is decoded.

At step S135, the arithmetic operation section 165 adds a predicted image selected by a process at step S141 hereinafter described and inputted thereto through the switch 173 to the difference information, whereby the original image is decoded. At step S136, the deblock filter 166 filters the image outputted from the arithmetic operation section 165. By this, block distortion is removed. At step S137, the frame memory 169 stores the filtered image.

At step S138, the lossless decoding section 162 determines, based on a result of the lossless decoding of the header part of the compressed image, whether or not the compressed image is an inter prediction image, that is, whether or not the lossless decoding result includes information representative of an optimum inter prediction mode.

If it is determined at step S138 that the compressed image is an inter prediction image, then the lossless decoding section 162 supplies the motion vector information, reference frame information, information representative of the optimum inter prediction mode, AIF use flag information, filter coefficients and so forth to the motion compensation portion 172.

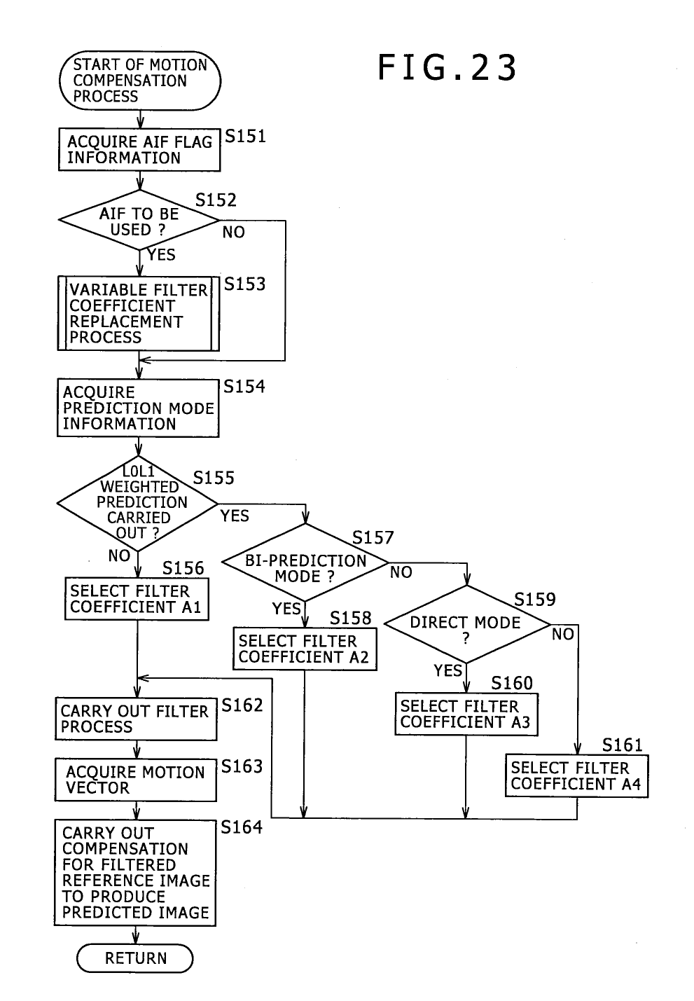

Then at step S139, the motion compensation portion 172 carries out a motion compensation process. Details of the motion compensation process at step S139 are hereinafter described with reference to FIG. 23.

By this process, when the object slice uses an AIF, the stored filter coefficients are replaced with variable filter coefficients in accordance with the L0L1 weighted prediction and any other prediction from the lossless decoding section 162. Then, a variable filter coefficient depending upon whether or not the prediction mode uses the L0L1 weighted prediction is used to carry out a variable filter process. In the case where the object slice does not yet use an AIF, fixed filter coefficients depending upon whether or not the prediction mode uses the L0L1 weighted prediction are used to carry out a fixed filter process. Thereafter, a compensation process is carried out for the reference image after the filter process using motion vectors, and a prediction image produced thereby is outputted to the switch 173.

On the other hand, if it is determined at step S138 that the compressed image is not an inter prediction image, that is, in the case where the lossless decoding result includes information representative of an optimum intra prediction mode, the lossless decoding section 162 supplies information representative of the optimum intra prediction mode to the intra prediction section 171.

Then at step S140, the intra prediction section 171 carries out an intra prediction process for the image from the frame memory 169 in the optimum intra prediction mode representative of the information from the lossless decoding section 162 to produce an intra prediction image. Then, the intra prediction section 171 outputs the intra prediction image to the switch 173.

At step S141, the switch 173 selects and outputs a predicted image to the arithmetic operation section 165. In particular, a predicted image produced by the intra prediction section 171 or a predicted image produced by the motion compensation portion 172 is supplied to the switch 173. Accordingly, the predicted image supplied is selected and outputted to the arithmetic operation section 165 and is added to an output of the inverse orthogonal transform section 164 at step S135 as described hereinabove.

At step S142, the screen reordering buffer 167 carries out reordering. In particular, the order of frames reordered for encoding by the screen reordering buffer 62 of the image encoding apparatus 51 is reordered into the original displaying order.

At step S143, the D/A converter 168 D/A converts the image from the screen reordering buffer 167. This image is outputted to and displayed on a display unit not shown.

### [Description of the Motion Compensation Process of the Image Decoding Apparatus]

Now, the motion compensation process at step S139 of FIG. 22 is described with reference to a flow chart of FIG. 23.

The control portion 186 acquires AIF use flag information included in the information of the slice header from the lossless decoding section 162 at step S151. It is to be noted that the AIF use flag information is set for each filter coefficient used on the encoding side and transmitted from the encoding side. Accordingly, in the case of the pattern A, the AIF use flag (aif_other_flag) for the case where the L0L1 weighted prediction is not used, AIF use flag (aif_bipred_flag) for the bi-prediction mode, AIF use flag (aif_direct_flag) for the direct mode and AIF use flag (aif_slik_flag) for the skip mode are acquired.

At step S152, the control portion 186 determines based on the AIF use flags whether or not the object slice uses an AIF. For example, in the case where the value of even one of the plural AIF use flags described above is 1, it is determined at step S152 that an AIF is used, and thereafter the processing advances to step S153.

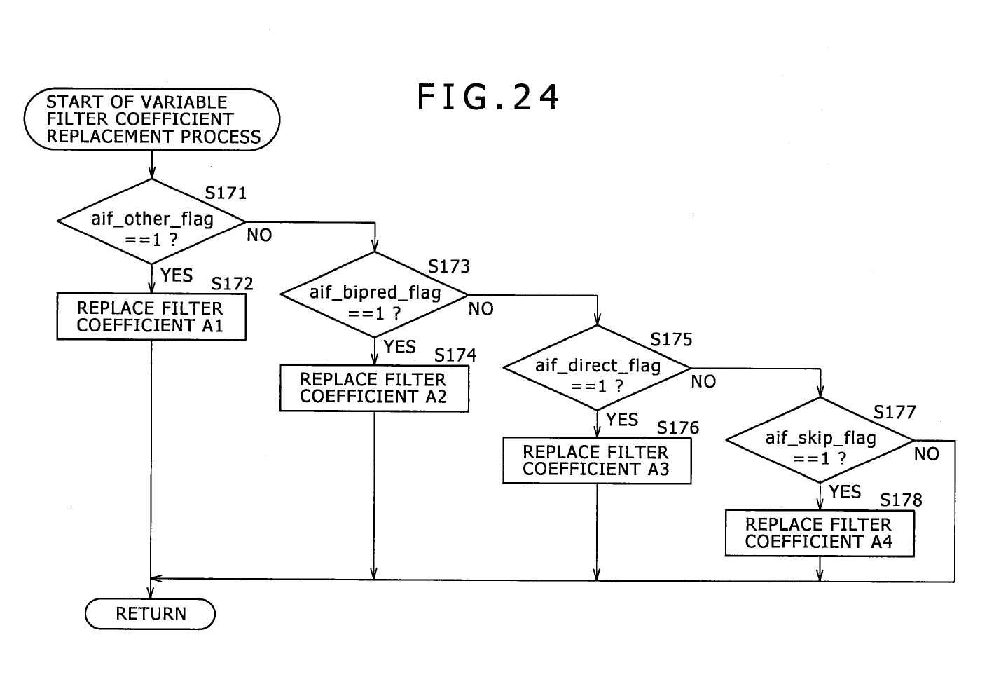

At step S153, the variable filter coefficient storage part 184 executes a variable filter coefficient replacement process under the control of the control portion 186. While this variable filter coefficient replacement process is hereinafter described with reference to FIG. 24, the stored coefficient is rewritten in the process at step S153 with a variable filter coefficient with regard to which the value of the AIF use flag is 1, that is, which is calculated with regard to the slice by the encoding side. It is to be noted that, at this time, the A1 filter coefficient memory 201 to the A4 filter coefficient memory 204 of the variable filter coefficient storage part 184 read out filter coefficients stored therein and supply the read out filter coefficients to the selector 205.

On the other hand, for example, if the values of the plural AIF use flags are zero, then it is determined at step S152 that an AIF is not used, and the step S153 is skipped and the processing advances to step S154. It is to be noted that, at this time, the A1 filter coefficient memory 191 to the A4 filter coefficient memory 194 of the fixed filter coefficient storage part 182 read out filter coefficients stored therein and supply the read out filter coefficients to the selector 195.

Here, for the convenience of description, the processes at the following steps S156, S158 and S160 to S162 are processes which are carried out, if it is determined at step S152 described hereinabove that an AIF is used, by the variable filter coefficient storage part 184 and the variable interpolation filter 183, but are carried out, if it is determined at step S152 described hereinabove that an AIF is not used, by the fixed filter coefficient storage part 182 and the fixed interpolation filter 181. In the following description, an example of the variable filter coefficient storage part 184 and the variable interpolation filter 183 is described as a representative.

At step S154, the control portion 186 acquires information of the inter prediction mode for each macro block from the lossless decoding section 162.

At step S155, the control portion 186 determines based on the information of the inter prediction mode whether or not the L0L1 weighted prediction is being carried out. If it is determined at step S155 that the L0L1 weighted prediction is not being carried out, then the processing advances to step S156, at which the selector 205 selects the filter coefficient A1 from the A1 filter coefficient memory 201 and supplies the selected filter coefficient A1 to the variable interpolation filter 183 under the control of the control portion 186.

If it is determined at step S155 that the L0L1 weighted prediction is being carried out, then the processing advances to step S157, at which the control portion 186 determines based on the information of the inter prediction mode whether or not the current mode is the bi-prediction mode.

If it is determined at step S157 that the current mode is the bi-prediction mode, then the processing advances to step S158, at which the selector 205 selects the filter coefficient A2 from the A2 filter coefficient memory 202 and supplies the selected filter coefficient A2 to the variable interpolation filter 183 under the control of the control portion 186.

If it is determined at step S157 that the current mode is not the bi-prediction mode, then the processing advances to step S159, at which the control portion 186 determines based on the information of the inter prediction mode that the current mode is the direct mode.

If it is determined at step S159 that the current mode is the direct mode, then the processing advances to step S160, at which the selector 205 selects the filter coefficient A3 from the A3 filter coefficient memory 203 and supplies the selected filter coefficient A3 to the variable interpolation filter 183 under the control of the control portion 186.

If it is determined at step S159 that the current mode is not the direct mode, or in other words, if the current mode is the skip mode, then the processing advances to step S161, at which the selector 205 selects the filter coefficient A4 from the A4 filter coefficient memory 204 and supplies the selected filter coefficient A4 to the variable interpolation filter 183 under the control of the control portion 186.

At step S162, the variable interpolation filter 183 carries out a filter process for the reference image from the frame memory 169 using the variable filter coefficients from the variable filter coefficient storage part 184 and outputs the reference image after the variable filter process to the motion compensation processing part 185.

At step S163, the motion compensation processing part 185 carries out a compensation process for the reference image after the filtering using the motion vectors from the lossless decoding section 162 in the prediction mode controlled by the control portion 186 to produce a predicted image of the object block, and outputs the produced predicted image to the switch 173.

### [Description of the Variable Filter Coefficient Replacement Process]

Now, the variable filter coefficient replacement process at step S153 of FIG. 23 is described with reference to a flow chart of FIG. 24.

The control portion 186 determines, at step S171, whether or not the value of the AIF use flag (aif_other_flag) for the case where the L0L1 weighted prediction is not used is 1. If it is determined at step S171 that the value of aif_other_flag is 1, then the processing advances to step S172, at which the A1 filter coefficient memory 201 replaces the stored filter coefficient with the filter coefficient A1 included in the slice header from the lossless decoding section 162 under the control of the control portion 186.

If it is determined at step S171 that the value of aif_other_flag is not 1, then the processing advances to step S173, at which the control portion 186 determines whether or not the value of the AIF use flag (aif_bipred_flag) for the bi-prediction mode is 1. If it is determined at step S173 that the value of aif_bipred_flag is 1, then the processing advances to step S174, at which the A2 filter coefficient memory 202 replaces the stored filter coefficient with the filter coefficient A2 included in the slice header from the lossless decoding section 162 under the control of the control portion 186.

If it is determined at step S173 that the value of aif_bipred_flag is not 1, then the processing advances to step S175, at which the control portion 186 determines whether or not the value of the AIF use flag (aif_direct_flag) for the direct mode is 1. If it is determined at step S175 that the value of aif_direct_flag is 1, then the processing advances to step S176, at which the A3 filter coefficient memory 203 replaces the stored filter coefficient with the filter coefficient A3 included in the slice header from the lossless decoding section 162 under the control of the control portion 186.

If it is determined at step S175 that the value of aif_direct_flag is not 1, then the processing advances to step S177, at which the control portion 186 determines whether or not the value of the AIF use flag (aif_skip_flag) for the skip mode is 1. If it is determined at step S177 that the value of aif_skip_flag is 1, then the processing advances to step S178, at which the A4 filter coefficient memory 204 replaces the stored filter coefficient with the filter coefficient A4 included in the slice header from the lossless decoding section 162 under the control of the control portion 186.

If it is determined at step S177 that the value of aif_skip_flag is not 1, then the processing advances to step S154 of FIG. 23. In particular, in this instance, since no AIF is used, the processing advances without replacement of any filter coefficient.

In this manner, the image encoding apparatus 51 and the image decoding apparatus 151 select filter coefficients to be used for interpolation filtering depending at least upon whether or not they are to be used in the L0L1 weighted prediction. In particular, in the case where filter coefficients are to be used in the L0L1 weighted prediction, filter coefficients having such a characteristic that high frequency components of an image after the filter process are amplified are selected.

Accordingly, since high frequency components which are lost by the L0L1 weighted prediction are amplified in advance, frequency components after weighted prediction are suppressed from being lost, and the prediction accuracy is improved.

Consequently, since a residual signal which needs to be included in stream information to be sent to the decoding side is reduced, the bit number can be reduced and the encoding efficiency is improved.

Further, when weighted prediction is to be carried out, filter coefficients are selected in response to the bi-prediction mode, direct mode and skip mode. In particular, filter coefficients having a characteristic in degree of amplification of high frequency components for each mode are selected. Consequently, as described hereinabove with reference to FIG. 7, it is possible to cope with a case in which the degree of positional displacement is different among the bi-prediction mode, direct mode and skip mode.

Further, since this filter selection is applied also to the variable filter (AIF), also in the AIF, loss of high frequency components of an image can be suppressed and a clear sense of the picture quality can be obtained.

It is to be noted that, while, in the foregoing description, an example wherein a filter having six taps is used is described, the tap number of the filter is not restricted.

While the foregoing description is given taking an interpolation filter of a Separable AIF as an example, the structure of the filter is not limited to that of the Separable AIF. In other words, even if the filter is different in structure, the present invention can be applied to the filter.

### [Description of Application to an Extended Macro Block Size]

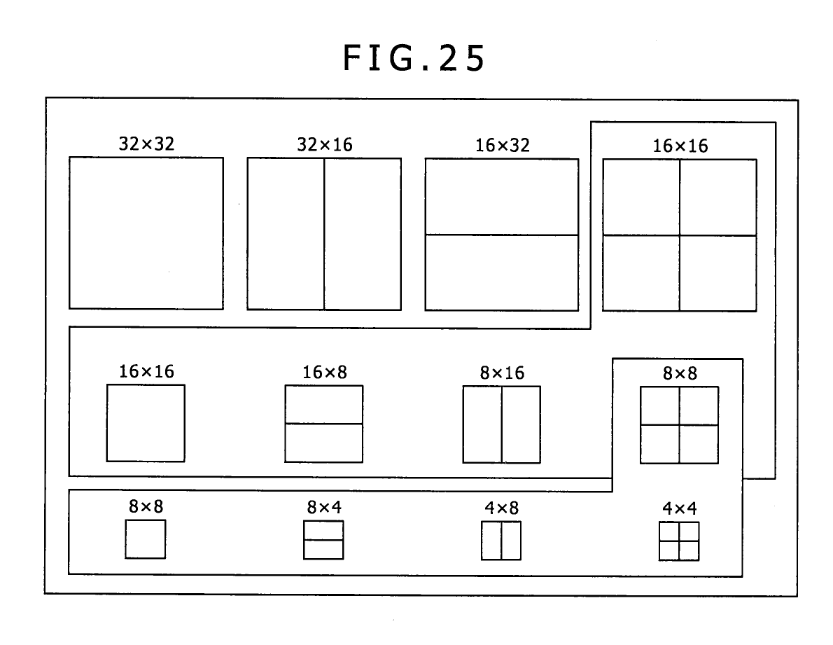

FIG. 25 is a view illustrating an example of a block size proposed in Non-Patent Document 4. In Non-Patent Document 4, the macro block size is extended to 32×32 pixels.

At an upper stage of FIG. 25, macro blocks configured from 32×32 pixels and divided into blocks (partitions) of 32×32 pixels, 32×16 pixels, 16×32 pixels and 16×16 pixels are shown in order from the left. At a middle stage of FIG. 25, blocks configured from 16×16 pixels and divided into blocks (partitions) of 16×16 pixels, 16×8 pixels, 8×16 pixels and 8×8 pixels are shown in order from the left. Further, at a lower stage of FIG. 25, blocks configured from 8×8 pixels and divided into blocks (partitions) of 8×8 pixels, 8×4 pixels, 4×8 pixels and 4×4 pixels are shown in order from the left.

In particular, a macro block of 32×32 pixels can be processed in a block of 32×32 pixels, 32×16 pixels, 16×32 pixels and 16×16 pixels shown at the upper stage of FIG. 25.

The block of 16×16 pixels shown on the right side at the upper stage can be processed in a block of 16×16 pixels, 16×8 pixels, 8×16 pixels and 8×8 pixels shown at the middle stage, similarly as in the H.264/AVC method.

The block of 8×8 pixels shown on the right side at the middle stage can be processed in a block of 8×8 pixels, 8×4 pixels, 4×8 pixels and 4×4 pixels shown at the lower stage, similarly as in the H.264/AVC method.

By such a hierarchical structure as described above, in the proposal of Non-Patent Document 4, while the compatibility with the H.264/AVC method is maintained with regard to the blocks of 16×16 pixels or less, a greater block is defined as a superset of them.

The present invention can be applied also to such an extended macro block size proposed as described above.

Further, while, in the foregoing description, the H.264/AVC method is used as the base for the encoding method, the present invention is not limited to this and can be applied to an image encoding apparatus/image decoding apparatus in which an encoding method/decoding method wherein any other motion prediction and compensation process is carried out are used.

It is to be noted that the present invention can be applied to an image encoding apparatus and an image decoding apparatus which are used to receive image information (a bit stream) compressed by orthogonal transform and motion compensation such as discrete cosine transform, for example, as in MPEG, H.26x through a network medium such as a satellite broadcast, cable television, the Internet or a portable telephone set. Further, the present invention can be applied to an image encoding apparatus and an image decoding apparatus which are used upon processing on a storage medium such as an optical or magnetic disk and a flash memory. Furthermore, the present invention can be applied also to a motion prediction compensation apparatus included in those image encoding apparatus and image decoding apparatus and so forth.

It is to be noted that, while the series of processes described above can be executed by hardware, it may otherwise be executed by software. In the case where the series of processes is executed by software, a program which constructs the software is installed into a computer. Here, the computer includes a computer incorporated in hardware for exclusive use, a personal computer for universal use which can execute various functions by installing various programs, and so forth.

### [Example of the Configuration of the Personal Computer]

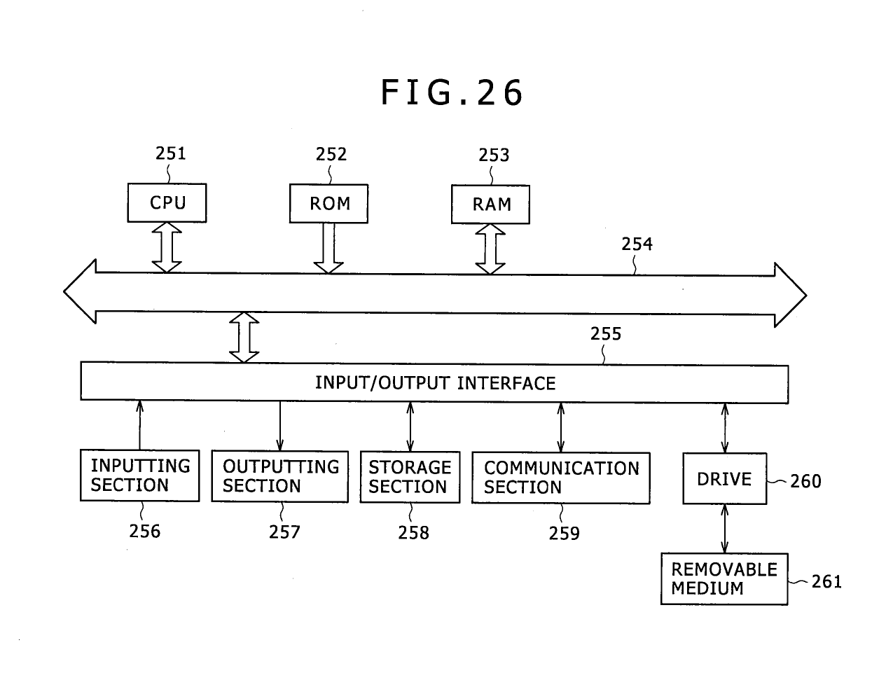

FIG. 26 is a block diagram showing an example of a configuration of hardware of a computer which executes the series of processes of the present invention in accordance with a program.

In the computer, a CPU (Central Processing Unit) 251, a ROM (Read Only Memory) 252 and a RAM (Random Access Memory) 253 are connected to each other by a bus 254.

To the bus 254, an input/output interface 255 is connected further. To the input/output interface 255, an inputting section 256, an outputting section 257, a storage section 258, a communication section 259 and a drive 260 are connected.

The inputting section 256 includes a keyboard, a mouse, a microphone and so forth. The outputting section 257 includes a display unit, a speaker and so forth. The storage section 258 includes a hard disk, a nonvolatile memory and so forth. The communication section 259 includes a network interface and so forth. The drive 260 drives a removable medium 261 such as a magnetic disk, an optical disk, a magneto-optical disk or a semiconductor memory.

In the computer configured in such a manner as described above, the CPU 251 loads a program stored, for example, in the storage section 258 into the RAM 253 through the input/output interface 255 and the bus 254 and executes the program to carry out the series of processes described hereinabove.

The program which is executed by the computer (CPU 251) can be recorded into or on and provided as the removable medium 261, for example, as a package medium or the like. Further, the program can be provided through a wired or wireless transmission medium such as a local area network, the Internet or a digital broadcast.

In the computer, the program can be installed into the storage section 258 through the input/output interface 255 by loading the removable medium 261 into the drive 260. Further, the program can be received by the communication section 259 through a wired or wireless transmission medium and installed into the storage section 258. Or else, the program can be installed in the ROM 252 or the storage section 258 in advance.

It is to be noted that the program to be executed by the computer may be a program whose processes are carried out in time series in accordance with an order described in the present specification or a program whose processes are carried out in parallel or at a necessary timing such as when they are invoked.

The embodiment of the present invention is not limited to the embodiment described hereinabove but can be modified in various manners without departing from the subject matter of the present invention.

For example, the image encoding apparatus 51 or the image decoding apparatus 151 described hereinabove can be applied to an arbitrary electronic apparatus. Several examples are described below.

### [Example of the Configuration of the Television Receiver]

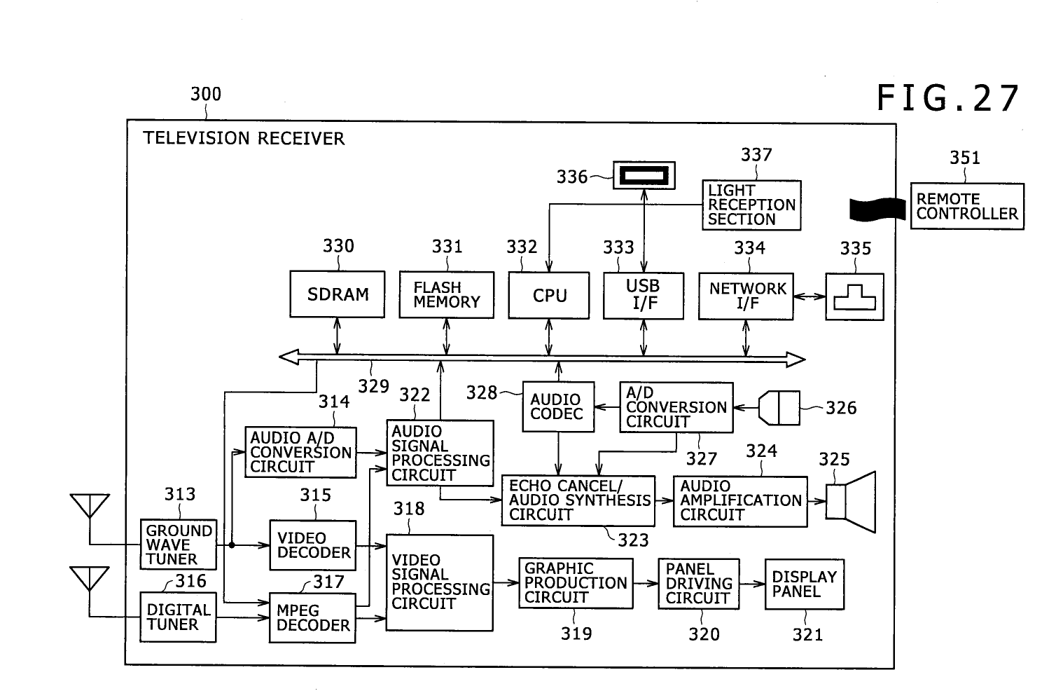

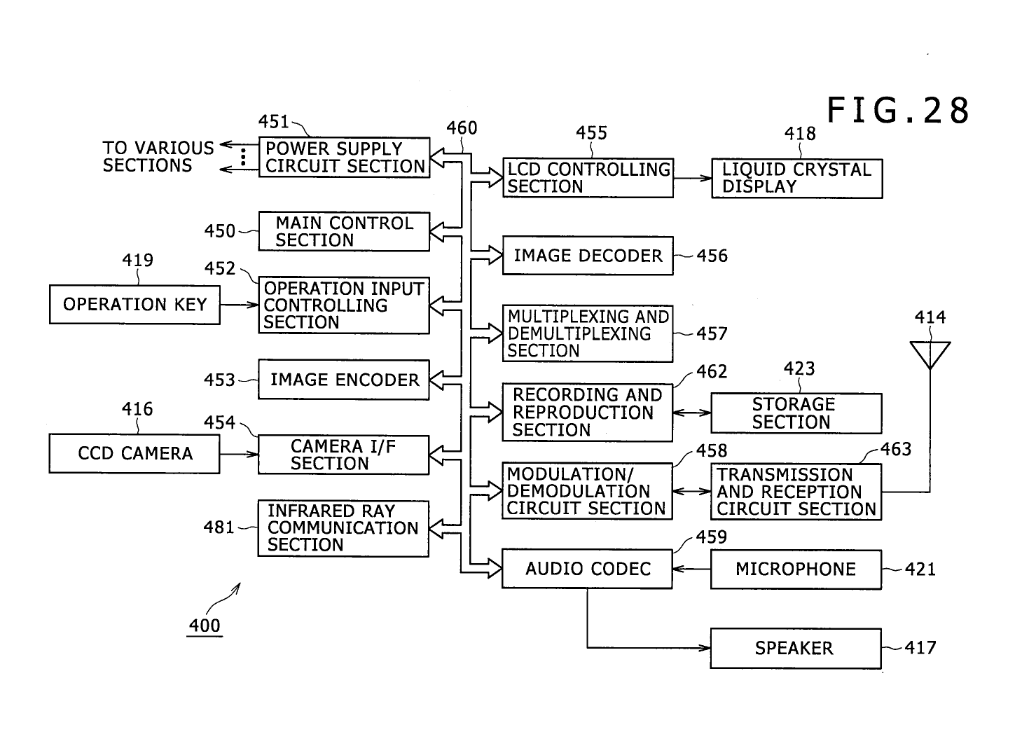

FIG. 27 is a block diagram showing an example of principal components of a television receiver which uses the image decoding apparatus to which the present invention is applied.

The television receiver 300 shown in FIG. 27 includes a ground wave tuner 313, a video decoder 315, a video signal processing circuit 318, a graphic production circuit 319, a panel driving circuit 320, and a display panel 321.

The ground wave tuner 313 receives a broadcasting wave signal of a terrestrial analog broadcast through an antenna, demodulates the broadcasting signal to acquire a video signal and supplies the video signal to the video decoder 315. The video decoder 315 carries out a decoding process for the video signal supplied thereto from the ground wave tuner 313 and supplies resulting digital component signals to the video signal processing circuit 318.

The video signal processing circuit 318 carries out a predetermined process such as noise removal for the video data supplied thereto from the video decoder 315 and supplies resulting video data to the graphic production circuit 319.

The graphic production circuit 319 produces video data of a program to be displayed on the display panel 321 or image data by a process based on an application supplied thereto through the network and supplies the produced video data or image data to the panel driving circuit 320. Further, the graphic production circuit 319 suitably carries out also such a process as to supply video data obtained by producing video data (graphic) for displaying a screen image to be used by a user for selection of an item and superposing the video data on the video data of the program to the panel driving circuit 320.

The panel driving circuit 320 drives the display panel 321 based on the data supplied thereto from the graphic production circuit 319 so that a video of the program or various kinds of screen images described hereinabove are displayed on the display panel 321.

The display panel 321 is formed from an LCD (Liquid Crystal Display) unit or the like and displays a video of a program under the control of the panel driving circuit 320.

The television receiver 300 further includes an audio A/D (Analog/Digital) conversion circuit 314, an audio signal processing circuit 322, an echo cancel/audio synthesis circuit 323, an audio amplification circuit 324 and a speaker 325.

The ground wave tuner 313 demodulates a received broadcasting wave signal to acquire not only a video signal but also an audio signal. The ground wave tuner 313 supplies the acquired audio signal to the audio A/D conversion circuit 314.

The audio A/D conversion circuit 314 carries out an A/D conversion process for the audio signal supplied thereto from the ground wave tuner 313 and supplies a resulting digital audio signal to the audio signal processing circuit 322.

The audio signal processing circuit 322 carries out a predetermined process such as noise removal for the audio data supplied thereto from the audio A/D conversion circuit 314 and supplies resulting audio data to the echo cancel/audio synthesis circuit 323.

The echo cancel/audio synthesis circuit 323 supplies the audio data supplied thereto from the audio signal processing circuit 322 to the audio amplification circuit 324.

The audio amplification circuit 324 carries out a D/A conversion process and an amplification process for the audio data supplied thereto from the echo cancel/audio synthesis circuit 323 to adjust the audio data to a predetermined sound level so that sound is outputted from the speaker 325.

Further, the television receiver 300 includes a digital tuner 316 and an MPEG decoder 317.

The digital tuner 316 receives a broadcasting wave signal of a digital broadcast (terrestrial digital broadcast, BS (Broadcasting Satellite)/CS (Communication Satellite) digital broadcast) through the antenna, demodulates the broadcasting wave signal to acquire an MPEG-TS (Moving Picture Experts Group-Transport Stream) and supplies the MPEG-TS to the MPEG decoder 317.

The MPEG decoder 317 cancels scrambling applied to the MPEG-TS supplied thereto from the digital tuner 316 to extract a stream including data of a program which is an object of reproduction (object of viewing). The MPEG decoder 317 decodes audio packets which configure the extracted stream and supplies resulting audio data to the audio signal processing circuit 322. Further, the MPEG decoder 317 decodes video packets which configure the stream and supplies resulting video data to the video signal processing circuit 318. Further, the MPEG decoder 317 supplies extracted EPG (Electronic Program Guide) data extracted from the MPEG-TS to a CPU 332 through a path not shown.

The television receiver 300 uses the image decoding apparatus 151 described hereinabove as the MPEG decoder 317 which decodes the video packets in this manner. Accordingly, the MPEG decoder 317 is suppressed from losing high frequency components after weighted prediction, and a clear sense of the picture quality is obtained, as in the case of the image decoding apparatus 151.

The video data supplied from the MPEG decoder 317 are subjected to a predetermined process by the video signal processing circuit 318 similarly as in the case of the video data supplied from the video decoder 315. Then, on the video data to which the predetermined process is applied, video data produced by the graphic production circuit 319 or the like are suitably superposed, and resulting data are supplied to the display panel 321 through the panel driving circuit 320 so that an image of the data is displayed on the display panel 321.

The audio data supplied from the MPEG decoder 317 are subjected to a predetermined process by the audio signal processing circuit 322 similarly as in the case of the audio data supplied from the audio A/D conversion circuit 314. Then, the audio data subjected to the predetermined process are supplied through the echo cancel/audio synthesis circuit 323 to the audio amplification circuit 324, by which a D/A conversion process and an amplification process are carried out therefor. As a result, sound adjusted to a predetermined sound amount is outputted from the speaker 325.

The television receiver 300 includes a microphone 326 and an A/D conversion circuit 327 as well.

The A/D conversion circuit 327 receives a signal of voice of the user fetched by the microphone 326 provided for voice conversation in the television receiver 300. The A/D conversion circuit 327 carries out a predetermined A/D conversion process for the received voice signal and supplies resulting digital voice data to the echo cancel/audio synthesis circuit 323.

The echo cancel/audio synthesis circuit 323 carries out, in the case where data of voice of the user (user A) of the television receiver 300 are supplied from the A/D conversion circuit 327 thereto, echo cancellation for the voice data of the user A. Then, the echo cancel/audio synthesis circuit 323 causes data of the voice obtained by synthesis with other sound data or the like after the echo cancellation to be outputted from the speaker 325 through the audio amplification circuit 324.

Further, the television receiver 300 includes an audio codec 328, an internal bus 329, an SDRAM (Synchronous Dynamic Random Access Memory) 330, a flash memory 331, the CPU 332, a USB (Universal Serial Bus) I/F 333, and a network I/F 334 as well.

The A/D conversion circuit 327 receives a signal of voice of the user fetched by the microphone 326 provided for voice conversation in the television receiver 300. The A/D conversion circuit 327 carries out an A/D conversion process for the received voice signal and supplies resulting digital voice data to the audio codec 328.

The audio codec 328 converts the voice data supplied thereto from the A/D conversion circuit 327 into data of a predetermined format for transmission through a network and supplies the data to the network I/F 334 through the internal bus 329.

The network I/F 334 is connected to a network through a cable connected to a network terminal 335. The network I/F 334 transmits voice data supplied thereto from the audio codec 328, for example, to a different apparatus connected to the network. Further, the network I/F 334 receives sound data transmitted, for example, from the different apparatus connected thereto through the network, through the network terminal 335 and supplies the sound data to the audio codec 328 through the internal bus 329.

The audio codec 328 converts the sound data supplied thereto from the network I/F 334 into data of a predetermined format and supplies the data of the predetermined format to the echo cancel/audio synthesis circuit 323.

The echo cancel/audio synthesis circuit 323 carries out echo cancellation for the sound data supplied thereto from the audio codec 328 and causes data of sound obtained by synthesis with different sound data or the like to be outputted from the speaker 325 through the audio amplification circuit 324.

The SDRAM 330 stores various kinds of data necessary for the CPU 332 to carry out processing.

The flash memory 331 stores a program to be executed by the CPU 332. The program stored in the flash memory 331 is read out at a predetermined timing such as upon starting of the television receiver 300 by the CPU 332. Into the flash memory 331, also EGP data acquired through a digital broadcast, data acquired from a predetermined server through a network and so forth are stored.

For example, an MPEG-TS including contents data acquired from a predetermined server through a network is stored into the flash memory 331 under the control of the CPU 332. The flash memory 331 supplies, for example, the MPEG-TS to the MPEG decoder 317 through the internal bus 329 under the control of the CPU 332.

For example, the MPEG decoder 317 processes the MPEG-TS similarly as in the case of the MPEG-TS supplied from the digital tuner 316. In this manner, the television receiver 300 can receive contents data configured from a video, an audio and so forth through a network, decode the content data by using the MPEG decoder 317 and cause the video of the data to be displayed or the audio to be outputted.

Further, the television receiver 300 includes a light reception section 337 for receiving an infrared signal transmitted from a remote controller 351 as well.

The light reception section 337 receives infrared rays from the remote controller 351 and outputs a control code obtained by demodulation of the infrared rays and representative of the substance of a user operation to the CPU 332.

The CPU 332 executes a program stored in the flash memory 331 and controls general operation of the television receiver 300 in response to a control code supplied thereto from the light reception section 337. The CPU 332 and the other components of the television receiver 300 are connected to each other by a path not shown.

The USB I/F 333 carries out transmission and reception of data to and from an external apparatus to the television receiver 300 connected thereto through a USB cable connected to a USB terminal 336. The network I/F 334 is connected to a network through a cable connected to the network terminal 335 and carries out also transmission and reception of data other than audio data to and from various apparatus connected to the network.

The television receiver 300 can enhance the encoding efficiency to obtain a clear sense of the picture quality by using the image decoding apparatus 151 as the MPEG decoder 317. As a result, the television receiver 300 can acquire and display a decoded image of a higher definition from a broadcasting signal through the antenna or content data acquired through the network.

### [Example of the Configuration of the Portable Telephone Set]

FIG. 28 is a block diagram showing an example of principal components of a portable telephone set which uses the image encoding apparatus and the image decoding apparatus to which the present invention is applied.

The portable telephone set 400 shown in FIG. 28 includes a main control section 450 for comprehensively controlling various components, a power supply circuit section 451, an operation input controlling section 452, an image encoder 453, a camera I/F section 454, an LCD controlling section 455, an image decoder 456, a multiplexing and demultiplexing section 457, a recording and reproduction section 462, a modulation/demodulation circuit section 458, and an audio codec 459. The components mentioned are connected to each other through a bus 460.

The portable telephone set 400 further includes an operation key 419, a CCD (Charge Coupled Devices) camera 416, a liquid crystal display unit 418, a storage section 423, a transmission and reception circuit section 463, an antenna 414, a microphone (mic) 421 and a speaker 417.

If a clearing and power supply key is placed into an on state by an operation of the user, then the power supply circuit section 451 supplies power to the components from a battery pack to start up the portable telephone set 400 into an operable state.

The portable telephone set 400 carries out various operations such as transmission and reception of an audio signal, transmission and reception of an electronic mail or image data, image pickup or data recording in various modes such as a voice call mode or a data communication mode under the control of the main control section 450 configured from a CPU, a ROM, a RAM and so forth.

For example, in the voice call mode, the portable telephone set 400 converts a voice signal collected by the microphone (mic) 421 into digital sound data by means of the audio codec 459, carries out a spectrum spreading process of the digital sound data by means of the modulation/demodulation circuit section 458, and carries out a digital to analog conversion process and a frequency conversion process by means of the transmission and reception circuit section 463. The portable telephone set 400 transmits a transmission signal obtained by the conversion process to a base station not shown through the antenna 414. The transmission signal (sound signal) transmitted to the base station is supplied to a portable telephone set of the opposite party of the call through a public telephone network.

Further, for example, in the voice call mode, the portable telephone set 400 amplifies a reception signal received by the antenna 414 by means of the transmission and reception circuit section 463 and further carries out a frequency conversion process and an analog to digital conversion process, carries out a spectrum despreading process by means of the modulation/demodulation circuit section 458 and converts the reception signal into an analog sound signal by means of the audio codec 459. The portable telephone set 400 outputs an analog sound signal obtained by the conversion from the speaker 417.

Further, for example, in the case where an electronic mail is to be transmitted in the data communication mode, the portable telephone set 400 accepts text data of an electronic mail inputted by an operation of the operation key 419 by means of the operation input controlling section 452. The portable telephone set 400 processes the text data by means of the main control section 450 and causes the liquid crystal display unit 418 to display the text data as an image through the LCD controlling section 455.

Further, the portable telephone set 400 produces electronic mail data based on text data, a user instruction or the like accepted by the operation input controlling section 452 by means of the main control section 450. The portable telephone set 400 carries out a spectrum spreading process of the electronic mail data by means of the modulation/demodulation circuit section 458 and carries out a digital to analog conversion process and a frequency conversion process by means of the transmission and reception circuit section 463. The portable telephone set 400 transmits a transmission signal obtained by the conversion process to a base station not shown through the antenna 414. The transmission signal (electronic mail) transmitted to the base state is supplied to a predetermined destination through the network, a mail server and so forth.

On the other hand, for example, in the case where an electronic mail is received in the data communication mode, the portable telephone set 400 receives a signal transmitted thereto from the base station by means of the transmission and reception circuit section 463 through the antenna 414, amplifies the signal and further carries out a frequency conversion process and an analog to digital conversion process. The portable telephone set 400 carries out a spectrum despreading process of the reception signal by means of the modulation/demodulation circuit section 458 to restore the original electronic mail data. The portable telephone set 400 causes the restored electronic mail data to be displayed on the liquid crystal display unit 418 through the LCD controlling section 455.

It is to be noted that also it is possible for the portable telephone set 400 to record (store) the received electronic mail data into the storage section 423 through the recording and reproduction section 462.

This storage section 423 is an arbitrary rewritable storage medium. The storage section 423 may be a semiconductor memory such as, for example, a RAM or a built-in type flash memory or may be a hard disk or else may be a removable medium such as a magnetic disk, a magneto-optical disk, an optical disk, a USB memory or a memory card. Naturally, the storage section 423 may be any other storage section.

Further, for example, in the case where image data are to be transmitted in the data communication mode, the portable telephone set 400 produces image data by image pickup by means of the CCD camera 416. The CCD camera 416 has optical devices such as a lens and a stop and a CCD unit as a photoelectric conversion element, and picks up an image of an image pickup object, converts the intensity of received light into an electric signal and produces image data of the image of the image pickup object. The image data are compression encoded in accordance with a predetermined encoding method of, for example, MPEG2, MPEG4 or the like by means of the image encoder 453 through the camera I/F section 454 to convert the image data into encoded image data.

The portable telephone set 400 uses the image encoding apparatus 51 described hereinabove as the image encoder 453 which carries out such processes as described above. Accordingly, the image encoder 453 can reduce the used region of the frame memory and reduce the overhead of filter coefficients to be included into stream information.

It is to be noted that the portable telephone set 400 simultaneously carries out, by means of the audio codec 459, analog to digital conversion of the voice collected by means of the microphone (mic) 421 during image pickup of the CCD camera 416 and further carries out encoding of the voice.

The portable telephone set 400 multiplexes encoded image data supplied thereto from the image encoder 453 and digital sound data supplied thereto from the audio codec 459 by a predetermined method by means of the multiplexing and demultiplexing section 457. The portable telephone set 400 carries out a spectrum spreading process of the multiplexed data obtained by the multiplexing by means of the modulation/demodulation circuit section 458 and further carries out a digital to analog conversion process and a frequency conversion process by means of the transmission and reception circuit section 463. The portable telephone set 400 transmits a transmission signal obtained by the conversion processes to the base station not shown through the antenna 414. The transmission signal (image data) transmitted to the base station is supplied to the opposite party of the communication through the network or the like.

It is to be noted that, in the case where the image data are not transmitted, also it is possible for the portable telephone set 400 to cause the image data produced by the CCD camera 416 to be displayed on the liquid crystal display unit 418 through the LCD controlling section 455 without interposition of the image encoder 453.

Further, in the case where, for example, in the data communication mode, data of a moving image file linked to a simple homepage or the like are to be received, the portable telephone set 400 receives the signal transmitted from the base station by means of the transmission and reception circuit section 463 through the antenna 414, amplifies the signal and further carries out a frequency conversion process and an analog to digital conversion process for the signal. The portable telephone set 400 carries out a spectrum despreading process for the reception signal by means of the modulation/demodulation circuit section 458 to restore the original multiplexed data. The portable telephone set 400 demultiplexes the multiplexed data into encoded image data and encoded sound data by means of the multiplexing and demultiplexing section 457.

The portable telephone set 400 decodes, by means of the image decoder 456, the encoded image data in accordance with a decoding method corresponding to the predetermined encoding method such as MPEG2 or MPEG4 to produce reproduced moving image data and causes the reproduced moving image data to be displayed on the liquid crystal display unit 418 through the LCD controlling section 455. Consequently, for example, video data included in the moving image file linked to the simple homepage are displayed on the liquid crystal display unit 418.

The portable telephone set 400 uses the image decoding apparatus 151 described hereinabove as the image decoder 456 which carries out such processes as described above. Accordingly, the image decoder 456 can reduce the used region of the frame memory and reduce the overhead of filter coefficients to be included into stream information similarly as in the case of the image decoding apparatus 151.

At this time, the portable telephone set 400 simultaneously converts digital sound data into an analog sound signal by means of the audio codec 459 and causes the analog sound data to be outputted from the speaker 417. Consequently, for example, the sound data included in a video file linked to the simple homepage are reproduced.

It is to be noted that also it is possible for the portable telephone set 400 to record (store) the received data linked to the simple homepage or the like into the storage section 423 through the recording and reproduction section 462 similarly as in the case of an electronic mail.

Further, the portable telephone set 400 can analyze a two-dimensional code obtained by image pickup by the CCD camera 416 to acquire information recorded in the two-dimensional code by means of the main control section 450.

Furthermore, the portable telephone set 400 can communicate with an external apparatus using infrared rays by means of an infrared communication section 481.

The portable telephone set 400 is suppressed from losing high frequency components after weighted prediction and a clear sense of the picture quality is obtained by using the image encoding apparatus 51 as the image encoder 453. As a result, the portable telephone set 400 can provide encoded data (image data) of a high encoding efficiency to a different apparatus.

Further, the portable telephone set 400 is suppressed from losing high frequency components after weighted prediction and a clear sense of the picture quality is obtained by using the image decoding apparatus 151 as the image decoder 456. As a result, the portable telephone set 400 can obtain and display a decoded image of a higher definition, for example, from a video file linked to a simple homepage.

It is to be noted that, while it is described in the foregoing description that the portable telephone set 400 uses the CCD camera 416, it may otherwise use an image sensor (CMOS image sensor) in which a CMOS (Complementary Metal Oxide Semiconductor) camera is used in place of the CCD camera 416. Also in this instance, the portable telephone set 400 can pick up an image of an image pickup object and produce image data of the image of the image pickup object similarly as in the case where the CCD camera 416 is used.

Further, while it is described in the foregoing description that the electronic apparatus is formed as the portable telephone set 400, the image encoding apparatus 51 and the image decoding apparatus 151 can be applied to any apparatus which has an image pickup function and a communication function similar to those of the portable telephone set 400 such as, for example, a PDA (Personal Digital Assistants), a smartphone, a UMPG (Ultra Mobile Personal Computer), a network book, or a notebook type personal computer similarly as in the case of the portable telephone set 400.

### [Example of the Configuration of the Hard Disk Recorder]

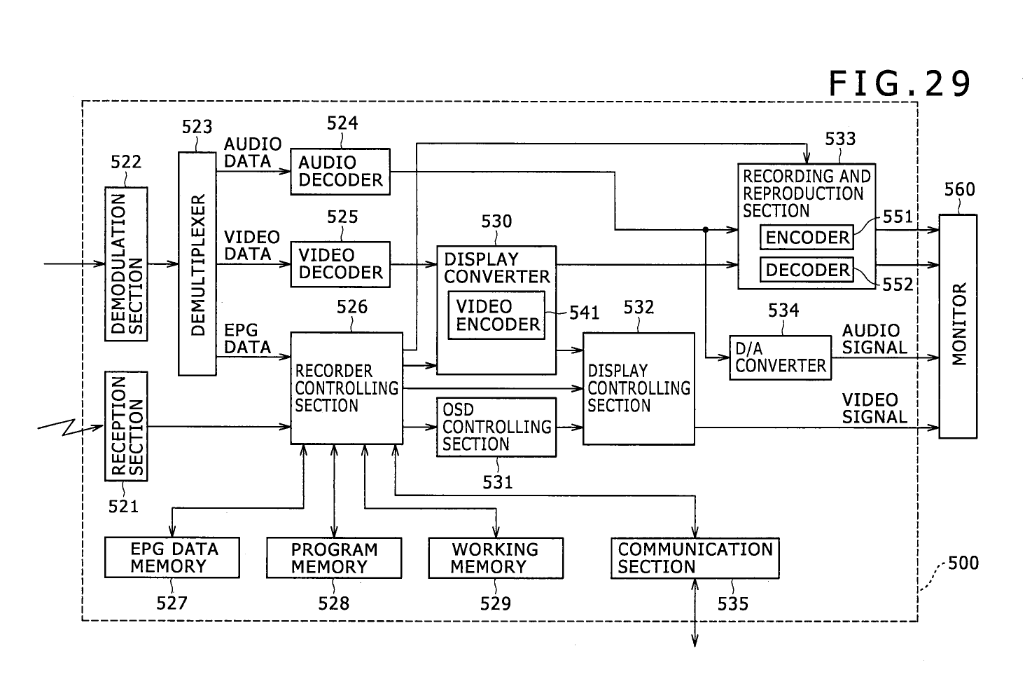

FIG. 29 is a block diagram showing an example of principal components of a hard disk recorder which uses the image encoding apparatus and the image decoding apparatus to which the present invention is applied.

The hard disk recorder (HDD recorder) 500 shown in FIG. 29 is an apparatus which saves audio data and video data of a broadcasting program included in a broadcasting wave signal (television signal) transmitted from a satellite, an antenna on the ground or the like and received by a tuner on a hard disk built therein and provides the saved data to a user at a timing in accordance with an instruction of the user.

The hard disk recorder 500 can extract audio data and video data, for example, from a broadcasting wave signal, suitably decode the audio data and the video data and store the audio data and the video data on the built-in hard disk. Also it is possible for the hard disk recorder 500 to acquire audio data and video data from a different apparatus, for example, through a network, suitably decode the audio data and the video data and store the audio data and the video data on the built-in hard disk.

Further, the hard disk recorder 500 decodes audio data and video data, for example, recorded on the built-in hard disk and supplies the audio data and the video data to a monitor 560 so that an image is displayed on the screen of the monitor 560. Further, the hard disk recorder 500 can cause sound of the audio data to be outputted from the monitor 560.

The hard disk recorder 500 decodes audio data and video data extracted from a broadcasting wave signal acquired, for example, through a tuner or audio data and video data acquired from a different apparatus through a network and supplies the audio data and the video data to the monitor 560 so that an image of the video data is displayed on the screen of the monitor 560. Also it is possible for the hard disk recorder 500 to output sound of the audio data from a speaker of the monitor 560.

Naturally, other operations can be carried out.

As shown in FIG. 29, the hard disk recorder 500 includes a reception section 521, a demodulation section 522, a demultiplexer 523, an audio decoder 524, a video decoder 525, and a recorder controller section 526. The hard disk recorder 500 further includes an EPG data memory 527, a program memory 528, a work memory 529, a display converter 530, an OSD (On Screen Display) controlling section 531, a display controlling section 532, a recording and reproduction section 533, a D/A converter 534 and a communication section 535.

The display converter 530 includes a video encoder 541. The recording and reproduction section 533 includes an encoder 551 and a decoder 552.

The reception section 521 receives an infrared signal from a remote controller (not shown), converts the infrared signal into an electric signal and outputs the electric signal to the recorder controller section 526. The recorder controller section 526 is configured, for example, from a microprocessor and so forth and executes various processes in accordance with a program stored in the program memory 528. At this time, the recorder controller section 526 uses the work memory 529 as occasion demands.

The communication section 535 is connected to a network and carries out a communication process with a different apparatus through the network. For example, the communication section 535 is controlled by the recorder controller section 526, and communicates with a tuner (not shown) and outputs a channel selection controlling signal principally to the tuner.

The demodulation section 522 demodulates a signal supplied thereto from the tuner and outputs the demodulated signal to the demultiplexer 523. The demultiplexer 523 demultiplexes the data supplied thereto from the demodulation section 522 into audio data, video data and EPG data and outputs them to the audio decoder 524, video decoder 525 and recorder controller section 526, respectively.

The audio decoder 524 decodes the audio data inputted thereto, for example, in accordance with the MPEG method and outputs the decoded audio data to the recording and reproduction section 533. The video decoder 525 decodes the video data inputted thereto, for example, in accordance with the MPEG method and outputs the decoded video data to the display converter 530. The recorder controller section 526 supplies the EPG data inputted thereto to the EPG data memory 527 so as to be stored into the EPG data memory 527.

The display converter 530 encodes the video data supplied thereto from the video decoder 525 or the recorder controller section 526 into video data, for example, of the NTSC (National Television Standards Committee) system by means of the video encoder 541 and outputs the encoded video data to the recording and reproduction section 533. Further, the display converter 530 converts the size of the screen of the video data supplied thereto from the video decoder 525 and the recorder controller section 526 to a size corresponding to the size of the monitor 560. The display converter 530 converts the video data, whose screen size has been converted, further into video data of the NTSC system by the video encoder 541, converts the video data into an analog signal, and outputs the analog signal to the display controlling section 532.

The display controlling section 532 superposes an OSD signal outputted from the OSD (On Screen Display) controlling section 531 on a video signal inputted thereto from the display converter 530 under the control of the recorder controller section 526 and outputs a resulting signal to the display unit of the monitor 560 so as to be displayed on the display unit.

Further, audio data outputted from the audio decoder 524 are converted into an analog signal by the D/A converter 534 and supplied to the monitor 560. The monitor 560 outputs the audio signal from a speaker built therein.

The recording and reproduction section 533 has a hard disk as a storage medium for storing video data, audio data and so forth.

The recording and reproduction section 533 encodes audio data supplied thereto, for example, from the audio decoder 524 in accordance with the MPEG method by means of the encoder 551. Further, the recording and reproduction section 533 encodes video data supplied thereto from the video encoder 541 of the display converter 530 in accordance with the MPEG method by means of the encoder 551. The recording and reproduction section 533 multiplexes encoded data of the audio data and encoded data of the video data by means of a multiplexer. The recording and reproduction section 533 channel encodes and amplifies the multiplexed data and writes resulting data on the hard disk through a recording head.

The recording and reproduction section 533 reproduces data recorded on the hard disk through a reproduction head, amplifies the reproduced data and demultiplexes the amplified reproduced data into audio data and video data by means of a demultiplexer. The recording and reproduction section 533 decodes the audio data and the video data in accordance with the MPEG method by means of the decoder 552. The recording and reproduction section 533 D/A converts the decoded audio data and outputs resulting audio data to the speaker of the monitor 560. Further, the recording and reproduction section 533 D/A converts the decoded video data and outputs resulting data to the display of the monitor 560.

The recorder controller section 526 reads out the latest EPG data from the EPG data memory 527 based on a user instruction indicated by an infrared signal from the remote controller received through the reception section 521, and supplies the read out EPG data to the OSD controlling section 531. The OSD controlling section 531 generates image data corresponding to the inputted EPG data and outputs the image data to the display controlling section 532. The display controlling section 532 outputs the video data inputted thereto from the OSD controlling section 531 to the display unit of the monitor 560 so as to be displayed on the display unit. Consequently, an EPG (electronic program guide) is displayed on the display unit of the monitor 560.

Further, the hard disk recorder 500 can acquire various data such as video data, audio data and EPG data supplied thereto from a different apparatus through a network such as the Internet.

The communication section 535 is controlled by the recorder controller section 526, and acquires encoded data such as video data, audio data and EPG data from the different apparatus through the network and supplies the encoded data to the recorder controller section 526. The recorder controller section 526 supplies the acquired encoded data such as, for example, video data and audio data to the recording and reproduction section 533 so as to be stored on the hard disk. At this time, the recorder controller section 526 and the recording and reproduction section 533 may carry out processes such as re-encoding as occasion demands.

Further, the recorder controller section 526 decodes the acquired encoded data such as video data and audio data and supplies resulting video data to the display converter 530. The display converter 530 processes the video data supplied thereto from the recorder controller section 526 and supplies resulting data to the monitor 560 through the display controlling section 532 so that an image of the video data is displayed on the monitor 560 similarly to video data supplied from the video decoder 525.

Further, the recorder controller section 526 may supply the decoded audio data to the monitor 560 through the D/A converter 534 so that sound of the audio is outputted from the speaker in accordance with the image display.

Further, the recorder controller section 526 decodes encoded data of the acquired EPG data and supplies the decoded EPG data to the EPG data memory 527.

Such a hard disk recorder 500 as described above uses the image decoding apparatus 151 as a decoder built in the video decoder 525, decoder 552 and recorder controller section 526. Accordingly, the decoder built in the video decoder 525, decoder 552 and recorder controlling section 526 is suppressed from losing high frequency components after weighted prediction and a clear sense of the picture quality is obtained similarly as in the case of the image decoding apparatus 151.

Accordingly, the hard disk recorder 500 can produce a predicted image of high accuracy. As a result, the hard disk recorder 500 can obtain a decoded image of a higher definition, for example, from encoded data of video data received through the tuner, encoded data of video data read out from the hard disk of the recording and reproduction section 533 or encoded data of video data acquired through the network and display the decoded image on the monitor 560.

Further, the hard disk recorder 500 uses the image encoding apparatus 51 as the encoder 551. Accordingly, the encoder 551 is suppressed from losing high frequency components after weighted prediction and a clear sense of the picture quality is obtained similarly as in the case of the image encoding apparatus 51.

Accordingly, the hard disk recorder 500 can improve the encoding efficiency, for example, of encoded data to be recorded on the hard disk. As a result, the hard disk recorder 500 can utilize the storage region of the hard disk with a higher efficiency and at a higher speed.

It is to be noted that, while, in the foregoing description, the hard disk recorder 500 wherein video data or audio data are recorded on the hard disk is described, naturally any recording medium may be used. For example, also to a recorder which applies a recording medium other than a hard disk such as, for example, a flash memory, an optical disk or a video tape, the image encoding apparatus 51 and the image decoding apparatus 151 can be applied similarly as in the case of the hard disk recorder 500 described hereinabove.

### [Example of the Configuration of the Camera]

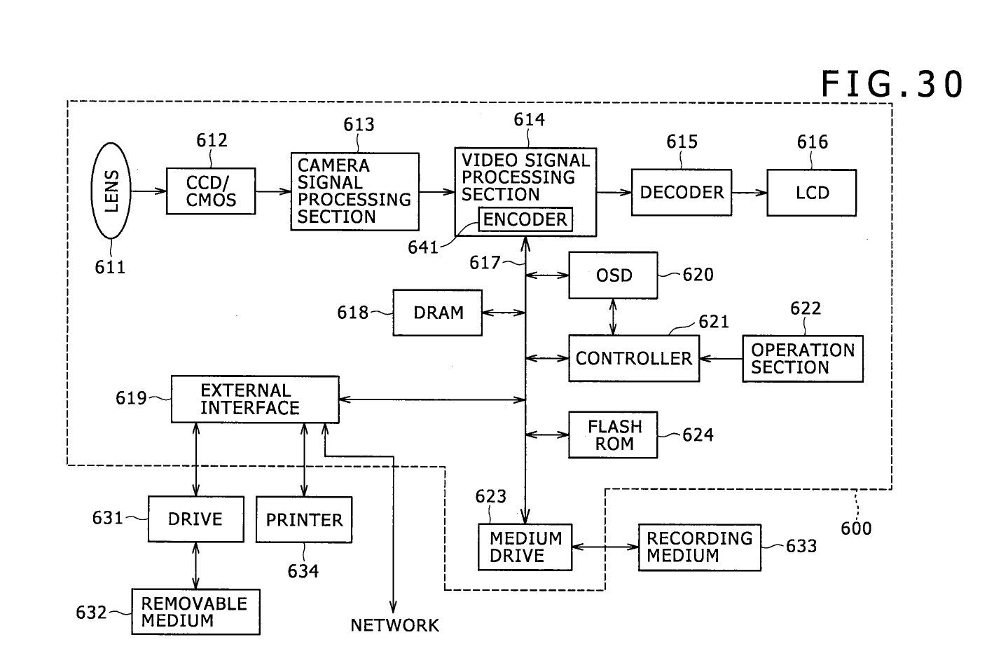

FIG. 30 is a block diagram showing an example of principal components of a camera which uses the image decoding apparatus and the image encoding apparatus to which the present invention is applied.

The camera 600 shown in FIG. 30 picks up an image of an image pickup object and causes the image of the image pickup object to be displayed on an LCD unit 616 or recorded as image data on or into a recording medium 633.

A lens block 611 allows light (that is, a video of an image pickup object) to be introduced into a CCD/CMOS unit 612. The CCD/CMOS unit 612 is an image sensor for which a CCD unit or a CMOS unit is used, and converts the intensity of received light into an electric signal and supplies the electric signal to a camera signal processing section 613.

The camera signal processing section 613 converts the electric signal supplied thereto from the CCD/CMOS unit 612 into color difference signals of Y, Cr and Cb and supplies the color difference signals to an image signal processing section 614. The image signal processing section 614 carries out a predetermined image process for the image signal supplied thereto from the camera signal processing section 613 or encodes the image signal, for example, in accordance with the MPEG method by means of an encoder 641 under the control of a controller 621. The image signal processing section 614 supplies encoded data produced by encoding the image signal to a decoder 615. Further, the image signal processing section 614 acquires display data produced by an on screen display (OSD) unit 620 and supplies the display data to the decoder 615.

In the processes described above, the camera signal processing section 613 suitably utilizes a DRAM (Dynamic Random Access Memory) 618 connected through a bus 617 and causes the DRAM 618 to retain image data, encoded data obtained by encoding the image data or the like as occasion demands.

The decoder 615 decodes the encoded data supplied thereto from the image signal processing section 614 and supplies resulting image data (decoded image data) to the LCD unit 616. Further, the decoder 615 supplies display data supplied thereto from the image signal processing section 614 to the LCD unit 616. The LCD unit 616 suitably synthesizes an image of the decoded image data and an image of the display data supplied thereto from the decoder 615 and displays the synthesized image.

The on screen display unit 620 outputs display data of a menu screen image formed from symbols, characters or figures or an icon to the image signal processing section 614 through the bus 617 under the control of the controller 621.

The controller 621 executes various processes based on a signal representative of the substance of an instruction issued by the user using an operation section 622 and controls the image signal processing section 614, the DRAM 618, and external interface 619, the on screen display unit 620, a medium drive 623 and so forth through the bus 617. In a FLASH ROM 624, a program, data and so forth necessary for the controller 621 to execute various processes are stored.

For example, the controller 621 can encode image data stored in the DRAM 618 or decode encoded data stored in the DRAM 618 in place of the image signal processing section 614 or the decoder 615. At this time, the controller 621 may carry out an encoding or decoding process in accordance with a method similar to the encoding or decoding method of the image signal processing section 614 or the decoder 615 or may carry out an encoding or decoding process in accordance with a method which is not compatible with the image signal processing section 614 or the decoder 615.

Further, for example, if an instruction to start image printing is issued from the operation section 622, then the controller 621 reads out image data from the DRAM 618 and supplies the image data to a printer 634 connected to the external interface 619 through the bus 617 so as to be printed by the printer 634.

Furthermore, for example, if an image recording instruction is issued from the operation section 622, then the controller 621 reads out encoded data from the DRAM 618 and supplies the encoded data to the recording medium 633 loaded in the medium drive 623 through the bus 617 so as to be stored into the recording medium 633.

The recording medium 633 is an arbitrary readable and writable removable medium such as, for example, a magnetic disk, a magneto-optical disk, an optical disk or a semiconductor memory. Naturally, also the type of the recording medium 633 as a type of a removable medium is arbitrary, and it may be a tape device or may be a disk or otherwise may be a memory card. Naturally, the recording medium 633 may be a contactless IC card or the like.

Further, the medium drive 623 and the recording medium 633 may be integrated with each other in such a manner as to be configured from a non-portable recording medium like, for example, a built-in type hard disk drive, an SSD (Solid State Drive) or the like.

The external interface 619 is configured, for example, from a USB input/output terminal and is connected to the printer 634 in the case where printing of an image is to be carried out. Further, the drive 631 is connected to the external interface 619 as occasion demands, and a removable medium 632 such as a magnetic disk, an optical disk or a magneto-optical disk is suitably loaded into the drive 631 such that a computer program read out from them is installed into the FLASH ROM 624 as occasion demands.

Further, the external interface 619 includes a network interface connected to a predetermined network such as a LAN or the Internet. The controller 621 reads out encoded data from the DRAM 618, for example, in accordance with an instruction from the operation section 622 and can supply the encoded data from the external interface 619 to a different apparatus connected thereto through the network. Further, the controller 621 can acquire encoded data or image data supplied from the different apparatus through the network through the external interface 619 and retain the acquired data into the DRAM 618 or supply the acquired data to the image signal processing section 614.

Such a camera 600 as described above uses the image decoding apparatus 151 as the decoder 615. Accordingly, the decoder 615 is suppressed from losing high frequency components after weighted prediction and a clear sense of the picture quality is obtained similarly as in the case of the image decoding apparatus 151.

Accordingly, the camera 600 can implement higher speed processing and produce a predicted image of high accuracy. As a result, the camera 600 can obtain a decoded image of a higher definition, for example, from image data produced by the CCD/CMOS unit 612, encoded data of video data read out from the DRAM 618 or the recording medium 633 or encoded data of video data acquired through the network and cause the decoded image to be displayed on the LCD unit 616.

Further, the camera 600 uses the image encoding apparatus 51 as the encoder 641. Accordingly, the encoder 641 is suppressed from losing high frequency components after weighted prediction and the prediction accuracy is improved similarly as in the case of the image coding apparatus 51.

Accordingly, the camera 600 can improve the encoding efficiency, for example, of encoded data to be recorded on the hard disk. As a result, the camera 600 can use the storage region of the DRAM 618 or the recording medium 633 with a higher efficiency at a higher speed.

It is to be noted that the decoding method of the image decoding apparatus 151 carried out by the controller 621 may be applied. Similarly, the encoding method of the image encoding apparatus 51 may be applied to the encoding process carried out by the controller 621.

Further, the image data obtained by image pickup by the camera 600 may be a moving image or may be a still image.

Naturally, the image encoding apparatus 51 and the image decoding apparatus 151 can be applied also to an apparatus or a system other than the apparatus described above.

### Second Embodiment

### [Example of the Configuration of the Image Encoding Apparatus]

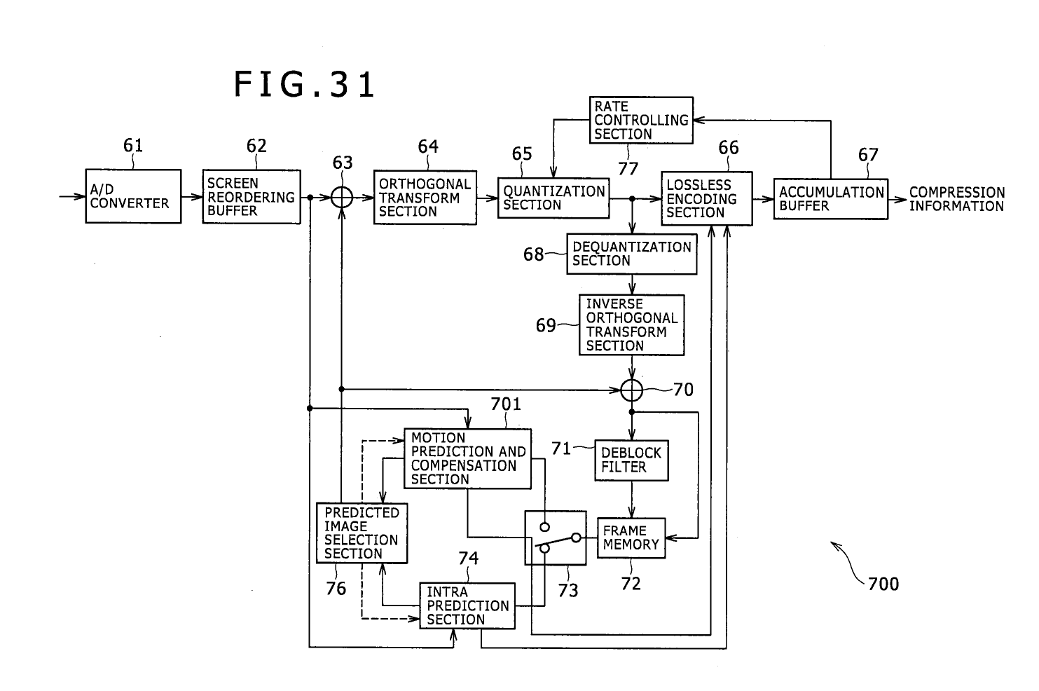

FIG. 31 shows a configuration of a second embodiment as an image encoding apparatus as the image processing apparatus to which the present invention is applied.

From among contents shown in FIG. 31, those which are same as the components of FIG. 8 are denoted by like reference characters. Overlapping description is suitably omitted.

The configuration of the image encoding apparatus 700 of FIG. 31 is different from the configuration of FIG. 8 principally in that a motion prediction and compensation section 701 is provided in place of the motion prediction and compensation section 75. The image encoding apparatus 700 carries out a filter process for a reference image using a SIFO (Single pass switched Interpolation Filter with Offset).

It is to be noted that the SIFO is an intermediate interpolation filter between a fixed interpolation filter and an AIF. In particular, in the SIFO, for each slice, filter coefficients of a desired one of sets (hereinafter referred to as filter coefficient set) of a plurality of kinds of filter coefficients determined in advance can be set and an offset can be set. Details of the SIFO are described, for example, in VCEG (Visual Coding Expert Group) A135, VCEG-AJ29 and so forth.

In the image encoding apparatus 700, the motion prediction and compensation section 701 determines, based on a reference image supplied thereto from the frame memory 72 through the switch 73 and an image supplied from the screen reordering buffer 62 to be inter processed, an offset to be set to the SIFO when a filter process for the reference image for each slice for each candidate inter prediction mode.

The motion prediction and compensation section 701 carries out a filter process for a reference image using SIFOs to which, for each candidate inter prediction mode, an offset of an object slice and combinations of filter coefficients of sub pels of all candidate filter coefficient sets corresponding to the inter prediction mode are set. In the following, the combinations of the filter coefficients of the sub pels of all filter coefficient sets are referred to as all combinations of all filter coefficient sets.

Further, the motion prediction and compensation section 701 carries out motion prediction for each block of all candidate inter prediction modes based on the image to be inter processed and the reference image after the filter process to generate a motion vector for each block. The motion prediction and compensation section 701 carries out a compensation process for each block of the reference image after the filter process based on the produced motion vectors to produce a predicted image. Then, the motion prediction and compensation section 701 determines a cost function value for each block for all combinations of all candidate filter coefficient sets corresponding to all candidate inter prediction modes.

Further, the motion prediction and compensation section 701 determines an optimum inter prediction mode for each block based on the cost function values of all candidate inter prediction modes corresponding to the reference image after the optimum filter process. It is to be noted that the optimum filter process is a filter process by a SIFO in which filter coefficients determined for a slice of a type same as that of an object slice of a frame immediately preceding to the object frame are set. The motion prediction and compensation section 701 supplies the predicted image produced based on the reference image after the optimum filter process of the optimum inter prediction mode and the cost function value corresponding to the predicted image to the predicted image selection section 76.

Further, the motion prediction and compensation section 701 determines filter coefficients for an optimum filter process of a slice of a type same as that of the object slice of a frame next to the object frame based on the optimum inter prediction mode of each block of the object slice and the cost function value of all combinations of all filter coefficient sets corresponding to the optimum inter prediction mode.

The motion prediction and compensation section 701 outputs, in the case where the predicted image of the optimum inter prediction mode is selected by the predicted image selection section 76, inter prediction mode information indicative of the optimum inter prediction mode to the lossless encoding section 66.

At this time, also motion vector information, reference frame information, information of the slice, a set number which is a number for specifying a filter coefficient set of filter coefficients in the optimum filter process, an offset and so forth are outputted to the lossless encoding section 66. Consequently, the lossless encoding section 66 carries out a lossless encoding process of the motion vector information, reference frame information, slice information, set number, offset and so forth and inserts resulting information into the header part of the compressed image. It is to be noted that the slice information, set number and offset are inserted into the slice header.

### [Example of the Configuration of the Motion Prediction and Compensation Section]

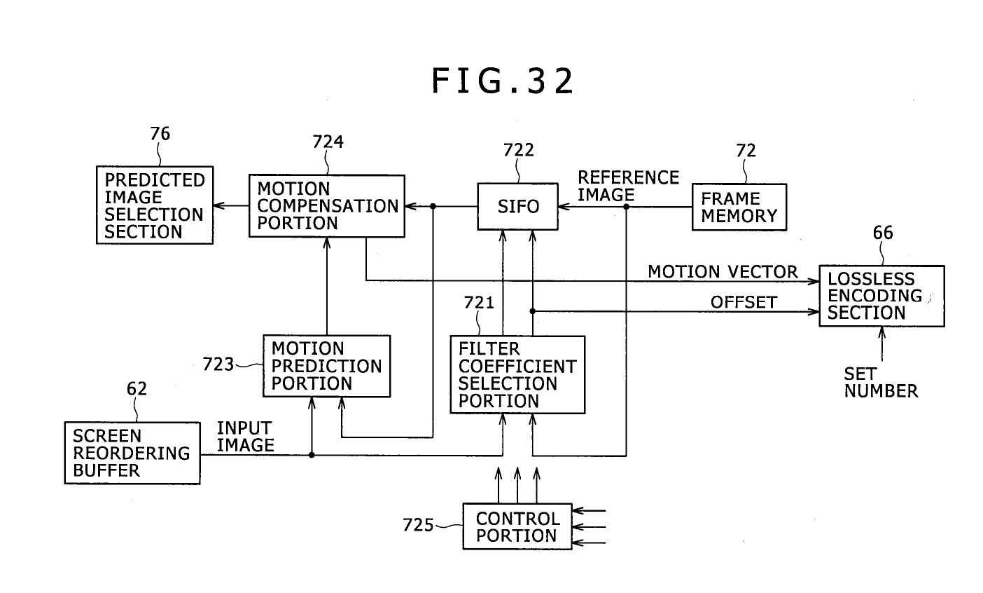

FIG. 32 is a block diagram showing an example of a configuration of the motion prediction and compensation section 701. It is to be noted that, in FIG. 32, the switch 73 of FIG. 31 is omitted.

Those of components shown in FIG. 32 which are similar to those of FIG. 9 are denoted by like reference characters. Overlapping description is omitted suitably.

The configuration of the motion prediction and compensation section 701 of FIG. 32 is different from the configuration of FIG. 9 in that a filter coefficient selection portion 721, a SIFO 722, a motion prediction portion 723, a motion compensation portion 724 and a control portion 725 are provided in place of the fixed interpolation filter 81, filter coefficient storage portion 82, variable interpolation filter 83, filter coefficient calculation portion 84, motion prediction portion 85, motion compensation portion 86 and control portion 87, respectively.

To the filter coefficient selection portion 721 of the motion prediction and compensation section 701, an image to be inter processed from within an input image supplied from the screen reordering buffer 62 is supplied, and a reference image is supplied from the frame memory 72 through the switch 73. The filter coefficient selection portion 721 calculates, for each slice, the difference between average values in luminance of the image to be inter processed for each candidate inter prediction mode and the reference image. The filter coefficient selection portion 721 determines, for each slice, an offset for each candidate inter prediction mode based on the differences and supplies the offset to the SIFO 722. Further, the filter coefficient selection portion 721 supplies the offset to the lossless encoding section 66 in accordance with an instruction from the control portion 725.

The SIFO 722 carries out a filter process for the reference image from the frame memory 72 based on the offset and the filter coefficients supplied from the filter coefficient selection portion 721.

In particular, for example, in the case where the pixel values of pixels at fractional positions after the filter process are a to o illustrated in FIG. 6, the FIFO 722 first uses the pixel values E, F, G, H, I and J of the pixels at the integral positions in the reference image to determine the pixel values a, b and c of the pixels at the fractional positions in accordance with the following expression (24). Here, h[pos][n] is a filter coefficient, pos indicates the position of the sub pel shown in FIG. 6, and n indicates the number of the filter coefficient. Further, offset[pos] indicates the offset of the sub pel at pos.

a=h[a][0]×E+h1[a][1]×F+h2[a][2]×G+h[a][3]×H+h[a][4]×I+h[a][5]×J+offset[a]

b=h[b][0]×E+h1[b][1]×F+h2[b][2]×G+h[b][3]×H+h[b][4]×I+h[b][5]×J+offset[b]

c=h[c][0]×E+h1[c][1]×F+h2[c][2]×G+h[c][3]×H+h[c][4]×I+h[c][5]×J+offset[C] (24)

Further, the SIFO 722 uses the pixel values G1, G2, G, G3, G4 and G5 of the pixels at the integral positions shown in FIG. 6 in the reference image to determine the pixel values d to o of the pixels at the fractional positions in accordance with the following expression (25).

d=h[d][0]×G1+h[d][1]×G2+h[d][2]×G+h[d][3]×G3+h[d][4]*G4+h[d][5]×G5+offset[d]

h=h[h][0]×G1+h[h][1]×G2+h[h][2]×G+h[h][3]×G3+h[h][4]*G4+h[h][5]×G5+offset[h]

l=h[l][0]×G1+h[l][1]×G2+h[l][2]×G+h[l][3]×G3+h[l][4]*G4+h[l][5]×G5+offset[l]

e=h[e][0]×a1+h[e][1]×a2+h[e][2]×a+h[e][3]×a3+h[e][4]*a4+h[e][5]×a5+offset[e]

i=h[i][0]×a1+h[i][1]×a2+h[i][2]×a+h[i][3]×a3+h[i][4]*a4+h[i][5]×a5+offset[i]

m=h[m][0]×a1+h[m][1]×a2+h[m][2]×a+h[m][3]×a3+h[m][4]*a4+h[m][5]×a5+offset[m]

f=h[f][0]×b1+h[f][1]×b2+h[f][2]×b+h[f][3]×b3+h[f][4]*b4+h[f][5]×b5+offset[f]

j=h[j][0]×b1+h[j][1]×b2+h[j][2]×b+h[j][3]×b3+h[j][4]*b4+h[j][5]×b5+offset[j]

n=h[n][0]×b1+h[n][1]×b2+h[n][2]×b+h[n][3]×b3+h[n][4]*b4+h[n][5]×b5+offset[n]

g=h[g][0]×c1+h[g][1]×c2+h[g][2]×c+h[g][3]×c3+h[g][4]*c4+h[g][5]×c5+offset[g]

k=h[k][0]×c1+h[k][1]×c2+h[k][2]×c+h[k][3]×c3+h[k][4]*c4+h[k][5]×c5+offset[k]

o=h[o][0]×c1+h[o][1]×c2+h[o][2]×c+h[o][3]×c3+h[o][4]*c4+h[o][5]×c5+offset[o] (25)

It is to be noted that the SIFO 722 functions, for the pixel value g, as a strong low-pass filter (LPF). Consequently, noise of the reference image after the filter process can be reduced.

The function of the SIFO 722 as a strong LPF for the pixel value g may differ between a case in which the L0L1 weighted prediction is used and another case in which the L0L1 weighted prediction is not used. For example, in the case where the L0L1 weighted prediction is used, the SIFO 722 is controlled so as not to function as a strong LPF for the pixel value g, but in the case where the L0L1 weighted prediction is not carried out, the SIFO 722 is controlled so as to function as a strong LPF for the pixel value g. Consequently, a characteristic of an LPF which is temporally strong is obtained, and in the case where the L0L1 weighted prediction is used, an unnecessary function as an LPF which is spatially strong can be deleted.

It is to be noted that, in the case where the L0L1 weighted prediction is used, the SIFO 722 may be configured so as to function as a strong LPF only for the pixel value g of one of a reference pixel of L0 and a reference pixel of L1. Or, the function as a strong LPF for the pixel value g by the SIFO 722 may be changed over in response to the inter prediction mode.

The filter coefficient selection portion 721 supplies the reference image after the filter process for each block to the motion compensation portion 724 and the motion prediction portion 723.

The motion prediction portion 723 produces, for each block, a motion vector in all candidate inter prediction modes based on the image to be inter predicted from among input images from the screen reordering buffer 62 and the reference image after the filter process from the SIFO 722. The motion prediction portion 723 outputs the produced motion vectors to the motion compensation portion 724.

The motion compensation portion 724 carries out a compensation process for each block for the reference image after the filter process supplied thereto from the SIFO 722 using the motion vectors supplied thereto from the motion prediction portion 723 to produce a predicted image. Then, the motion compensation portion 724 determines a cost function value for each block for all combinations of all filter coefficient sets corresponding to all candidate inter prediction modes.

Further, the motion compensation portion 724 determines the inter prediction mode which indicates a minimum cost function value as an optimum inter prediction mode for each block based on the cost function values of all candidate inter prediction modes corresponding to the reference image after the optimum filter process. Then, the motion compensation portion 724 supplies the predicted image based on the reference image after the optimum filter process in the optimum inter prediction mode and the cost function value corresponding to the predicted image to the predicted image selection section 76. Further, the motion compensation portion 724 supplies the cost function value of all combinations of all candidate filter coefficient sets corresponding to the optimum inter prediction mode of each block of the object slice to the control portion 725.

In the case where a predicted image in an optimum inter prediction mode is selected by the predicted image selection section 76, the motion compensation portion 724 outputs the prediction mode information indicative of the optimum inter prediction mode, information of the slice in which the type of the slice is included, motion vectors, information of the reference image and so forth to the lossless encoding section 66 under the control of the control portion 725.

The control portion 725 sets a prediction mode. The control portion 725 controls the filter coefficient selection portion 721 in response to a type of prediction of a set prediction mode, that is, in response to whether the set prediction mode is the L0L1 weighted prediction or some other prediction. In particular, in the case of the L0L1 weighted prediction, the control portion 725 supplies a set number of a filter coefficient set to be used for the L0L1 weighted prediction to the filter coefficient selection portion 721 and instructs the filter coefficient selection portion 721 to output the filter coefficients of the filter coefficient set. On the other hand, in the case of some other prediction (that is, in the case of prediction which does not carry out the L0L1 weighted prediction), the control portion 725 supplies a set number of the filter coefficients to be used for the other prediction to the filter coefficient selection portion 721 and instructs the filter coefficient selection portion 721 to output the filter coefficients of the filter coefficient set.

Further, the control portion 725 determines filter coefficients for an optimum filter process for each inter prediction mode based on the cost function values of all combinations of all filter coefficient sets corresponding to the optimum inter prediction modes of the blocks of the object slice supplied from the motion compensation portion 724. In particular, the control portion 725 determines a combination of filter coefficients of each sub pel with which the sum of cost function values of blocks, in which the prediction modes are set as the optimum inter prediction modes, is a minimum value as filter coefficients in the optimum filter process in the prediction modes.

Further, if a signal representing that an inter prediction image is selected is received from the predicted image selection section 76, then the control portion 725 carries out control to cause the motion compensation portion 724 and the filter coefficient selection portion 721 to output necessary information to the lossless encoding section 66. Further, the control portion 725 supplies a set number of filter coefficients for the optimum filter process to the lossless encoding section 66 in response to the signal representing that an inter prediction image is selected from the predicted image selection section 76.

### [Example of the Configuration of the Filter Coefficient Selection Portion]

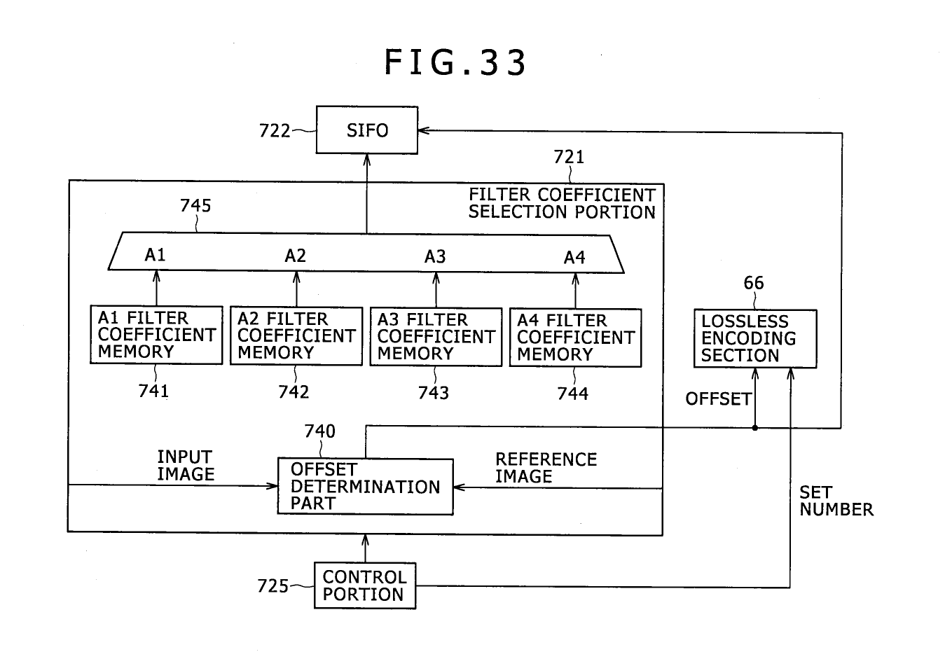

FIG. 33 is a block diagram showing an example of a configuration of the filter coefficient selection portion 721 in the case of the pattern A.

As shown in FIG. 33, the filter coefficient selection portion 721 is configured from an offset determination part 740, an A1 filter coefficient memory 741, an A2 filter coefficient memory 742, an A3 filter coefficient memory 743, an A4 filter coefficient memory 744 and a selector 745.

The offset determination part 740 of the filter coefficient selection portion 721 calculates a difference between average values in luminance of an image to be inter processed for each candidate inter prediction mode and a reference image for each slice. The offset determination part 740 determines, based on the difference, an offset for each candidate inter prediction mode for each slice and supplies such offsets to the SIFO 722. Further, the offset determination part 740 supplies the offsets to the lossless encoding section 66 in accordance with an instruction from the control portion 725.

The A1 filter coefficient memory 741 stores fixed filter coefficients A1 to be used in all inter prediction modes in the case where the L0L1 weighted prediction is not used as a plurality of filter coefficient sets. The A1 filter coefficient memory 741 selects the fixed filter coefficients A1 of a predetermined filter coefficient set from among the plural kinds of stored filter coefficient sets for each sub pel in accordance with the instruction from the control portion 725. The A1 filter coefficient memory 741 outputs the selected fixed filter coefficients A1 of all sub pels to the selector 745.

The A2 filter coefficient memory 742 stores filter coefficients A2 to be used in the bi-prediction mode in the case where the L0L1 weighted prediction is used as a plurality of kinds of filter coefficient sets. The A2 filter coefficient memory 742 selects the filter coefficients A2 of a predetermined filter coefficient set from among the plural kinds of stored filter coefficient sets for each sub pel in accordance with an instruction from the control portion 725. The A2 filter coefficient memory 742 outputs the selected filter coefficients A2 of all sub pels to the selector 745.

The A3 filter coefficient memory 743 stores filter coefficients A3 to be used in the direct mode in the case where the L0L1 weighted prediction is used as a plurality of filter coefficient sets. The A3 filter coefficient memory 743 selects the filter coefficients A3 of a predetermined filter coefficient set from among the plural kinds of stored filter coefficient sets in accordance with an instruction from the control portion 725 for each sub pel. The A3 filter coefficient memory 743 outputs the selected filter coefficients A3 of all sub pels to the selector 745.

The A4 filter coefficient memory 744 stores filter coefficients A4 to be used in the skip mode in the case where the L0L1 weighted prediction is used as a plurality of kinds of filter coefficient sets. The A4 filter coefficient memory 744 selects the filter coefficients A4 of a predetermined filter coefficient set from among the plural kinds of stored filter coefficient sets in accordance with an instruction from the control portion 725 for each sub pel. The A4 filter coefficient memory 744 outputs the selected filter coefficients A4 of all sub pels to the selector 745.

The selector 745 selects one filter coefficient from among the filter coefficients A1 to A4 in accordance with an instruction from the control portion 725 and outputs the selected filter coefficient to the SIFO 722.

It is to be noted that, in the following, where there is no necessity to particularly distinguish the A1 filter coefficient memory 741, A2 filter coefficient memory 742, A3 filter coefficient memory 743 and A4 filter coefficient memory 744 from each other, they are collectively referred to as filter coefficient memories.

### [Example of the Storage Information of the A1 Filter Coefficient Memory]

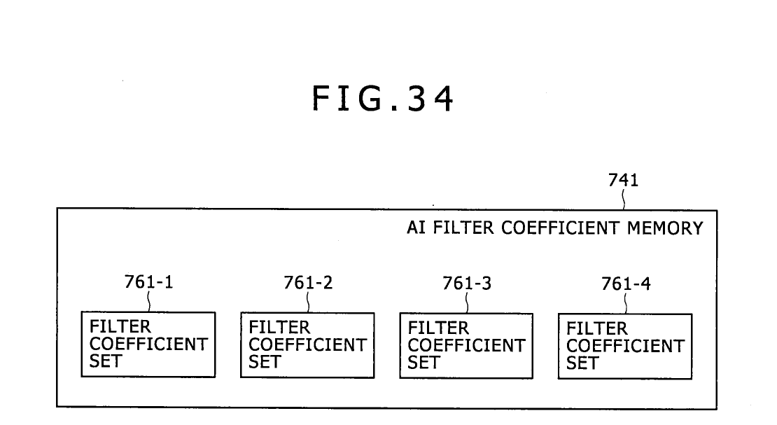

FIG. 34 is a view illustrating an example of storage information of the A1 filter coefficient memory 741.

In the example of FIG. 34, four different kinds of fixed filter coefficients A1 are stored as filter coefficient sets 761-1 to 761-4 in the A1 filter coefficient memory 741.

It is to be noted that the number of filter coefficient sets to be stored in the A1 filter coefficient memory 741 is not limited to four. However, if the number of filter coefficient sets is great, then since the information amount of the set numbers to be inserted into the slice header increases, the overhead increases. On the other hand, if the number of filter coefficient sets is small, then an optimum filter coefficient cannot be set, and there is the possibility that the encoding efficiency may drop. Accordingly, the number of filter coefficient sets is determined in response to the permissible range of the overhead and the encoding efficiency of the system configured from the image encoding apparatus 700 and an image decoding apparatus hereinafter described.

Further, while the storage information of the A1 filter coefficient memory 741 in FIG. 34 is described, also with regard to the A2 filter coefficient memory 742, A3 filter coefficient memory 743 and A4 filter coefficient memory 744, a plurality of filter coefficient sets are stored similarly.

### [Description of the Process of the Image Encoding Apparatus]

Now, a process of the image encoding apparatus 700 in FIG. 31 is described. An encoding process of the image encoding apparatus 700 is similar to the encoding process of FIG. 15 except the motion prediction and compensation process at step S22 of the encoding process of FIG. 15. Accordingly, only a motion prediction and compensation process by the motion prediction and compensation section 701 of the image encoding apparatus 700 is described here.

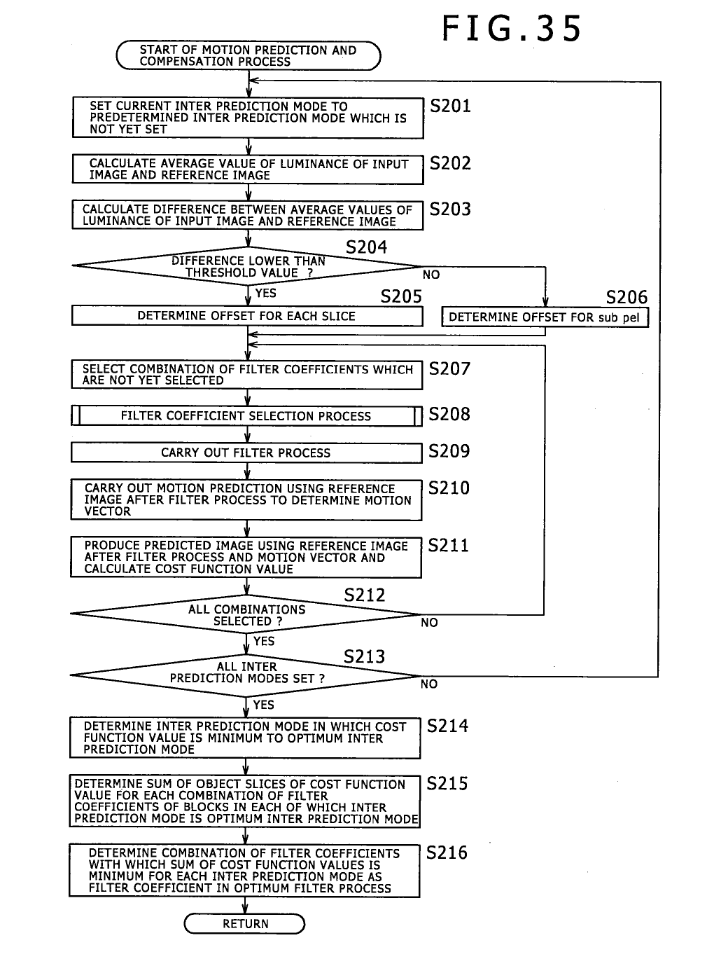

FIG. 35 is a flow chart illustrating the motion prediction and compensation process by the motion prediction and compensation section 701 of the image encoding apparatus 700. The motion prediction and compensation process is carried out for each slice.

At step S201 of FIG. 35, the control portion 725 (FIG. 32) of the motion prediction and compensation section 701 sets a current inter prediction mode to a predetermined inter prediction mode which is not yet set from among candidate inter prediction modes.

At step S202, the offset determination part 740 (FIG. 33) of the filter coefficient selection portion 721 calculates an average value in luminance of images for which an inter process is to be carried out from within an input image and another average value in luminance of reference images corresponding to the present inter prediction mode.

At step S203, the offset determination part 740 calculates a difference between average values in luminance of the images for which the inter process is to be carried out from within the input image and the reference images corresponding to the current inter prediction mode.

At step S204, the offset determination part 740 determines whether or not the difference calculated at step S203 is equal to or lower than a predetermined threshold value (for example, 2). If it is determined at step S204 that the difference is equal to or lower than the predetermined threshold value, then the offset determination part 740 determines the difference as an offset for each of object slices. It is to be noted that the offset for each slice is a common offset to all sub pels of each slice. In particular, where the difference is equal to or lower than the predetermined threshold value, one offset is determined as an offset for each slice for one slice and is determined as an offset for all sub pels. Then, the offset determination part 740 supplies the offset for each slice to the SlFO 722 and advances the processing to step S207.

On the other hand, if it is determined at step S204 that the difference is higher than the predetermined threshold value, then the offset determination part 740 determines a value for each sub pel based on the difference as an offset for each sub pel.

In particular, for example, where the difference is 10, the offset of h is 10 with regard to totaling 15 sub pels from a to o, and the offset is determined such that it increases by 10/15 in order of o, g, f, n, d, l, b, h, j, c, a, k, i, m and e. In particular, the offsets with regard to the sub pels of o, g, f, n, d, l, b, h, j, c, a, k, i, m and e are 80/15, 90/15, 100/15, 110/15, 120/15, 130/15, 140/15, 10, 160/15, 170/15, 180/15, 190/15, 200/15, 210/15 and 220/15. The offset determination part 740 supplies the determined offsets to the SlFO 722 and advances the processing to step S207.

At step S207, the control portion 725 selects a combination of filter coefficients of those sub pels which are not yet selected from within the filter coefficient set stored in the filter coefficient memory corresponding to the current inter prediction mode.

In particular, the control portion 725 first recognizes a filter coefficient memory corresponding to filter coefficients to be selected at step S208 hereinafter described. Then, the control portion 725 recognizes all set numbers of the filter coefficient sets in the filter coefficient memory and selects a set number for each sub pel to determine a combination of set numbers of those sub pels which are not yet selected.

For example, the control portion 725 determines the set number of the filter coefficient set 761-1 in the A1 filter coefficient memory 741 as the set number of totaling 15 sub pels of a, b, c, d, e, f, g, h, i, j, k, l, m, n and o. Further, the control portion 725 determines the set number of the filter coefficient set 761-1 in the A1 filter coefficient memory 741 as a set number of totaling 14 sub pels of a, b, c, d, e, f, g, h, j, k, l, m and n, and determines the set number of the filter coefficient set 761-2 as the set number of the sub pel of o.

Then, the control portion 725 issues an instruction of the combination of the set numbers to the filter coefficient memory corresponding to filter coefficients to be selected at step S208. Consequently, the filter coefficient memory reads out the filter coefficients of the sub pels from the filter coefficient set of the set number based on the combination of the set numbers of the sub pels included in the instruction issued from the control portion 725 and supplies the read out filter coefficients to the selector 745.

At step S208, the filter coefficient selection portion 721 carries out a filter coefficient selection process. Since the filter coefficient selection process is similar to the filter coefficient selection process of FIG. 17, description of the same is omitted. The filter coefficient A1, filter coefficient A2, filter coefficient A3 or filter coefficient A4 selected in the filter coefficient selection process is supplied to the SIFO 72.

At step S209, the SIFO 722 carries out a filter process for the reference image from the frame memory 72 based on the offset and filter coefficient supplied from the filter coefficient selection portion 721. The filter coefficient selection portion 721 supplies the reference image after the filter process to the motion compensation portion 724 and the motion prediction portion 723.

At step S210, the motion prediction portion 723 carries out motion prediction for each block using images to be inter processed from within the input image from the screen reordering buffer 62 and the reference image after the filter process from the SIFO 722 to produce a motion vector. The motion prediction portion 723 outputs the produced motion vectors to the motion compensation portion 724.

At step S211, the motion compensation portion 724 carries out a compensation process for each block using the reference image after the filter process supplied from the SIFO 722 and the motion vectors supplied from the motion prediction portion 723 to produce a prediction image. Then, the motion compensation portion 724 determines a cost function value for each block.

At step S212, the control portion 725 determines whether or not all combinations of the filter coefficients of the sub pels in the filter coefficient set corresponding to the current inter prediction mode are selected in the process at step S207. If it is determined at step S212 that all combinations are not yet selected, then the processing returns to step S207 and the processes at steps S207 to S212 are repetitively carried out until all combinations are selected.

On the other hand, if it is determined at step S212 that all combinations are selected, then the control portion 725 determines, at step S213, whether or not all candidate inter prediction modes are set as the current inter prediction mode in the process at step S201.

If it is determined at step S213 that all candidate inter prediction modes are not yet set as the current inter prediction mode, then the processing returns to step S201. Then, the processes at steps S201 to S213 are repetitively carried out until all candidate inter prediction modes are set as the current inter prediction mode.

On the other hand, if it is determined at step S213 that all candidate inter prediction modes are set as the current inter prediction mode, then the processing advances to step S214. At step S214, the motion compensation portion 724 determines an inter prediction mode in which the cost function value exhibits a minimum value to an optimum inter prediction mode for each block based on the cost function values of all candidate inter prediction modes corresponding to the reference image after the optimum filter process from among the cost function values calculated at step S211.

It is to be noted that, in the process at step S214 for the first frame, a process in which predetermined filter coefficients (for example, filter coefficients as a filter coefficient set whose set number is 0) are used is determined as the optimum filter process.

Further, the motion compensation portion 724 supplies the prediction image produced based on the reference image after the optimum filter process of the optimum inter prediction mode and the cost function value corresponding to the prediction image to the predicted image selection section 76. Then, where the prediction image of the optimum inter prediction mode is selected by the predicted image selection section 76, prediction mode information which indicates the optimum inter prediction mode and the motion vectors corresponding to the optimum inter prediction mode are outputted to the lossless encoding section 66 under the control of the control portion 725. Further, the motion compensation portion 724 supplies the cost function values of all combinations of all filter coefficient sets corresponding to the optimum inter prediction mode of each block to the control portion 725.

At step S215, the control portion 725 determines, based on the cost function values of all combinations of all filter coefficient sets corresponding to the optimum inter prediction mode of each block supplied from the motion compensation portion 724, the sum of a number of cost function values of object slices for each combination of filter coefficients in the blocks, in which each inter prediction mode is determined as the optimum inter prediction mode. In particular, the control portion 725 carries out, for each inter prediction mode, addition of a number of cost function values equal to the number of slices for each combination of the filter coefficients corresponding to the optimum inter prediction mode regarding those blocks in which the optimum inter prediction mode is the predetermined inter prediction mode.

At step S216, the control portion 725 determines, for each inter prediction mode, a combination of filter coefficients with regard to which the sum of cost function values exhibits a minimum value as the filter coefficient in the optimum filter process based on the sum of cost function values for each combination of filter coefficients of each inter prediction mode calculated at step S215. The set number of filter coefficients for each sub pel is supplied to the lossless encoding section 66 in response to a signal representing that the inter prediction image from the predicted image selection section 76 is selected, and is inserted into the slice header of a slice of the same type as that of an object slice of a next frame to the object frame. Then, the motion prediction and compensation process is ended.

As described above, in the image encoding apparatus 700, the filter coefficients and the offset in the optimum filter process can be set by one kind of motion prediction. As a result, the calculation cost of the filter coefficients can be reduced in comparison with the image encoding apparatus 51 of FIG. 8.

Further, since, in the image encoding apparatus 700, not the filter coefficients themselves but the set number of filter coefficients for each sub pel is included in the slice header, the overhead can be reduced in comparison with the image encoding apparatus 51 of FIG. 8.

It is to be noted that, while, in the second embodiment, a filter coefficient set is selected for each sub pel, one filter coefficient set common to all sub pels may be selected. In this instance, since the image encoding apparatus 700 may determine the cost function value in a unit of a filter coefficient set in order to determine filter coefficients in an optimum filter process, the overhead can be reduced. Further, since the information for specifying a filter coefficient set is one set number for each inter prediction mode, the bit amount of the information can be decreased.

Further, the embodiment may be configured such that both of selection of a filter coefficient set for each sub pel and selection of one filter coefficient set common to all sub pels can be selectively carried out. In this instance, a flag indicative of which one of the selections is carried out is inserted into the slice header. This flag indicates 1 in the case where the selection of a filter coefficient set for each sub pel is carried out, but indicates 0 in the case where the selection of one filter coefficient set common to all sub pels is carried out.

Further, while, in the second embodiment, a filter coefficient set is provided for each of the filter coefficients A1 to A4, the filter coefficient set common to the filter coefficient A1 to the filter coefficient A4 may be provided. However, in the case where a filter coefficient set is provided for each of the filter coefficient A1 to the filter coefficient set A4, only the filter coefficient set suitable for each of the filter coefficient A1 to the filter coefficient set A4 can be provided. Accordingly, the number of filter coefficient sets to be prepared for each of the filter coefficient A1 to the filter coefficient set A4 becomes small in comparison with a case in which a common filter coefficient set is provided, and the bit amount of the set number to be inserted into the slice header can be decreased.

### [Example of the Configuration of the Image Decoding Apparatus]

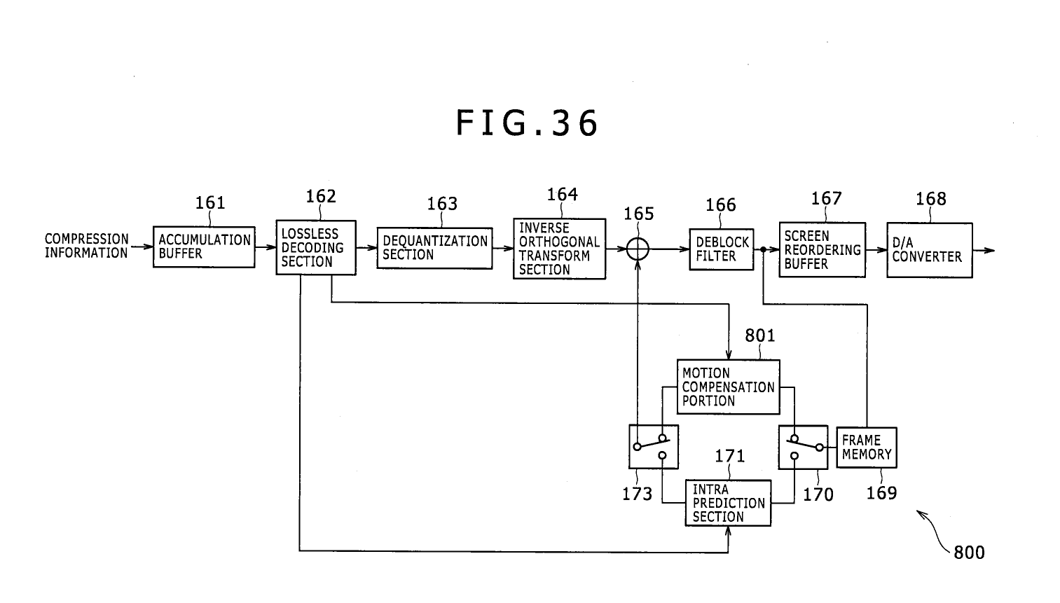

FIG. 36 shows a configuration of a second embodiment of an image decoding apparatus as the image processing apparatus to which the present invention is applied.

From among components shown in FIG. 36, those which are same as the components of FIG. 18 are denoted by like reference characters. Overlapping description is suitably omitted.

The configuration of the image decoding apparatus 800 of FIG. 36 is principally different from the configuration of FIG. 18 in that a motion compensation portion 801 is provided in place of the motion compensation portion 172. The image decoding apparatus 800 decodes a compressed image outputted from the image encoding apparatus 700 of FIG. 31.

In particular, in the motion compensation portion 801 of the image decoding apparatus 800, at least a plurality of filter coefficients used for L0L1 weighted prediction and a plurality of filter coefficients used for any other prediction are stored as filter coefficient sets.

The motion compensation portion 801 reads out, for each sub pel, filter coefficients of a filter coefficient set of a set number included in the slice header from the lossless decoding section 162 from among filter coefficient sets corresponding to the optimum inter prediction mode from the lossless decoding section 162. The motion compensation portion 801 carries out a filter process for a reference image from the frame memory 169 by means of a SIFO using the read out filter coefficients and the offset included in the slice header.

Further, the motion compensation portion 801 carries out a compensation process for the reference image after the filter process for each block using the motion vectors from the lossless decoding section 162 to produce a prediction image. The produced prediction image is outputted to the arithmetic operation section 165 through the switch 173.

### [Example of the Configuration of the Motion Compensation Portion]

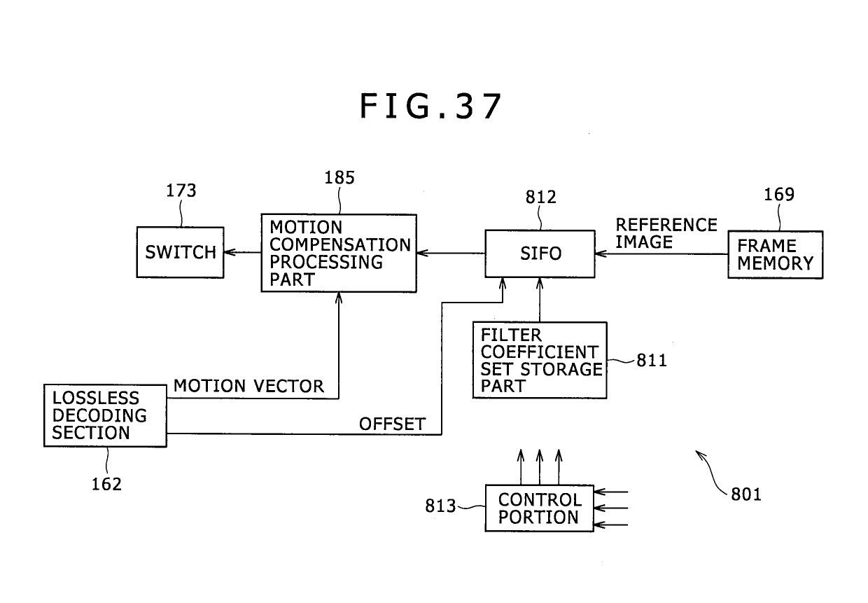

FIG. 37 is a block diagram showing an example of a detailed configuration of the motion compensation portion 801. It is to be noted that, in FIG. 37, the switch 170 of FIG. 36 is omitted.

In FIG. 37, like components to those in FIG. 19 are denoted by like reference characters. Overlapping description is omitted suitably.

The configuration of the motion compensation portion 801 of FIG. 37 is different from the configuration of FIG. 19 principally in that a filter coefficient set storage part 811, a SIFO 812 and a control portion 813 are provided in place of the fixed interpolation filter 181, fixed filter coefficient storage part 182, variable interpolation filter 183, variable filter coefficient storage part 184 and control portion 186.

The filter coefficient set storage part 811 of the motion compensation portion 801 stores at least plural kinds of filter coefficients to be used for the SIFO 812 for L0L1 weighted prediction and any other prediction as filter coefficient sets. The filter coefficient set storage part 811 reads out the filter coefficients in a predetermined filter coefficient set for each sub pel under the control of the control portion 813. Further, the filter coefficient set storage part 811 selects some of the read out filter coefficients for the L0L1 weighted prediction and any other prediction under the control of the control portion 813 and supplies the selected filter coefficients to the SIFO 812.

The SIFO 812 carries out a filter process for the reference image from the frame memory 169 using the offset supplied from the lossless decoding section 162 and the filter coefficients supplied from the filter coefficient set storage part 811. The SIFO 812 outputs the reference image after the filter process to the motion compensation processing part 185.

The control portion 813 acquires a set number included in information of the slice header from the variable decoding section 162 for each slice and issues an instruction to read out the filter coefficient set having the set number to the filter coefficient set storage part 811. Further, the control portion 813 issues an instruction regarding which one of filter coefficients for the L0L1 weighted prediction and any other prediction is to be selected to the filter coefficient set storage part 811 in response to the prediction mode information supplied from the lossless decoding section 162. Further, the control portion 813 controls the motion compensation processing part 185 to carry out a compensation process of the optimum inter prediction mode based on the prediction mode information.

### [Example of the Configuration of the Filter Coefficient Set Storage Part]

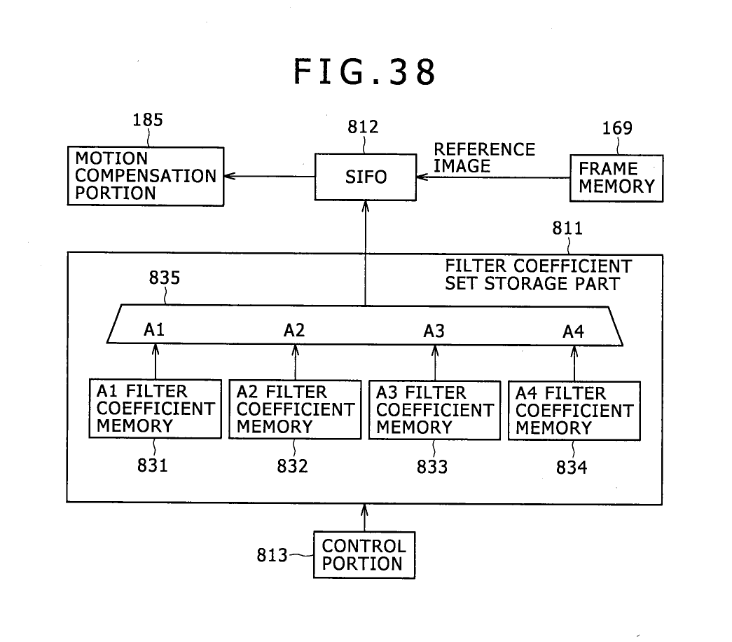

FIG. 38 is a block diagram showing an example of a configuration of the filter coefficient set storage part 811 in the case of the pattern A.

As shown in FIG. 38, the filter coefficient set storage part 811 includes an A1 filter coefficient memory 831, an A2 filter coefficient memory 832, an A3 filter coefficient memory 833, an A4 filter coefficient memory 834 and a selector 835.

The A1 filter coefficient memory 831 stores, as filter coefficient sets, plural kinds of the filter coefficients A1 used for all inter prediction modes in the case where the L0L1 weighted prediction is not used similarly to the A1 filter coefficient memory 741 of FIG. 33. The A1 filter coefficient memory 831 selects the filter coefficients A1 of a predetermined filter coefficient set from among the plural kinds of filter coefficient sets stored therein for each sub pel in accordance with an instruction from the control portion 813. The A1 filter coefficient memory 831 outputs the selected filter coefficients A1 for all sub pels to the selector 835.

The A2 filter coefficient memory 832 stores, as filter coefficient sets, plural kinds of the filter coefficients A2 used for the bi-prediction mode where the L0L1 weighted prediction is used similarly to the A2 filter coefficient memory 742 of FIG. 33. The A2 filter coefficient memory 832 selects the filter coefficients A2 of a predetermined filter coefficient set from among the plural kinds of filter coefficient sets stored therein for each sub pel in accordance with an instruction from the control portion 813. The A2 filter coefficient memory 832 outputs the selected filter coefficients A2 for all sub pels to the selector 835.

The A3 filter coefficient memory 833 stores, as filter coefficient sets, plural kinds of the filter coefficients A3 used for the direct mode where the L0L1 weighted prediction is used similarly to the A3 filter coefficient memory 743 of FIG. 33. The A3 filter coefficient memory 833 selects the filter coefficients A3 of a predetermined filter coefficient set from among the plural kinds of the filter coefficient sets stored therein for each sub pel in accordance with the instruction from the control portion 813. The A3 filter coefficient memory 833 outputs the selected filter coefficients A3 for all sub pels to the selector 835.

The A4 filter coefficient memory 834 stores, as filter coefficient sets, plural kinds of the filter coefficients A4 used for the skip mode where the L0L1 weighted prediction is used similarly to the A4 filter coefficient memory 744 of FIG. 33. The A4 filter coefficient memory 834 selects the filter coefficient A4 of a predetermined filter coefficient set from among the plural kinds of the filter coefficient sets stored therein for each sub pel in accordance with the instruction from the control portion 813. The A4 filter coefficient memory 834 outputs the selected filter coefficients A4 for all sub pels to the selector 835.

In accordance with an instruction from the control portion 813, the selector 835 selects one of the filter coefficients A1 to A4 and outputs the selected filter coefficient to the SIFO 812.

### [Description of the Process of the Image Decoding Apparatus]

Now, a process of the image decoding apparatus 800 of FIG. 36 is described. The decoding process of the image decoding apparatus 800 is similar to the decoding process of FIG. 22 except the motion compensation process at step S139 of the decoding process of FIG. 22. Accordingly, only a motion compensation process by the motion compensation portion 801 of the image decoding apparatus 800 is described here.

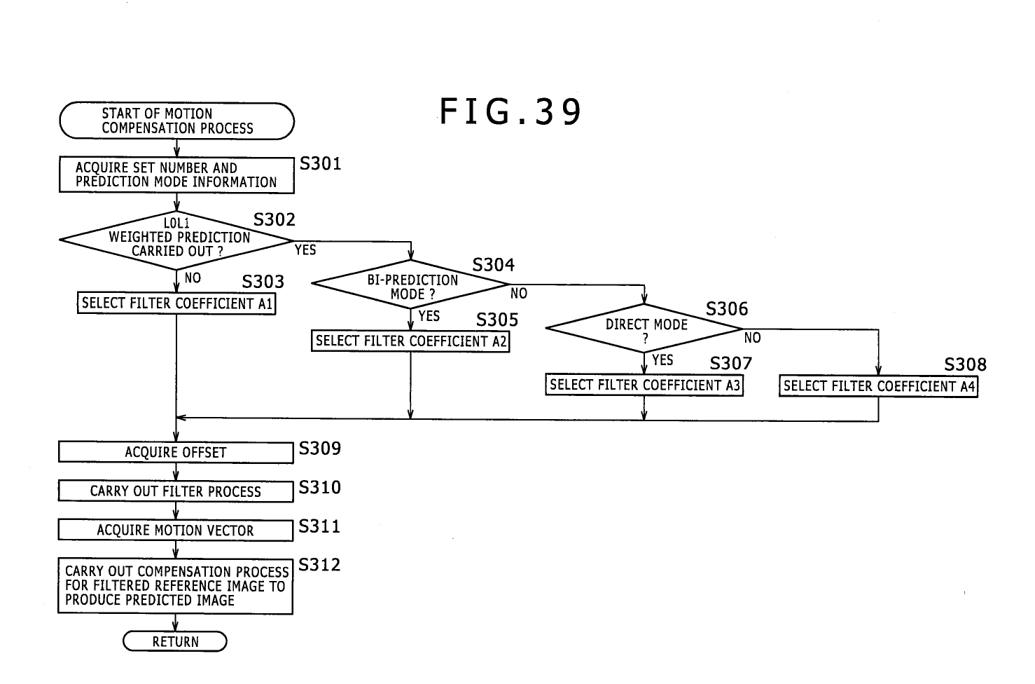

FIG. 39 is a flow chart illustrating the motion compensation process by the motion compensation portion 801 of the image decoding apparatus 800. The motion compensation process by the motion compensation portion 801 is carried out for each slice.

At step S301, the control portion 813 (FIG. 37) of the motion compensation portion 801 acquires the set number of each sub pel for each slice included in information of the slice header from the lossless decoding section 162 and acquires prediction mode information for each block. The control portion 813 issues an instruction of the acquired set number of each sub pel to the filter coefficient set storage part 811. Consequently, the A1 filter coefficient memory 831, A2 filter coefficient memory 832, A3 filter coefficient memory and A4 filter coefficient memory of the filter coefficient set storage part 811 individually read out the filter coefficient of the sub pel in the filter coefficient set of the set number of each sub pel included in the instruction from the control portion 813 and supply the read out filter coefficients to the selector 835.

Since the processes at steps S302 to S308 are similar to the processes at steps S155 to S161 of FIG. 23, description of the same is omitted.

After the process at step S308, the SIFO 812 acquires an offset for each slice included in the slice header from the lossless decoding section 162 at step S309.

At step S310, the SIFO 812 carries out a filter process for the reference image from the frame memory 169 using the offset supplied from the lossless decoding section 162 and the filter coefficient supplied from the filter coefficient set storage part 811. The SIFO 812 outputs the reference image after the filter process to the motion compensation processing part 185.

At step S311, the motion compensation processing part 185 acquires a motion vector for each block from the lossless decoding section 162.

At step S312, the motion compensation processing part 185 carries out a compensation process for the filtered reference image using the motion vector from the lossless decoding section 162 in the optimum inter prediction mode for each block under the control of the control portion 813 to produce a prediction image. The motion compensation part 185 outputs the produced prediction image to the switch 173. Then, the motion compensation process is ended.

### <Different Classification of Filter Coefficients>

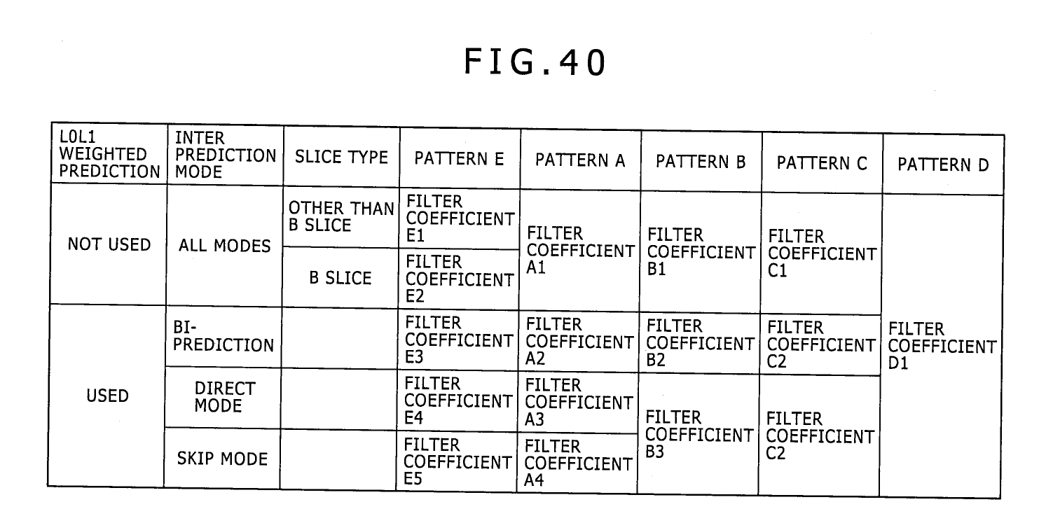

FIG. 40 is a view illustrating another classification method of filter coefficients. It is to be noted that, in an example of FIG. 40, it is represented that, if a numeral and an alphabetical letter at a portion of a filter [X][X] are different, then a characteristic of the filter is different.

The classification method of filter coefficients illustrated in FIG. 40 is a method in which one pattern E is added to the classification method of filter coefficients illustrated in FIG. 10.

The pattern E is a method for classifying filter coefficients into five filter coefficients E1 to E5. In particular, in the pattern E, not only a filter coefficient different for each inter prediction mode in the case where the L0L1 weighted prediction is used is used similarly as in the pattern A but also a filter coefficient different depending upon whether an object slice is a slice other than a B slice or is a B slice in the case where the L0L1 weighted prediction is not used is used.

In particular, the filter coefficient E1 is used for slices other than the B slice of all inter prediction modes where the L0L1 weighted prediction is not used. The filter coefficient E2 is used for the B slice of all inter prediction modes where the L0L1 weighted prediction is not used. The filter coefficient E3 is used for the bi-prediction mode where the L0L1 weighted prediction is used. The filter coefficient E4 is used for the direct mode where the L0L1 weighted prediction is used. The filter coefficient E5 is used for the skip mode where the L0L1 weighted prediction is used.

In the following, an effect by the pattern E is described.

In the AVC standard, both of a region in which the L0L1 weighted prediction is used and another region in which the L0L1 weighted prediction is not used exist usually in a mixed state in the B slice. On the other hand, since the P slice cannot refer to the L1 reference, the L0L1 weighted prediction is not used.

In particular, while, in the B slice, both of reference pixels of L0 and L1 are sometimes used, in the P slice, only reference pixels of L0 are used in the P slice. Further, where the L0L1 weighted prediction is not used in the B slice, it is considered that there is a high degree of the possibility that a special motion, that is, a motion which involves rotation or enlargement or reduction, may occur in the region. Then, the motion such as rotation or enlargement or reduction is hard to be compensated for by motion compensation of high-frequency components. Accordingly, in the B slice, where the L0L1 weighted prediction is not used, the interpolation filter (fixed interpolation filter 81, variable interpolation filter 83, SIFO 722) is required to have an LPF characteristic having a high intensity in comparison with the P slice.

Therefore, if optimum filter coefficients for the B slice where the L0L1 weighted prediction is not used are prepared as the filter coefficients A1 to C1 of the fixed interpolation filter 81 or the SIFO 722, then higher frequency components are excessively suppressed in the P slice. This makes a factor of deterioration of the encoding efficiency or picture quality particularly in the encoding method configured only from the P slice.

On the other hand, in the pattern E, where the L0L1 weighted prediction is not used, the filter coefficient E1 for a slice other than the B slice and the filter coefficient E2 for the B slice are prepared separately each other. Accordingly, optimum filter coefficients can be used for the B slice and any slice other than the B slice. As a result, noise included in the reference image can be suitably removed and loss of high-frequency components of the reference image can be suppressed.

It is to be noted that the present invention can be applied also to an image processing apparatus in which a filter other than the fixed interpolation filter described hereinabove (FIF (Fixed Interpolation Filter), AIF and SIFO is used.

Further, the offset may be set in the fixed interpolation filter 81 and the variable interpolation filter 83.

### DESCRIPTION OF REFERENCE CHARACTERS

51 Image encoding apparatus, 66 Lossless encoding section, 75 Motion prediction and compensation section, 81 Fixed interpolation filter, 82 Filter coefficient storage portion, 83 Variable interpolation filter, 84 Filter coefficient calculation portion, 85 Motion prediction portion, 86 Motion compensation portion, 87 Control portion, 91 A1 Filter coefficient memory, 92 A2 Filter coefficient memory, 93 A3 Filter coefficient memory, 94 A4 Filter coefficient memory, 95 Selector, 101 A1 Filter coefficient calculation part, 102 A2 Filter coefficient calculation part, 103 A3 Filter coefficient calculation part, 104 A4 Filter coefficient calculation part, 105 Selector, 151 Image decoding apparatus, 162 Lossless decoding section, 172 Motion compensation portion, 181 Fixed interpolation filter, 182 Fixed filter coefficient storage part, 183 Variable interpolation filter, 184 Variable filter coefficient storage part, 185 Motion compensation processing part, 186 Control portion, 191 A1 Filter coefficient memory, 192 A2 Filter coefficient memory, 193 A3 Filter coefficient memory, 194 A4 Filter coefficient memory, 195 Selector, 201 A1 Filter coefficient memory, 202 A2 Filter coefficient memory, 203 A3 Filter coefficient memory, 204 A4 Filter coefficient memory, 205 Selector

1. An image processing apparatus, comprising:
an interpolation filter for interpolating pixels of a reference image corresponding to an encoded image with fractional accuracy;
filter coefficient selection means for selecting filter coefficients of said interpolation filter based on use or non-use of weighted prediction by a plurality of such reference images different from each other in the encoded image; and
motion compensation means for producing a predicted image using the reference image interpolated by said interpolation filter of the filter coefficients selected by said filter coefficient selection means and a motion vector corresponding to the encoded image.

2. The image processing apparatus according to claim 1, wherein, where the weighted prediction by the plural different reference images is used, said filter coefficient selection means selects filter coefficients of said interpolation filter based on whether or not the current mode is a bi-prediction mode.

3. The image processing apparatus according to claim 2, wherein said filter coefficient selection means selects the filter coefficients whose degree of amplification of high-frequency components is different based on whether or not the current mode is the bi-prediction mode.

4. The image processing apparatus according to claim 1, wherein, where the weighted prediction by the plural different reference images is used, said filter coefficient selection means selects filter coefficients of said interpolation filter based on whether the current mode is a bi-prediction mode, a direct mode or a skip mode.

5. The image processing apparatus according to claim 1, wherein said interpolation filter interpolates the pixels of the reference image with fractional accuracy using the filter coefficients selected by said filter coefficient selection means and an offset value.

6. The image processing apparatus according to claim 1, further comprising:
decoding means for decoding the encoded image, the motion vector and the filter coefficients calculated upon encoding, wherein
said filter coefficient selection means selects the filter coefficients decoded by said decoding means based on use or non-use of the weighted prediction by a plurality of such reference images different from each other in the encoded image.

7. The image processing apparatus according to claim 6, wherein the filter coefficients include plural kinds of filter coefficients upon use of the weighted prediction and plural kinds of filter coefficients upon non-use of the weighted prediction; and
said filter coefficient selection means selects the filter coefficients decoded by said decoding means based on use or non-use of the weighted prediction and information for specifying a kind of the filter coefficients.

8. The image processing apparatus according to claim 1, further comprising:
motion prediction means for carrying out motion prediction between an object image of encoding and the reference image interpolated by said interpolation filter of the filter coefficients selected by said filter coefficient selection means to detect the motion vector.

9. The image processing apparatus according to claim 8, wherein, where the weighted prediction by the plural different reference images is used, said filter coefficient selection means selects filter coefficients of said interpolation filter based on whether or not the current mode is a bi-prediction mode.

10. The image processing apparatus according to claim 8, further comprising:
filter coefficient calculation means for calculating filter coefficients of said interpolation filter using the object image of encoding, the reference images and the motion vector detected by said motion prediction means, wherein
said filter coefficient selection means selects the filter coefficients calculated by said filter coefficient calculation means based on use or non-use of the weighted prediction by the plural different reference images.

11. The image processing apparatus according to claim 10, wherein said filter coefficient selection means determines, based on use or non-use of the weighted prediction by the plural different reference images, the filter coefficients calculated by said filter coefficient calculation means as a first selection candidate and determines a predetermined filter coefficient as a second selection candidate;
said motion prediction means carries out motion prediction between the object image of the encoding and the reference image interpolated by said interpolation filter of the first selection candidate to detect a motion vector for the first selection candidate, and carries out motion prediction between the object image of the encoding and the reference image interpolated by said interpolation filter of the second selection candidate to detect a motion vector for the second selection candidate;
said motion compensation means produces a predicted image for the first selection candidate using the reference image interpolated by said interpolation filter of the first selection candidate and the motion vector for the first selection candidate, and produces a predicted image for the second selection candidate using the reference image interpolated by said interpolation filter of the second selection candidate and the motion vector for the second selection candidate; and
said filter coefficient selection means selects a filter coefficient corresponding to a smaller one of the difference between the predicted image for the first selection candidate and the object image of the encoding and the difference between the predicted image for the second selection candidate and the object image of the encoding.

12. The image processing apparatus according to claim 8, wherein the filter coefficients include plural kinds of filter coefficients when the weighted prediction is used and plural kinds of filter coefficients when the weighted prediction is not used; and
said filter coefficient selection means selects the filter coefficients based on use or non-use of the weighted prediction and a cost function value corresponding to each kind of the filter coefficient.

13. An image processing method for an image processing apparatus which includes an interpolation filter for interpolating pixels of a reference image corresponding to an encoded image with fractional accuracy, said method comprising the steps, executed by the image processing apparatus, of:
selecting filter coefficients of the interpolation filter based on use or non-use of weighted prediction by a plurality of reference images different from each other in the encoded image; and
producing a predicted image using the reference images interpolated by the interpolation filter of the selected filter coefficients and a motion vector corresponding to the encoded image.

14. The image processing method according to claim 13, further comprising the step, executed by the image processing apparatus, of:
carrying out motion prediction between an object image of encoding and the reference image interpolated by the interpolation filter of the selected filter coefficients to detect a motion vector.

15. A program for causing a computer of an image processing apparatus, which includes an interpolation filter for interpolating pixels of a reference image corresponding to an encoded image with fractional accuracy, to function as:
filter coefficient selection means for selecting filter coefficients of the interpolation filter based on use or non-use of weighted prediction by a plurality of such reference images different from each other in the encoded image; and
motion compensation means for producing a predicted image using the reference image interpolated by the interpolation filter of the filter coefficients selected by the filter coefficient selection means and a motion vector corresponding to the encoded image.

16. The program according to claim 15, wherein the program further causes the computer to function as motion prediction means for carrying out motion prediction between an object image of encoding and the reference image interpolated by the interpolation filter of the filter coefficients selected by the filter coefficient selection means to detect the motion vector.
